(19) United States
(12) Patent Application Publication
(10) Pub. No.: US 2008/0153997 A1
(43) Pub. Date: Jun. 26, 2008

(54) Polymer production at supercritical conditions

(75) Inventors: Gary L. Casty, Easton, PA (US); Raymond A. Cook, Bethlehem, PA (US); Gabor Kiss, Hampton, NJ (US); Patrick Brant, Seabrook, TX (US)

Correspondence Address: EXXONMOBIL CHEMICAL COMPANY, 5200 BAYWAY DRIVE, P.O. BOX 2149, BAYTOWN, TX, 77522-2149, US

(73) Assignee: EXXONMOBIL RESEARCH AND ENGINEERING

(21) Appl. No.: 11/714,546

(22) Filed: Mar. 6, 2007

Related U.S. Application Data
(60) Provisional application No. 60/876,193, filed on Dec. 20, 2006.

(51) Int. Cl. C08F 4/42; C08F 2/00; C08F 4/46

(52) U.S. Cl. 526/88; 526/126; 526/134; 526/154; 526/172; 526/64; 526/65; 526/90

(57) ABSTRACT

This invention relates to a process to polymerize olefins comprising contacting, at a temperature of 60° C. or more and a pressure of at least 15 MPa, one or more olefin monomers having three or more carbon atoms, with: 1) a catalyst system comprising one or more activators and one or more nonmetallocene metal-centered, heteroaryl ligand catalyst compounds, where the metal is chosen from the Group 4, 5, 6, the lanthanide series, or the actinide series of the Periodic Table of the Elements, 2) optionally one or more comonomers, 3) optionally diluent or solvent, and 40 optionally solvent, wherein: a) the olefin monomers and any comonomers are present in the polymerization system at 40 weight % or more, b) the monomer having three or more carbon atoms is present at 80 wt % or more based upon the weight of all monomers and comonomers present in the feed, c) the polymerization occurs at a temperature above the solid-fluid phase transition temperature of the polymerization system and a pressure no lower than 10 MPa below the cloud point pressure of the polymerization system and less than 1500 MPa, in the event the solid-fluid phase transition temperature of the polymerization system cannot be determined then the polymerization occurs at a temperature above the fluid fluid phase transition temperature.

### PRIORITY CLAIM

This claims the benefit of and priority to U.S. Ser. No. 60/876,193, filed Dec. 20, 2006.

### STATEMENT OF RELATED CASES

This application is related to U.S. Ser. No. 10/667,585, filed Sep. 22, 2003, which claims priority to and the benefit of U.S. Ser. No. 60/412,541, filed Sep. 20, 2002 and U.S. Ser. No. 60/431,077, filed Dec. 5, 2002.

This application is also related to U.S. Ser. No. 10/667,586, filed Sep. 23, 2003, which claims priority to and the benefit of U.S. Ser. No. 60/412,541, filed Sep. 20, 2002 and U.S. Ser. No. 60/431,077, filed Dec. 5, 2002.

This application is also related to U.S. Ser. No. 11/510,871, filed Aug. 25, 2006 which is a continuation-in-part of U.S. Ser. No. 11/177,004 filed Jul. 8, 2005 (now abandoned), which claims the benefit of U.S. Ser. No. 60/586,465, filed Jul. 8, 2004. U.S. Ser. No. 11/177,004 is a continuation in part of U.S. Ser. No. 10/667,585, filed Sep. 22, 2003, which claims the benefit of U.S. Ser. No. 60/412,541, filed Sep. 20, 2002, and claims the benefit of U.S. Ser. No. 60/431,077, filed Dec. 5, 2002. U.S. Ser. No. 11/177,004, is also a continuation-in-part of U.S. Ser. No. 10/667,586, filed Sep. 22, 2003, which claims the benefit of U.S. Ser. No. 60/412,541, filed Sep. 20, 2002, and claims the benefit of U.S. Ser. No. 60/431,077, filed Dec. 5, 2002.

### FIELD OF THE INVENTION

This invention relates to polymerization of olefin monomers having three or more carbon atoms under supercritical conditions using a nonmetallocene, metal-centered, heteroaryl ligand catalyst compound.

### BACKGROUND

Since the mid-1980s metallocene catalysts have been used in high-pressure reactors--mainly for producing ethylene-backbone polymers including ethylene copolymers with monomers of one or more of propylene, butene, and hexene, along with other specialty monomers such as 4-methyl-1,5-hexadiene. For example U.S. Pat. No. 5,756,608, granted to Langhausen et al., reports a process for polymerizing C₂ to C₁₀ 1-alkenes using bridged metallocene catalysts. However, polypropylene production in high-pressure conditions has been seen as impractical and unworkable at temperatures much above the propylene critical point despite the expectation that processes for producing commercially useful polypropylene in a high-pressure system would provide advantages, such as increased reactivity, or increased catalyst productivity, or higher throughput, or shorter residence times, etc. Likewise new polypropylene polymers are also in constant need for the preparation of new and improved products. Thus there is a need in the art to develop new processes capable of greater efficiency and manufacture of new polypropylene polymers.

In addition there is also a need for polymerization processes that are flexible enough to be used with other monomers. For example a high-pressure process to make polybutene or polyhexene would also be useful.

U.S. Pat. No. 6,084,041, granted to Andtsjö et al., discloses supercritical propylene polymerization under relatively mild conditions (90-100° C. and less than 6.89 MPa pressure) using supported Ziegler-Natta and metallocene catalysts. This patent does not relate to propylene copolymerization at temperatures or pressures much higher than described above. It also does not specifically disclose bulk propylene polymerization using soluble, unsupported metallocene catalysts.

U.S. Pat. No. 5,969,062 granted to Mole et al., describes a process for preparing ethylene copolymers with a-olefins in which polymerization is carried out at a pressure between 100-350 MPa and at a temperature from 200-280° C. The catalyst is based on a tetramethylcyclopentadienyl titanium complex.

U.S. Pat. No. 5,408,017 describes an olefin polymerization catalyst for use at polymerization temperatures of 140° C. to 160° C., or greater. Mainly, temperatures exceeding the melting point temperature and approaching the polymer decomposition temperature are said to yield high productivity.

WO 93/11171 discloses a polyolefin production process that comprises continuously feeding olefin monomer and a metallocene catalyst system into a reactor. The monomer is continuously polymerized to provide a monomer-polymer mixture. Reaction conditions keep this mixture at a pressure below the system's cloud-point pressure. These conditions create a polymer-rich and a monomer-rich phase and maintain the mixture's temperature above the polymer's melting point.

U.S. Pat. No. 6,355,741 discloses a process for producing polyolefins having a bimodal molecular weight distribution. The process comprises producing a first polyolefin fraction in a first loop reactor. The process couples this first loop reactor to a second loop reactor that prepares a second polyolefin fraction. At least one of the loops uses supercritical conditions.

WO 92/14766 describes a process comprising the steps of (a) continuously feeding olefinic monomer and a catalyst system, with a metallocene component and a cocatalyst component, to the reactor; (b) continuously polymerizing that monomer in a polymerization zone reactor under elevated pressure; (c) continuously removing the polymer/monomer mixture from the reactor; (d) continuously separating monomer from molten polymer; (e) reducing pressure to form a monomer-rich and a polymer-rich phase; and (f) separating monomer from the reactor.

U.S. Pat. No. 5,326,835 describes bimodal polyethylene production. This invention's first reactor stage is a loop reactor in which polymerization occurs in an inert, low-boiling hydrocarbon. After the loop reactor, the reaction medium transits into a gas-phase reactor where gas-phase ethylene polymerization occurs. The polymer produced appears to have a bimodal molecular weight distribution.

CA 2,118,711 (equivalent to DE 4,130,299) describes propylene polymerization at 149° C. and 1510 bar using the syndiotactic metal complex of (CH₃)₂C(fluorenyl)(cyclopentadienyl)zirconium dichloride with methylalumoxane and trimethylaluminum. Catalyst activity is reported to be 8380 gPP/g Ic′h. The M_{w} is reported to be 2,000. CA 2,118,711 also describes propylene copolymerization with ethylene at 190° C. and 1508 bar using (CH₃)₂C(fluorenyl)(cyclopentadienyl)zirconium dichloride complex, methylalumoxane and trimethylaluminum. Catalyst activity is reported to be 24358 g Polymer/g metallocene-hr. The M_{w} is reported to be 10,000.

Other References of Interest Include:
Olefin Polymerization Using Highly Congested ansa-Metallocenes under High Pressure: Formation of Superhigh Molecular Weight Polyolefins, Suzuki, et al., Macromolecules, 2000, 33, 754-759, EP 1 123 226, WO 00 12572, WO 00 37514, EP 1 195 391, and Ethylene Bis(Indenyl)Zirconocenes . . . , Schaverien, C. J. et al., Organometallics, ACS, Columbus Ohio, vol 20, no. 16, August 2001, pg 3436-3452, WO 96/34023, WO 97/11098, U.S. Pat. No. 5,084,534, U.S. Pat. No. 2,852,501, WO 93/05082, EP 129 368 B1, WO 97/45434, JP 96-208535 199660807, U.S. Pat. No. 5,096,867, WO 96/12744, U.S. Pat. No. 6,225,432, WO 02/090399, WO 02/50145, US 2002 013440, WO 01/46273, EP 1 008 607, JP-1998-110003A, U.S. Pat. No. 6,562,914, and JP-1998-341202B2.
   Another item of interest is an abstract obtained from the Borealis website that states:
   Barbo Loefgren, E. Kokko, L. Huhtanen, M Lahelin, Petri Lehmus, Udo Stehling. “Metallocene-PP produced under supercritical conditions.” 1st Blue Sky Conference on Catalytic Olefin Polymerization, 17.-206.2002,
   Sorrrento, Italy., 2002. “mPP produced in bulk conditions (100% propylene), especially at elevated temperature and under supercritical conditions, shows rheological behaviour indicative for small amounts of LCB in the polymer. This is a feature that can be utilized to produce mPP with enhanced melt strength under industrially meaningful conditions.”

Another item of interest is a paper apparently presented by Luft and Walther at the Sep. 22-24, 2004 “High Pressure in Venice” conference (Venice, Italy), sponsored by Associazione Italiana Ingegneria Chimica, entitled “Metallocene-Catalyzed Polymerisation in Supercritical Propylene” describing the polymerization of propylene using dimethylsilyl bis(2-methyl-4-phenyl-indenyl)zirconium dichloride activated with methylalumoxane under supercritical conditions.

WO/2004 026921 discloses polymerization of olefins, including propylene, under supercritical conditions near or above the cloud point of a system with various single site catalyst systems.

WO 02/38628 describes nonmetallocene, metal-centered, heteroaryl ligand catalyst compounds and various uses therefor. WO2006/009976 discloses polymerizations in fluorocarbons with various nonmetallocene, metal-centered, heteroaryl ligand catalyst compounds.

Further WO03/040095, WO 03/040201; WO 03/040202; WO 03/040233; WO 03/040442; and U.S. Pat. No. 7,087,690, which describe nonmetallocene, metal-centered, heteroaryl ligand catalyst compounds, their polymer products, and various uses therefor.

### SUMMARY

This invention relates to a process to polymerize olefins comprising contacting, at a temperature of 60° C. or more and a pressure of between 15 MPa (150 Bar, or about 2175 psi) to 1500 MPa (1500 Bar, or about 21,750 psi), one or more olefin monomers having three or more carbon atoms, with:
1) a catalyst system comprising one or more activators and one or more nonmetallocene metal-centered, heteroaryl ligand catalyst compounds, where the metal is chosen from the Group 4, 5, 6, the lanthanide series, or the actinide series of the Periodic Table of the Elements,
2) optionally one or more comonomers,
3) optionally diluent or solvent, and
4) optionally scavenger,
   wherein:

a) the olefin monomers and any comonomers are present in the polymerization system at 40 weight % or more,

b) the monomer having three or more carbon atoms is present at 80 wt % or more based upon the weight of all monomers and comonomers present in the feed,

c) the polymerization occurs at a temperature above the solid-fluid phase transition temperature of the polymerization system and a pressure no lower than 2 MPa below the cloud point pressure of the polymerization system, in the event the solid-fluid phase transition temperature of the polymerization system cannot be determined then the polymerization occurs at a temperature above the fluid fluid phase transition temperature.

The polymerization system is the olefin monomers, any comonomer present, any diluent or solvent present, any scavenger present, and the polymer product.

### Definitions

For purposes of this invention and the claims thereto:
1. A catalyst system is defined to be the combination of one or more catalyst compounds and one or more activators. The term “catalyst compound” is used interchangeably herein with the terms “catalyst,” “catalyst precursor,” and “catalyst precursor compound.”
2. A dense fluid is a fluid (such as a liquid or supercritical fluid) having a density of at least 300 kg/m³.
3. The solid-fluid phase transition temperature is defined as the temperature below which a solid polymer phase separates from the homogeneous polymer-containing fluid medium at a given pressure. The solid-fluid phase transition temperature can be determined by temperature reduction at constant pressure starting from temperatures at which the polymer is fully dissolved in the fluid medium. The phase transition is observed as the system becoming turbid, when measured using the method described below for determining cloud point.
4. The solid-fluid phase transition pressure is defined as the pressure below which a solid polymer phase separates from the polymer-containing fluid medium at a given temperature. The solid-fluid phase transition pressure is determined by pressure reduction at constant temperature starting from pressures at which the polymer is fully dissolved in the fluid medium. The phase transition is observed as the system becoming turbid, when measured using the method described below for determining cloud point. Likewise the solid-fluid phase transition temperature is defined as the temperature below which a solid polymer phase separates from the polymer-containing fluid medium at a given pressure. The phase transition is observed as the system becoming turbid, when measured using the method described below for determining cloud point.
5. The fluid-fluid phase transition pressure is defined as the pressure below which two fluid phases—a polymer-rich phase and a monomer rich phase—form at a given temperature. The fluid-fluid phase transition pressure can be determined by pressure reduction at constant temperature starting from pressures at which the polymer is fully dissolved in the fluid medium. The phase transition is observed as the system becoming turbid, when measured using the method described below for determining cloud point.
6. The fluid-fluid phase transition temperature is defined as the temperature below which two fluid phases—a polymer-rich phase and a monomer rich phase—form at a given pressure. The fluid-fluid phase transition pressure can be determined by temperature reduction at constant pressure starting from temperatures at which the polymer is fully dissolved in the fluid medium. The phase transition is observed as the system becoming turbid, when measured using the method described below for determining cloud point.
7. The cloud point is the pressure below which, at a given temperature, the polymerization system becomes turbid as described in J. Vladimir Oliveira, C. Dariva and J. C. Pinto, Ind. Eng, Chem. Res. 29, 2000, 4627. For purposes of this invention and the claims thereto, the cloud point is measured by shining a helium laser through the selected polymerization system in a cloud point cell onto a photocell and recording the pressure at the onset of rapid increase in light scattering for a given temperature. Clould point pressure is the point at which at a given temperature, the polymerization system becomes turbid. Clould point temperature is the point at which at a given pressure, the polymerization system becomes turbid.
8. A higher α-olefin is defined to be an α-olefin having 4 or more carbon atoms.
9. The use of the term “polymerization” encompasses any polymerization reaction such as homopolymerization and copolymerization.
10. A copolymerization encompasses any polymerization reaction of two or more monomers.
11. The new numbering scheme for the Periodic Table Groups is used as published in CHEMICAL AND ENGINEERING NEWS, 63(5), 27 (1985).
12. When a polymer or oligomer is referred to as comprising an olefin, the olefin present in the polymer or oligomer is the polymerized or oligomerized form of the olefin.
13. An oligomer is defined to be compositions having 2-120 monomer units.
14. A polymer is defined to be compositions having 121 or more monomer units.
15. A polymerization system is defined to be monomer(s) plus comonomer(s) plus polymer(s) plus optional inert solvent(s)/diluent(s) plus optional scavenger(s). Note that for the sake of convenience and clarity, the catalyst system is always addressed separately in the present discussion from other components present in a polymerization reactor. In this regard, the polymerization system is defined here narrower than customary in the art of polymerization that typically considers the catalyst system as part of the polymerization system. In the current definition, the mixture present in the polymerization reactor and in its effluent is composed of the polymerization system plus the catalyst system.
16. The critical temperatures (Tc) and critical pressures (Pc) are those that found in the Handbook of Chemistry and Physics, David R. Lide, Editor-in-Chief, 82nd edition 2001-2002, CRC Press, LLC. New York, 2001. In particular, the Tc and Pc of various molecules are:

| | | Pc | | | |
|---|---|---|---|---|---|
| Name | Tc (K) | (MPa) | Name | Tc (K) | Pc (MPa) |
| Hexane | 507.6 | 3.025 | Propane | 369.8 | 4.248 |
| Isobutane | 407.8 | 3.64 | Toluene | 591.8 | 4.11 |
| Ethane | 305.3 | 4.872 | Methane | 190.56 | 4.599 |
| Cyclobutane | 460.0 | 4.98 | Butane | 425.12 | 3.796 |
| Cyclopentane | 511.7 | 4.51 | Ethylene | 282.34 | 5.041 |
| 1-butene | 419.5 | 4.02 | Propylene | 364.9 | 4.6 |
| 1-pentene | 464.8 | 3.56 | Cyclopentene | 506.5 | 4.8 |
| Pentane | 469.7 | 3.37 | Isopentane | 460.4 | 3.38 |
| Benzene | 562.05 | 4.895 | Cyclohexane | 553.8 | 4.08 |
| 1-hexene | 504.0 | 3.21 | Heptane | 540.2 | 2.74 |

273.2 K = 0° C.

17. The following abbreviations are used: Me is methyl, Ph is phenyl, Et is ethyl, Pr is propyl, iPr is isopropyl, n-Pr is normal propyl, Bu is butyl, iBu is isobutyl, tBu is tertiary butyl, p-tBu is para-tertiary butyl, TMS is trimethylsilyl, TIBA is trisobutylaluminum, MAO is methylalumoxane, pMe is para-methyl, flu is fluorenyl, cp is cyclopentadienyl, Ind is indenyl.
18. The term “continuous” is defined to mean a system that operates without interruption or cessation. For example a continuous process to produce a polymer would be one where the reactants are continually introduced into one or more reactors and polymer product is continually withdrawn.
19. A slurry polymerization means a polymerization process in which particulate, solid polymer forms in a dense fluid or in a liquid/vapor polymerization medium. The dense fluid polymerization medium can form a single or two fluid phases, such as liquid, supercritical fluid, or liquid/liquid, or supercritical fluid/supercritical fluid, polymerization medium. In the liquid/vapor polymerization medium the polymer resides in the liquid (dense) phase.
20. A solution polymerization means a polymerization process in which the polymer is dissolved in a liquid polymerization system, such as an inert solvent or monomer(s) or their blends. A solution polymerization is typically a homogeneous liquid polymerization system.
21. A supercritical polymerization means a polymerization process in which the polymerization system is in a dense, supercritical state.
22. A bulk polymerization means a polymerization process in which a dense fluid polymerization system contains less than 20 wt % of inert solvent or diluent. The product polymer may be dissolved in the dense fluid polymerization system or may form a solid phase. In this terminology, a slurry polymerization, in which solid polymer particulates form in a dense fluid polymerization system containing less than 20 wt % of inert solvent or diluent, is referred to as a bulk slurry polymerization process or bulk heterogeneous polymerization process. A polymerization process in which the polymeric product is dissolved in a dense fluid polymerization system containing less than 20 wt % of inert solvent or diluent is referred to as bulk homogeneous polymerization process. A polymerization process in which the polymeric product is dissolved in a liquid polymerization system containing less than 20 wt % of inert solvent or diluent is referred to as bulk solution polymerization process. A polymerization process in which the polymeric product is dissolved in a supercritical polymerization system containing less than 20 wt % of inert solvent or diluent is referred to as bulk homogeneous supercritical polymerization process.
23 Homogeneous supercritical polymerization refers to a polymerization process in which the polymer is dissolved in a supercritical fluid polymerization medium, such as an inert solvent or monomer or their blends in their supercritical state. Homogeneous supercritical polymerization is distinguished from heterogeneous supercritical polymerizations, such as for example, supercritical slurry processes, the latter of which are performed in supercritical fluids but form solid polymer particulates in the polymerization reactor. Similarly, bulk homogeneous supercritical polymerization is distinguished from bulk solution polymerization, the latter of which is performed in a liquid as opposed to in a supercritical polymerization system.
24. Homogeneous polymerization or a homogeneous polymerization system is a polymerization system where the polymer product is uniformly dissolved in the polymerization medium. Such systems are not turbid as described in J. Vladimir Oliveira, C. Dariva and J. C. Pinto, Ind. Eng, Chem. Res. 29, 2000, 4627. For purposes of this invention and the claims thereto, turbidity is measured by shining a helium laser through the selected polymerization system in a cloud point cell onto a photocell and determining the point of the onset of rapid increase in light scattering for a given polymerization system. Uniform dissolution in the polymerization medium is indicated when there is little or no light scattering (i.e. less than 5% change).
25. The term “NMCHL catalyst compound” means nonmetallocene, metal-centered, heteroaryl ligand catalyst compound.

Unless otherwise noted, all molecular weights units (e.g. Mw, Mn, Mz) are g/mol and all ppm's are wt ppm.

### DETAILED DESCRIPTION

This invention relates to a process to polymerize olefins comprising contacting, at a temperature of 60° C. or more (preferably between 90 and 200° C., preferably between 80 and 200° C., preferably between 90 to 180° C.) and a pressure of between 15 MPa and 1500 MPa (preferably between 15 and 250 MPa, preferably between 20 and 140 MPa), one or more olefin monomers having three or more carbon atoms (preferably propylene), with:
1) a catalyst system comprising one or more activators and one or more nonmetallocene metal-centered, heteroaryl ligand catalyst compounds, where the metal is chosen from the Group 4, 5, 6, the lanthanide series, or the actinide series of the Periodic Table of the Elements (preferably group 4, preferably Hf, Ti, or Zr),
2) from 0 to 20 wt % (alternately from 0.5 to 15 wt %, alternately from 1 to 10 wt %, alternately from 1 to 5 wt %) of one or more comonomers (based upon the weight of the polymerization system),
3) from 0 to 40 wt % (alternately from 0 to 20 wt %, alternately from 0.5 to 15 wt %, alternately from 1 to 10 wt %, alternately from 1 to 5 wt %) diluent or solvent (based upon the weight of the polymerization system) and/or from 0 to 40 wt % (alternately from 0 to 20 wt %, alternately from 0.5 to 15 wt %, alternately from 1 to 10 wt %, alternately from 1 to 5 wt %) diluent or solvent (based upon the weight of the feed), and
4) from 0 to 25 wt % (alternately from 0 to 20 wt %, alternately from 0.5 to 15 wt %, alternately from 1 to 10 wt %, alternately from 1 to 5 wt %) scavenger, preferably one or more alkyl aluminum compounds (based upon the weight of the polymerization system) and/or from 0 to 25 wt % (alternately from 0 to 20 wt %, alternately from 0.5 to 15 wt %, alternately from 1 to 10 wt %, alternately from 1 to 5 wt %) scavenger , preferably one or more alkyl aluminum compounds (based upon the weight of the feed),
   wherein:

a) the olefin monomers and any comonomers are present in the polymerization system at 40 weight % or more, (preferably 50 wt % or more, preferably 55 wt % or more, preferably 60 wt % or more, preferably 65 wt % or more, preferably 70 wt % or more, preferably 75 wt % or more, preferably 80 wt % or more, preferably 85 wt % or more),

b) the monomer having three or more carbon atoms is present at (75 wt % or more, preferably at 80 wt % or more, preferably 85 wt % or more, preferably 90 wt % or more, preferably 95 wt % or more) based upon the weight of all monomers and comonomers present in the feed, and/or the olefin monomers having three or more carbon atoms are present in the polymerization system at 40 weight % or more, preferably 55 wt % or more, preferably 75 wt % or more, and

c) the polymerization occurs at a temperature above the solid-fluid phase transition temperature of the polymerization system and a pressure no lower than 10 MPa below the cloud point pressure (CPP) of the polymerization system (preferably no lower than 8 MPa below the CPP, preferably no lower than 6 MPa below the CPP, preferably no lower than 4 MPa below the CPP, preferably no lower than 2 MPa below the CPP).

Preferably, the polymerization occurs at a temperature and pressure above the solid-fluid phase transition temperature and pressure of the polymerization system and, preferably above the fluid-fluid phase transition temperature and pressure of the polymerization system.

This invention further relates to a process to polymerize olefins comprising contacting, in a polymerization system, olefin monomers having three or more carbon atoms with an NMCHL catalyst compound, an activator, optionally scavenger, optionally comonomer, and optionally diluent or solvent under supercritical conditions, preferably at a temperature above the solid-fluid phase transition temperature and or pressure, more preferably above the fluid-fluid phase transition temperature and or pressure. Alternately the supercritical polymerization occurs above the cloud point temperature of the polymerization system and, optionally, at a pressure no lower than 10 MPa below the cloud point pressure of the polymerization system and less than 250 MPa, where the polymerization system is the monomer(s), any comonomer(s) present, any diluent or solvent present, any scavenger(s) present, and the polymer product, and preferably where the olefin monomers having three or more carbon atoms are present at 40 weight % or more in the polymerization system and/or the olefin monomers having three or more carbon atoms are present at 40 weight % or more in the feed.

The polymerization reaction typically is carried out at conditions where the product polymer is dissolved in the fluid reaction system comprising one or more monomers, the polymeric products, and—optionally—one or more inert solvents, and—optionally—one or more scavengers. The total amount of inert solvents is preferably not more than 20 wt % in the reactor feed. The fluid reaction medium can form one single fluid phase or two fluid phases. Operating in a single fluid phase is advantageous and operating in a single supercritical fluid phase is particularly advantageous.

In a useful embodiment, any hydrocarbon, fluorocarbon, or fluorohydrocarbon inert solvent or mixtures thereof can be used at concentrations of up to 40 wt % in the feeds (preferably up to 30 wt %, more preferably up to 20 wt %) to any individual polymerization reactor in the process of the present invention. Although inert solvents/diluents may be used if so desired, operating in an essentially solvent/diluent-free polymerization system comprising less than 10 wt %, alternately less than 5 wt %, alternately less than 1 wt % of inert solvent or diluent is typically advantageous due to, among other things, eliminating the cost of solvent and solvent handling.

The concentration of the inert solvent/diluents in the reactor feed is preferably not more than 40 wt %, preferably not more than 30 wt %, preferably not more than 20 wt %. The concentration of the inert solvent/diluents in the reactor feed is more preferably not more than 10 wt %. The concentration of the inert solvent/diluent in the reactor feed is alternately not more than 5 wt %. The concentration of the inert solvent/diluents in the reactor feed is alternately not more than 1 wt %.

The combined volume of monomer(s) and solvent/diluent in the feed (or alternately in the polymerization system) advantageously comprises at least 40 wt %, preferably at least 50 wt % of neat monomer, preferably at least 60 wt % neat monomer, more preferably at least 70 wt %, more preferably at least 80 wt %, more preferably at least 90 wt %, more preferably at least 95 wt %, based upon the weight of the monomers and any solvents or diluents.

In another embodiment the concentration of comonomer in the feed is 10 wt % or less, preferably 5 wt % or less, preferably 2.5 wt % or less, preferably 1 wt % or less, preferably 0 wt %. In another embodiment the concentration of comonomer in the polymerization system is 10 wt % or less, preferably 5 wt % or less, preferably 2.5 wt % or less, preferably 1 wt % or less, preferably 0 wt %.

In a preferred embodiment, the polymerization occurs at a temperature and pressure above the solid-fluid phase transition temperature of the polymerization system, preferably the polymerization occurs at a temperature at least 5° C. higher (preferably at least 10 ° C. higher, preferably at least 20 ° C. higher) than the solid-fluid phase transition temperature and at a pressure at least 2 MPa higher (preferably at least 5 MPa higher, preferably at least 10 MPa higher) than the cloud point pressure of the polymerization system. In a preferred embodiment, the polymerization occurs at a pressure above the fluid-fluid phase transition pressure of the polymerization system (preferably at least 2 MPa higher, preferably at least 5 MPa higher, preferably at least 10 MPa higher than the fluid-fluid phase transition pressure). Alternately, the polymerization occurs at a temperature at least 5° C. higher (preferably at least 10° C. higher, preferably at least 20° C. higher) than the solid-fluid phase transition temperature and at a pressure higher than, (preferably at least 2 MPa higher, preferably at least 5 MPa higher, preferably at least 10 MPa higher) than the fluid-fluid phase transition pressure of the polymerization system.

In another embodiment, the polymerization occurs at a temperature above the solid-fluid phase transition temperature of the polymer-containing fluid reaction medium at the reactor pressure, preferably at least 5° C. above the solid-fluid phase transition temperature of the polymer-containing fluid reaction medium at the reactor pressure, or preferably at least 10° C. above the solid-fluid phase transformation point of the polymer-containing fluid reaction medium at the reactor pressure.

In another useful embodiment, the polymerization occurs at a temperature above the cloud point of the single-phase fluid reaction medium at the reactor pressure, more preferably 2° C. or more (preferably 5° C. or more, preferably 10° C. or more, preferably 30° C. or more) above the cloud point of the fluid reaction medium at the reactor pressure. Alternately, in another useful embodiment, the polymerization occurs at a temperature above the cloud point of the polymerization system at the reactor pressure, more preferably 2° C. or more (preferably 5° C. or more, preferably 10° C. or more, preferably 30° C. or more) above the cloud point of the polymerization system.

The polymerization process temperature should be above the solid-fluid phase transition temperature of the polymer-containing fluid polymerization system at the reactor pressure, or at least 2° C. above the solid-fluid phase transition temperature of the polymer-containing fluid polymerization system at the reactor pressure, or at least 5° C. above the solid-fluid phase transition temperature of the polymer-containing fluid polymerization at the reactor pressure, or at least 10° C. above the solid-fluid phase transformation point of the polymer-containing fluid polymerization system at the reactor pressure. In another embodiment, the polymerization process temperature should be above the cloud point of the single-phase fluid polymerization system at the reactor pressure, or 2° C. or more above the cloud point of the fluid polymerization system at the reactor pressure. In still another embodiment, the polymerization process temperature is between 50 and 350° C., or between 60 and 250° C., or between 70 and 250° C., or between 80 and 250° C. Exemplary lower polymerization temperature limits are 50, or 60, or 70, or 80, or 90, or 95, or 100, or 110, or 120° C. Exemplary upper polymerization temperature limits are 350, or 250, or 240, or 230, or 220, or 210, or 200° C.

Preferably the polymerizations described herein are homogeneous polymerizations, preferably the polymerizations are homogeneous supercritical polymerizations. Preferably the polymerizations performed herein are performed at a pressure and temperature above the critical point and, preferably, the cloud point is above the critical point. In systems where monomers having three or more carbon atoms are present at 40% or more in the polymerization system, if the critical point cannot be determined, then the critical point shall be deemed to be at 60° C. and 4.6 MPa.

In certain embodiments, the polymerization is performed in a supercritical polymerization system. In such embodiments, the reaction temperature is above the critical temperature of the polymerization system. In some embodiments, some or all reactors operate at homogeneous supercritical polymerization conditions Said homogeneous supercritical polymerizations of the in-line blending processes disclosed herein may be carried out at the following temperatures. In one embodiment, the temperature is above the solid-fluid phase transition temperature of the polymer-containing fluid reaction medium at the reactor pressure or at least 5° C. above the solid-fluid phase transition temperature of the polymer-containing fluid reaction medium at the reactor pressure, or at least 10° C. above the solid-fluid phase transformation point of the polymer-containing fluid reaction medium at the reactor pressure. In another embodiment, the temperature is above the cloud point of the single-phase fluid reaction medium at the reactor pressure, or 2° C. or more above the cloud point of the fluid reaction medium at the reactor pressure. In yet another embodiment, the temperature is between 50 and 350° C., between 60 and 250° C., between 70 and 250° C., or between 80 and 250° C. In one embodiment, the temperature is above 50, 60, 70, 80, 90, 95, 100, 110, or 120° C. In another embodiment, the temperature is below 350, 250, 240, 230, 220, 210, or 200° C. In another embodiment, the cloud point temperature is above the supercritical temperature of the polymerization system or between 50 and 350° C., between 60 and 250° C., between 70 and 250° C., or between 80 and 250° C. In yet another embodiment, the cloud point temperature is above 50, 60, 70, 80, 90, 95, 100, 110, or 120° C. In still yet another embodiment, the cloud point temperature is below 350, 250, 240, 230, 220, 210, or 200° C.

In a preferred embodiment, the polymerization occurs at a pressure no lower than the solid-fluid phase transition pressure of the polymer-containing fluid reaction medium at the reactor temperature.

Exemplary, but not limiting, process pressures, are between 1 MPa (0.15 kpsi) to 500 MPa (72.3 kpsi), and more particularly between 1 MPa (0.15 kpsi) and 300 MPa (45 kpsi). In one embodiment, the polymerization process pressure should be no lower than the solid-fluid phase transition pressure of the polymer-containing fluid polymerization system at the reactor temperature. In another embodiment, the polymerization process pressure should be no lower than 10 MPa below the cloud point of the fluid polymerization system at the reactor temperature and less than 1500 MPa. In still another embodiment, the polymerization process pressure should be between 10 and 500 MPa, or between 10 and 300 MPa, or between 20 and 250 MPa. Exemplary lower pressure limits are 1, 10, 15, 18, 20, 25, and 30 MPa (0.15, 1.45, 2.18, 2.6, 2.9, 3.6, 4.4 kpsi, respectively). Exemplary upper pressure limits are 1500, 1000, 500, 300, 250, and 200 MPa (217, 145, 72.5, 43.5, 36.3, and 29 kpsi, respectively).

In a preferred embodiment, the polymerization occurs at a temperature above the solid-fluid phase transition temperature of the polymerization system and a pressure no lower than 5 MPa below the cloud point pressure of the polymerization system and less than 1000 MPa, preferably no lower than 4 MPa below the cloud point pressure, preferably no lower than 3 MPa below the cloud point pressure, preferably no lower than 2 MPa below the cloud point pressure, preferably no lower than 1 MPa below the cloud point pressure.

In certain embodiments, polymerization is performed in a supercritical polymerization system. In such embodiments, the reaction pressure is above the critical the pressure of the polymerization system. In some embodiments, some or all reactors operate at homogeneous supercritical polymerization conditions Said homogeneous supercritical polymerizations of the in-line blending processes disclosed herein may be carried out at the following pressures. The supercritical polymerization process of the in-line blending processes disclosed herein may be carried out at the following pressures. In one embodiment, the pressure is no lower than the crystallization phase transition pressure of the polymer-containing fluid reaction medium at the reactor temperature or no lower than 5 MPa below the cloud point of the fluid reaction medium at the reactor temperature. In another embodiment, the pressure is between 10 and 500 MPa, between 10 and 300 MPa, or between 20 and 250 MPa. In one form, the pressure is above 10, 15, 18, 20, 25, or 30 MPa. In another form, the pressure is below 1500, 500, 300, 250, or 200 MPa. In another form, the cloud point pressure is between 10 and 500 MPa, between 10 and 300 MPa, or between 20 and 250 MPa. In yet another form, the cloud point pressure is above 10, 15, 20, 25, or 30 MPa. In still yet another form, the cloud point pressure is below 1500, 500, 300, 250, or 200 MPa.

The processes of this invention preferably occur in a dense fluid polymerization medium, preferably in a homogeneous polymerization medium, preferably above the cloud point of the polymerization medium. A supercritical state exists for a substance when the substance's temperature and pressure are above its critical point. The critical pressure and critical temperature of a fluid may be altered by combining it with another fluid, such as a diluent or another monomer. Thus, a supercritical polymerization medium is in the state where the polymerization medium is present at a temperature and pressure above the critical temperature and critical pressure of the medium, respectively. All polymerizations described herein are typically performed at a temperature at or above the supercritical temperature of the polymerization system. Alternately, all polymerizations described herein are typically performed at a pressure at or above the supercritical pressure of the polymerization system. Alternately, all polymerizations described herein are typically performed at a temperature and pressure at or above the supercritical temperature and pressure of the polymerization system.

In some embodiments, one or more optional comonomers, diluents, or other fluids are present in the polymerization medium along with the monomer. Diluents, comonomers, and other fluids each modify the media's critical point; and hence, alter the pressure-temperature regime within which a particular medium is in a supercritical state. Diluents, comonomers and other fluids each also modify the phase behavior (and as such the cloud point) of the polymerization medium; and hence, alter the pressure-temperature regime within which a particular medium is single-phased. In a preferred embodiment, ethylene is present in the polymerization system at 10 wt % or less, preferably 8 wt % or less, preferably 6 wt % or less, preferably at 4 wt % or less, preferably 2 wt % or less preferably at 0%. In another preferred embodiment, ethylene is present in the feed at 10 wt % or less, preferably 8 wt % or less, preferably 6 wt % or less, preferably at 4 wt % or less, preferably 2 wt % or less preferably at 0%.

In a preferred embodiment, the cloud point of the polymerization system is above the supercritical point of the polymerization system, preferably at least 5° C. above the supercritical point, preferably at least 10° C. above the supercritical point, preferably at least 15° C. above the supercritical point, preferably at least 30° C. above the supercritical point, preferably at least 45° C. above the supercritical point.

The terms “two-phase polymerization system” or “two-phase polymerization medium” mean a system having two and, preferably, only two phases. In certain embodiments, the two phases are two fluid phases and are referenced as a “first phase” and a “second phase.” In certain embodiments, the first phase is or includes a “monomer phase,” which includes monomers and may also include solvent and some of the product of polymerization. Preferably, however, the monomer phase is essentially free of the polymer product. In propylene polymerization, the monomer phase can be referred to as the “propylene phase.” In certain embodiments, the second phase is or includes the polymeric product but also typically includes some other parts of the polymerization system, such as the monomers, inert solvents/diluents, etc. None of the parts of the catalyst system are considered to be part of the polymerization system and the catalyst system can be present in both the first and second phase. In some embodiments, certain parts of the catalyst system can be solid, e.g., supported catalysts. Although solid catalysts can be applied if so desired, polymerization with dissolved catalysts in a single fluid phase is typically advantageous and in a single supercritical fluid phase is particularly advantageous.

Some embodiments select the temperature and pressure so that the polymer produced in the reaction and the low molecular weight components of the polymerization system that solvate it remain homogeneous, preferably above the reaction medium's cloud point and above the solid-fluid phase transition point with that polymer. Other embodiments select the temperature and pressure so that the reaction medium remains supercritical, but at a pressure below the polymer's cloud point in the particular reaction medium. This results in a two-phase reaction medium: a polymer-rich fluid phase and a polymer-lean fluid phase. All embodiments that are below the polymer's cloud point preferably operate above the polymer's solid-fluid phase transition temperature. Among other things this has the benefit of avoiding fouling. Although polymerization can be performed in fluid phase below the cloud point of the polymerization system, homogeneous operations above the cloud point in a single fluid phase are typically advantageous.

Useful diluents for use in the present invention include one or more of C₂-C₂₄ alkanes, such as ethane, propane, n-butane, i-butane, n-pentane, i-pentane, n-hexane, mixed hexanes, mixed octanes, cyclopentane, cyclohexane, etc., single-ring aromatics, such as toluene and xylenes. In some embodiments the diluent comprises one or more of ethane, propane, butane, isobutane, isopentane, and hexanes. In any embodiment described herein the diluent may be recyclable.

Additional useful diluents also include C₄ to C₁₅₀ isoparaffins, preferably C₄ to C₁₀₀ isoparaffins, preferably C₄ to C₂₅ isoparaffins, more preferably C₄ to C₂₀ isoparaffins. By isoparaffin is meant that the paraffin chains possess C₁ to C₁₀ alkyl branching along at least a portion of each paraffin chain. More particularly, the isoparaffins are saturated aliphatic hydrocarbons whose molecules have at least one carbon atom bonded to at least three other carbon atoms or at least one side chain (i.e., a molecule having one or more tertiary or quaternary carbon atoms), and preferably wherein the total number of carbon atoms per molecule is in the range between 6 to 50, and between 10 and 24 in another embodiment, and from 10 to 15 in yet another embodiment. Various isomers of each carbon number will typically be present. The isoparaffins may also include cycloparaffins with branched side chains, generally as a minor component of the isoparaffin. Preferably, the density (ASTM 4052, 15.6/15.6° C.) of these isoparaffins ranges from 0.65 to 0.83 g/cm³; the pour point is −40° C. or less, preferably −50° C. or less, the viscosity (ASTM 445, 25° C.) is from 0.5 to 20 cSt at 25° C.; and the average molecular weights in the range of 100 to 300 g/mol. Some suitable isoparaffins are commercially available under the tradename ISOPAR (ExxonMobil Chemical Company, Houston Tex.), and are described in, for example, U.S. Pat. Nos. 6,197,285, 3,818,105 and 3,439,088, and sold commercially as ISOPAR series of isoparaffins. Other suitable isoparaffins are also commercial available under the trade names SHELLSOL (by Shell), SOLTROL (by Chevron Phillips) and SASOL (by Sasol Limited). SHELLSOL is a product of the Royal Dutch/Shell Group of Companies, for example Shellsol TM (boiling point=215-260° C.). SOLTROL is a product of Chevron Phillips Chemical Co. LP, for example SOLTROL 220 (boiling point=233-280° C.). SASOL is a product of Sasol Limited (Johannesburg, South Africa), for example SASOL LPA-210, SASOL-47 (boiling point=238-274° C.).

In another embodiment, useful diluents include C₄ to C₂₅ n-paraffins, preferably C₄ to C₂₀ n-paraffins, preferably C₄ to C₁₅ n-paraffins having less than 0.1 wt %, preferably less than 0.01 wt % aromatics. Some suitable n-paraffins are commercially available under the tradename NORPAR (ExxonMobil Chemical Company, Houston Tex.), and are sold commercially as NORPAR series of n-paraffins. In another embodiment preferred diluents include dearomaticized aliphatic hydrocarbon comprising a mixture of normal paraffins, isoparaffins and cycloparaffins. Typically they are a mixture of C₄ to C₂₅ normal paraffins, isoparaffins and cycloparaffins, preferably C₅ to C₁₈, preferably C₅ to C₁₂. They contain very low levels of aromatic hydrocarbons, preferably less than 0.1, preferably less than 0.01 aromatics. Suitable dearomatized aliphatic hydrocarbons are commercially available under the tradename EXXSOL (ExxonMobil Chemical Company, Houston Tex.), and are sold commercially as EXXSOL series of dearomaticized aliphatic hydrocarbons.

In another embodiment the diluent comprises up to 20 weight % of oligomers of C₆ to C₁₄ olefins and/or oligomers of linear olefins having 6 to 14 carbon atoms, more preferably 8 to 12 carbon atoms, more preferably 10 carbon atoms having a kinematic viscosity of 10 or more (as measured by ASTM D 445); and preferably having a viscosity index (“VI”), as determined by ASTM D-2270 of 100 or more.

In another embodiment the diluent comprises up to 20 weight % of oligomers of C₂₀ to C₁₅₀₀ paraffins, preferably C₄₀ to C₁₀₀₀ paraffins, preferably C₅₀ to C₇₅₀ paraffins, preferably C₅₀ to C₅₀₀ paraffins. In another embodiment the diluent comprises up to 20 weight % of oligomers of 1-pentene, 1-hexene, 1-heptene, 1-octene, 1-nonene, 1-decene, 1-undecene and 1-dodecene. Such oligomers are commercially available as SHF and SuperSyn PAO's (ExxonMobil Chemical Company, Houston Tex.). Other useful oligomers include those sold under the tradenames Synfluid™ available from ChevronPhillips Chemical Co. in Pasedena Tex., Durasyn™ available from BP Amoco Chemicals in London England, Nexbase™ available from Fortum Oil and Gas in Finland, Synton™ available from Crompton Corporation in Middlebury Conn., USA, EMERY™ available from Cognis Corporation in Ohio, USA.

In another embodiment, the diluent comprises a fluorinated hydrocarbon. Preferred fluorocarbons for use in this invention include perfluorocarbons (“PFC” or “PFC's”) and or hydrofluorocarbons (“HFC” or “HFC's”), collectively referred to as “fluorinated hydrocarbons” or “fluorocarbons” (“FC” or “FC's”). Fluorocarbons are defined to be compounds consisting essentially of at least one carbon atom and at least one fluorine atom, and optionally hydrogen atom(s). A perfluorocarbon is a compound consisting essentially of carbon atom and fluorine atom, and includes for example linear branched or cyclic, C₁ to C₄₀ perfluoroalkanes. A hydrofluorocarbon is a compound consisting essentially of carbon, fluorine and hydrogen. Preferred FC's include those represented by the formula: CₓH_{y}F_{z} wherein x is an integer from 1 to 40, alternately from 1 to 30, alternately from 1 to 20, alternately from 1 to 10, alternately from 1 to 6, alternately from 2 to 20 alternately from 3 to 10, alternately from 3 to 6, most preferably from 1 to 3, wherein y is an integer greater than or equal to 0 and z is an integer and at least one, more preferably, y and z are integers and at least one. For purposes of this invention and the claims thereto, the terms hydrofluorocarbon and fluorocarbon do not include chlorofluorocarbons.

In one embodiment, a mixture of fluorocarbons are used in the process of the invention, preferably a mixture of a perfluorinated hydrocarbon and a hydrofluorocarbon, and more preferably a mixture of a hydrofluorocarbons. In yet another embodiment, the hydrofluorocarbon is balanced or unbalanced in the number of fluorine atoms in the HFC used.

Non-limiting examples of fluorocarbons useful in this invention include any of the fluorocarbons listed at page 65 line 10 to page 66, line 31 of WO2006/009976. In addition to those fluorocarbons described herein, those fluorocarbons described in Raymond Will, et. al., CEH Marketing Report, Fluorocarbons, Pages 1-133, by the Chemical Economics Handbook-SRI International, April 2001, which is fully incorporated herein by reference, are included.

In another preferred embodiment, the fluorocarbon(s) used in the process of the invention are selected from the group consisting of difluoromethane, trifluoromethane, 1,1-difluoroethane, 1,1,1-trifluoroethane, and 1,1,1,2-tetrafluoroethane and mixtures thereof.

In one particularly preferred embodiment, the commercially available fluorocarbons useful in the process of the invention include HFC-236fa having the chemical name 1,1,1,3,3,3-hexafluoropropane, HFC-134a having the chemical name 1,1,1,2-tetrafluoroethane, HFC-245fa having the chemical name 1,1,1,3,3-Pentafluoropropane, HFC-365mfc having the chemical name1,1,1,3,3-pentafluorobutane, R-318 having the chemical name octafluorocyclobutane, and HFC-43-10mee having the chemical name 2,3-dihydrodecafluoropentane.

In another embodiment, the fluorocarbon is not a perfluorinated C4 to C10 alkane. In another embodiment, the fluorocarbon is not perfluorodecalin, perfluoroheptane, perfluorohexane, perfluoromethylcyclohexane, perfluorooctane, perfluoro-1,3-dimethylcyclohexane, perfluorononane, or perfluorotoluene. In another embodiment the fluorocarbon is present at more than 1 weight %, based upon the weight of the fluorocarbon and any hydrocarbon solvent present in the reactor, preferably greater than 3 weight %, preferably greater than 5 weight %, preferably greater than 7 weight %, preferably greater than 10 weight %, preferably greater than 15 weight %.

In some embodiments, the fluorocarbons are preferably present in the polymerization reaction system at 0 to 20 volume %, based upon the volume of the system, preferably the fluorocarbons are present at 0 to 10 volume %, preferably 0 to 5 volume %, preferably 0 to 1 volume %.

With regard to the polymerization system, preferred diluents and solvents are those that are soluble in and inert to the monomer and any other polymerization components at the polymerization temperatures and pressures.

As mentioned above, the polymerization processes described herein are preferably run under homogeneous conditions. This characteristic provides a lower pressure and temperature limit that determine the cloud point of the system. Temperature and pressure are also constrained on the upper end. The upper temperature range is the decomposition or ceiling temperature of polypropylene. Thermal catalyst decomposition also often provides another practical upper limit for polymerization temperature that is below the ceiling temperature of polypropylene.

It is expected that any temperature range can be combined with any pressure range, provided that the chosen temperature and pressure are such that the reaction medium is above its critical point and above its cloud point (or within 10 MPa of the cloud point). Preferably the selected polymerization conditions form a single supercritical fluid phase. Advantageously, the reaction medium has a density of 300 kg/m³ or more, preferably 350 kg/m³ or more, preferably 400 kg/m³ or more.

### Monomers

The process described herein can be used to polymerize any monomer having one or more (non-conjugated) aliphatic double bond(s) and two or more carbon atoms. Preferred monomers include a-olefins, such as ethylene, propylene, butene-1, hexene-1, octene-1, and decene-1, substituted olefins, such as styrene, vinylcyclohexane, etc., non-conjugated dienes, such as vinylcyclohexene, etc., α,ω)-dienes, such as 1,5-hexadiene, 1,7-octadiene, etc., cycloolefins, such as cyclopentene, cyclohexene, etc., norbornene, and the like.

In a preferred embodiment the processes of this invention are used to polymerize any unsaturated monomer or monomers. Preferred monomers include C₂ to C₁₀₀ olefins, preferably C₂ to C₆₀ olefins, preferably C₃ to C₄₀ olefins preferably C₃ to C₂₀ olefins, preferably C₃ to C₁₂ olefins. In some embodiments preferred monomers include linear, branched or cyclic alpha-olefins, preferably C₃ to C₁₀₀ alpha-olefins, preferably C₃ to C₆₀ alpha-olefins, preferably C₃ to C₄₀ alpha-olefins preferably C₃ to C₂₀ alpha-olefins, preferably C₃ to C₁₂ alpha-olefins. Preferred olefin monomers may be one or more of propylene, butene, pentene, hexene, heptene, octene, nonene, decene, dodecene, 4-methyl-pentene-1, 3-methyl pentene-1,3,5,5-trimethyl hexene 1, and 5-ethyl-1-nonene.

In another embodiment the polymer produced herein is a copolymer of one or more linear or branched C₃ to C₃₀ prochiral alpha-olefins or C₅ to C₃₀ ring containing olefins or combinations thereof capable of being polymerized by either stereospecific and non-stereospecific catalysts. Prochiral, as used herein, refers to monomers that favor the formation of isotactic or syndiotactic polymer when polymerized using stereospecific catalyst(s).

Preferred monomers may also include aromatic-group-containing monomers containing up to 30 carbon atoms. Suitable aromatic-group-containing monomers comprise at least one aromatic structure, preferably from one to three, more preferably a phenyl, indenyl, fluorenyl, or naphthyl moiety. The aromatic-group-containing monomer further comprises at least one polymerizable double bond such that after polymerization, the aromatic structure will be pendant from the polymer backbone. The aromatic-group containing monomer may further be substituted with one or more hydrocarbyl groups including but not limited to C₁ to C₁₀ alkyl groups. Additionally two adjacent substitutions may be joined to form a ring structure. Preferred aromatic-group-containing monomers contain at least one aromatic structure appended to a polymerizable olefinic moiety. Particularly preferred aromatic monomers include styrene, alpha-methylstyrene, para-alkylstyrenes, vinyltoluenes, vinylnaphthalene, allyl benzene, and indene, especially styrene, paramethyl styrene, 4-phenyl-1-butene and allyl benzene.

Non aromatic cyclic group containing monomers are also preferred. These monomers can contain up to 30 carbon atoms. Suitable non-aromatic cyclic group containing monomers preferably have at least one polymerizable olefinic group that is either pendant on the cyclic structure or is part of the cyclic structure. The cyclic structure may also be further substituted by one or more hydrocarbyl groups such as, but not limited to, C₁ to C₁₀ alkyl groups. Preferred non-aromatic cyclic group containing monomers include vinylcyclohexane, vinylcyclohexene, vinylnorbornene, ethylidene norbornene, cyclopentadiene, cyclopentene, cyclohexene, cyclobutene, vinyladamantane, norbornene, and the like.

Preferred diolefin monomers useful in this invention include any hydrocarbon structure, preferably C₄ to C₃₀, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e. di-vinyl monomers). More preferably, the diolefin monomers are linear di-vinyl monomers, most preferably those containing from 4 to 30 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, vinylnorbornene, norbornadiene, ethylidene norbornene, divinylbenzene, dicyclopentadiene or higher ring containing diolefins with or without substituents at various ring positions.

Non-limiting examples of preferred polar unsaturated monomers include 6-nitro-1-hexene, N-methylallylamine, N-allylcyclopentylamine, N-allyl-hexylamine, methyl vinyl ketone, ethyl vinyl ketone, 5-hexen-2-one, 2-acetyl-5-norbornene, 7-syn methoxymethyl-5-norbornen-2-one, acrolein, 2,2-dimethyl-4-pentenal, undecylenic aldehyde, 2,4-dimethyl-2,6-heptadienal, acrylic acid, vinylacetic acid, 4-pentenoic acid, 2,2-dimethyl-4-pentenoic acid, 6-heptenoic acid, trans-2,4-pentadienoic acid, 2,6-heptadienoic acid, nona-fluoro-1-hexene, allyl alcohol, 7-octene-1,2-diol, 2-methyl-3-buten-1-ol, 5-norbornene-2-carbonitrile, 5-norbornene-2-carboxaldehyde, 5-norbornene-2-carboxylic acid, cis-5-norbornene-endo-2,3-dicarboxylic acid, 5-norbornene-2,2,-dimethanol, cis-5-norbornene-endo-2,3-dicarboxylic anhydride, 5-norbornene-2-endo-3-endo-dimethanol, 5-norbornene-2-endo-3-exo-dimethanol, 5-norbornene-2-methanol, 5-norbornene-2-ol, 5-norbornene-2-yl acetate, 1-[2-(5-norbornene-2-yl)ethyl]-3,5,7,9,11,13,15-heptacyclopentylpentacyclo[9.5.1.1^{3,9}.1^{5,15},.1^{7,13}]octasiloxane, 2-benzoyl-5-norbornene, allyl 1,1,2,2,-tetrafluoroethyl ether, acrolein dimethyl acetal, butadiene monoxide, 1,2-epoxy-7-octene, 1,2-epoxy-9-decene, 1,2-epoxy-5-hexene, 2-methyl-2-vinyloxirane, allyl glycidyl ether, 2,5-dihydrofuran, 2-cyclopenten-1-one ethylene ketal, allyl disulfide, ethyl acrylate, methyl acrylate.

In a preferred embodiment the processes described herein may be used to produce homopolymers or copolymers. (For the purposes of this invention and the claims thereto a copolymer may comprise two, three, four or more different monomer units.) Useful polymers produced herein include homopolymers or copolymers of any of the above monomers. In one embodiment, the polymer is a homopolymer of any C₃ to C₁₂ alpha-olefin. In another embodiment, the polymer is a homopolymer or co-polymer of ethylene. Preferably the polymer is a homopolymer of propylene. In another embodiment, the polymer is a copolymer comprising propylene and ethylene, preferably the copolymer comprises less than 50 weight % ethylene, more preferably less than 40 weight % ethylene, preferably the copolymer comprises less than 30 weight % ethylene, more preferably less than 20 weight % ethylene. In another embodiment, the polymer is a copolymer comprising propylene and one or more of any of the monomers listed above. In another preferred embodiment, the copolymers comprises one or more diolefin comonomers, preferably one or more C₆ to C₄₀ non-conjugated diolefins, more preferably C₆ to C₄₀ α,ω-dienes.

In another preferred embodiment the polymer produced herein is a copolymer of propylene and one or more C₂ or C₄ to C₂₀ linear, branched or cyclic monomers, preferably one or more C₂ or C₄ to C₁₂ linear, branched or cyclic alpha-olefins. Preferably the polymer produced herein is a copolymer of propylene and one or more of ethylene, butene, pentene, hexene, heptene, octene, nonene, decene, dodecene, 4-methyl-pentene-1,3-methyl pentene-1, and 3,5,5-trimethyl hexene 1.

In another preferred embodiment, the copolymers produced herein are copolymers of propylene and up to 10 wt % of a comonomer (preferably up to 8 wt %, preferably up to 6 wt %, preferably up to 5 wt %, preferably up to 4 wt %, preferably up to 3 wt %, preferably up to 2 wt %), based upon the weight of the copolymer. In another preferred embodiment the polymer is a copolymer of propylene and up to 10 wt % (preferably up to 8 wt %, preferably up to 6 wt %, preferably up to 5 wt %, preferably up to 4 wt %, preferably up to 3 wt %, preferably up to 2 wt %) of a comonomer selected from the group consisting of ethylene, butene, pentene, hexene, octene, decene, dodecene, and mixtures thereof, based upon the weight of the copolymer. In an alternate embodiment, the copolymers produced herein are copolymers of a C₃ or greater monomer and up to 15 wt % of ethylene (preferably up to 12 wt %, preferably up to 9 wt %, preferably up to 6 wt %, preferably up to 3 wt %, preferably up to 2 wt %, preferably up to 1 wt %), based upon the weight of the copolymer. In an alternate embodiment, the copolymers produced here contain less than 1 wt % ethylene, preferably 0% ethylene.

In a preferred embodiment, the copolymers described herein comprise at least 50 mole % of a first monomer and up to 50 mole % of other monomers.

In another embodiment, the polymer comprises: a first monomer present at from 40 to 95 mole %, preferably 50 to 90 mole %, preferably 60 to 80 mole %, and a comonomer present at from 1 to 40 mole %, preferably 5 to 60 mole %, more preferably 5 to 40 mole %, and a termonomer present at from 0 to 10 mole %, more preferably from 0.5 to 5 mole %, more preferably 1 to 3 mole %.

In a preferred embodiment the first monomer comprises one or more of any C₃ to C₁₀ linear branched or cyclic alpha-olefins, including propylene, butene, (and all isomers thereof), pentene (and all isomers thereof), hexene (and all isomers thereof), heptene (and all isomers thereof), and octene (and all isomers thereof). Preferred monomers include propylene, 1-butene, 4-methylpentene-1,1-hexene, 1-octene, 1-decene, cyclohexene, cyclooctene, hexadiene, cyclohexadiene and the like.

In a preferred embodiment the comonomer comprises one or more of any C₂ to C₄₀ linear, branched or cyclic alpha-olefins, including ethylene, propylene, butene, pentene, hexene, heptene, and octene, nonene, decene, undecene, dodecene, hexadecene, butadiene, hexadiene, heptadiene, pentadiene, octadiene, nonadiene, decadiene, dodecadiene, styrene, 3,5,5- trimethylhexene-1,3-methylpentene-1,4-methylpentene-1, cyclopentadiene, and cyclohexene.

In a preferred embodiment the termonomer comprises one or more of any C₂ to C₄₀ linear, branched or cyclic alpha-olefins, including ethylene, propylene, butene, pentene, hexene, heptene, and octene, nonene, decene, un-decene, do-decene, hexadecene, butadiene, hexadiene, heptadiene, pentadiene, octadiene, nonadiene, decadiene, dodecadiene, styrene, 3,5,5-trimethyl hexene-1,3-methylpentene-1,4-methylpentene-1, cyclopentadiene, and cyclohexene.

In a preferred embodiment the polymers described above further comprise one or more dienes at up to 10 weight %, preferably at 0.00001 to 1.0 weight %, preferably 0.002 to 0.5 weight %, even more preferably 0.003 to 0.2 weight %, based upon the total weight of the composition. In some embodiments 500 wt ppm or less of diene is added to the polymerization, preferably 400 ppm or less, preferably or 300 ppm or less. In other embodiments at least 50 ppm of diene is added to the polymerization, or 100 ppm or more, or 150 ppm or more.

In another embodiment the processes described herein are used to produce propylene copolymers with other monomer units, such as ethylene, other α-olefin, α-olefinic diolefin, or non-conjugated diolefin monomers, for example C₄-C₂₀ olefins, C₄-C₂₀ diolefins, C₄-C₂₀ cyclic olefins, C₈-C₂₀ styrenic olefins. Other unsaturated monomers besides those specifically described above may be copolymerized using the invention processes, for example, styrene, alkyl-substituted styrene, ethylidene norbornene, norbornadiene, dicyclopentadiene, vinylcyclohexane, vinylcyclohexene, acrylates, and other olefinically-unsaturated monomers, including other cyclic olefins, such as cyclopentene, norbornene, and alkyl-substituted norbornenes. Copolymerization can also incorporate α-olefinic macromonomers produced in-situ or added from another source. Some invention embodiments limit the copolymerization of α-olefinic macromonomers to macromonomers with 2000 or less mer units. U.S. Pat. No. 6,300,451 discloses many useful comonomers. That disclosure refers to comonomers as “a second monomer”.

In another embodiment, when propylene copolymers are desired, the following monomers can be copolymerized with propylene: ethylene, but-1-ene, hex-1-ene, 4-methylpent-1-ene, dicyclopentadiene, norbornene, C₄-C₂₀₀₀, C₄-C₂₀₀, or C₄-C₄₀ linear or branched, α,ω-dienes; C₄-C₂₀₀₀, C₄-C₂₀₀, or C₄-C₄₀ cyclic olefins; and C₄-C₂₀₀₀, C₄-C₂₀₀, or C₄-C₄₀ linear or branched α-olefins.

### Other Primary Monomer

Some invention processes polymerize 1-butene (T_{c}=146.5° C.; P_{c}=3.56 MPa), 1-pentene (T_{c}=191.8° C.; P_{c}=3.56 MPa), 1-hexene (T_{c}=230.8° C.; P_{c}=3.21 MPa), and 3-methyl-butene-1 (T_{c}=179.7° C.; P_{c}=3.53 MPa) using these monomers or mixtures comprising the monomers at supercritical conditions as the reaction medium or solvent. These processes can employ at least one of 1-butene, 1-pentene, or 3-methyl-butene-1 as monomer. These processes can also employ reaction media that comprise 1-butene, 1-pentene, or 3-methyl-butene-1. These processes can employ reaction media that contain greater than 50 wt % of 1-butene, 1-pentene, or 3-methyl-butene-1. Of course, these compounds can be freely mixed with each other and with propylene as monomer, bulk reaction media, or both.

### Catalyst Introduction

The processes described herein are practiced with a catalyst system comprising one or more nonmetallocene metal-centered, heteroaryl ligand catalyst compounds (where the metal is chosen from the Group 4, 5, 6, the lanthanide series, or the actinide series of the Periodic Table of the Elements) in combination with an activator. The process of the present invention can use one or more catalysts in any of the reactors of the polymerization reactor section or in any polymerization described herein.

The process of the present invention can use the same or different catalysts or catalyst mixtures in the different individual reactors of the reactor section of the present invention. For practical reasons, the deployment of no more than ten catalysts is preferred and the deployment of no more than six catalysts is more preferred in the polymerization process of the present invention. Further in alternate embodiments, no more than five catalysts are used and no more than three catalysts are used in any given reactor.

The one or more catalysts deployed in the process of the present invention can be homogeneously dissolved in the fluid reaction medium or can form a heterogeneous solid phase in the reactor. Operations with homogeneously dissolved catalysts are advantageous, particularly where unsupported catalyst systems are homogeneously dissolved in the polymerization system. Unsupported catalysts dissolved in the fluid reaction medium are also preferred. When the catalyst is present as a solid phase in the polymerization reactor, it can be supported or unsupported. Silica, silica-alumina and other like supported are particularly useful as supports as further described below. The catalyst can also be supported on structured supports, such as monoliths comprising straight or tortuous channels, reactor walls, internal tubing, etc. These structured supports are well known in the art of heterogeneous catalysis. When the catalyst(s) is (are) supported, operation with dispersed particles is preferred. When the catalyst is supported on dispersed particles, operations without catalyst recovery are preferred, i.e., the catalyst is left in the polymeric product of the process of the present invention.

The process of the present invention can use any combination of homogeneous and heterogeneous catalysts simultaneously present in one or more of the individual reactors of the polymerization reactor section, i.e., any reactor of the polymerization section of the present invention may contain one or more homogeneous catalysts and one or more heterogeneous catalysts simultaneously. Likewise, the process of the present invention can use any combination of homogeneous and heterogeneous catalysts deployed in the polymerization reactor section of the present invention. These combinations comprise scenarios when some or all reactors use a single catalyst and scenarios when some or all reactors use more than one catalyst.

One or more catalysts deployed in the process of the present invention can be supported on particles, which either can be dispersed in the fluid polymerization medium or can be contained in a stationary catalyst bed. When the supported catalyst particles are dispersed in the fluid reaction medium, they can be left in the polymeric product or can be separated from the product prior to its recovery from the fluid reactor effluent in a separation step that is typically downstream of the polymerization reactor section. If the catalyst particles are recovered, they can be either discarded or can be recycled with or without regeneration.

The catalyst(s) can be introduced any number of ways to the reactor. For example, the catalyst(s) can be introduced with the monomer-containing feed or separately. Also, the catalyst(s) can be introduced through one or multiple ports to the reactor. If multiple ports are used for introducing the catalyst(s), those ports can be placed at essentially the same or at different positions along the length of the reactor. Further if multiple ports are used for introducing the catalyst(s), the composition and the amount of catalyst feed through the individual ports can be the same or different. Adjustment in the amounts and types of catalyst through the different ports enables the modulation of polymer properties, such as molecular weight distribution, composition, composition distribution, crystallinity, etc.

In order to reduce catalyst cost, compounds destroying impurities that harm the catalyst(s) thus reducing its (their) activity can be optionally fed to the reactor(s). These impurity-destroying compounds are called scavengers in the practice of polymerization.

Any type of scavenger compounds can be fed to the reactor(s) that can destroy impurities harmful to the catalyst and thus reducing the observed catalytic productivity.

The scavenger can be the same or different chemical compound(s) as applied as catalyst activator. Useful scavengers include alkyl-aluminum compounds including alumoxanes, preferably the scavenger is one or more compounds represented by the formula: AlR*₃, where R* is a C₁ to C₂₀ hydrocarbyl group, preferably methyl, ethyl, butyl, hexyl, octyl, nonyl decyl and dodecyl, preferably the scavenger is one or more of trimethyl-aluminum, triethyl-aluminum, tri-isobutyl aluminum, trioctyl-aluminum, and the like. The scavenger also can be the same as the catalyst activator, for example, alumoxanes, such as methylalumoxane (MAO), etc., applied in excess of what is needed to fully activate the catalyst. The scavenger can be introduced to the reactor with the monomer feed or with any other feed stream. Scavenger introduction with the monomer-containing feed is typically advantageous because the scavenger can react with the impurities present in the monomer feed before the monomer feed contacts the catalyst.

The scavenger can be homogeneously dissolved in the polymerization reaction medium or can form a separate solid phase. Scavengers dissolved in the polymerization medium are advantageous.

### Catalyst Systems

The processes described herein are practiced with a catalyst system comprising one or more nonmetallocene metal-centered, heteroaryl ligand catalyst compounds (where the metal is chosen from the Group 4, 5, 6, the lanthanide series, or the actinide series of the Periodic Table of the Elements) in combination with an activator. Preferably, the transition metal is from Group 4, especially Ti or Zr or Hf. More specifically, in certain embodiments of the catalyst compound, the use of a hafnium metal is preferred as compared to a zirconium metal for heteroaryl ligand catalysts. For more information on nonmetallocene metal-centered, heteroaryl ligand catalyst compounds please see WO 2006/38628.

The catalyst compounds used in the practice of this invention include catalysts comprising ancillary ligand-hafnium complexes, ancillary ligand-zirconium complexes, which when optionally combined with an activator) catalyze polymerization and copolymerization reactions, particularly with monomers that are olefins, diolefins or other unsaturated compounds. Zirconium complexes, hafnium complexes, compositions or compounds using the disclosed ligands are within the scope of the catalysts useful in the practice of this invention. The metal-ligand complexes may be in a neutral or charged state. The ligand to metal ratio may also vary, the exact ratio being dependent on the nature of the ligand and metal-ligand complex. The metal-ligand complex or complexes may take different forms, for example, they may be monomeric, dimeric or of an even higher order.

For example, suitable ligands useful in the practice of this invention may be broadly characterized by the following general formula(1):

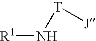

wherein R¹ is a ring having from 4-8 atoms in the ring generally selected from the group consisting of substituted cycloalkyl, substituted heterocycloalkyl, substituted aryl and substituted heteroaryl, such that R¹ may be characterized by the general formula(2):

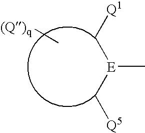

where Q¹ and Q⁵ are substituents on the ring other than to atom E, with E being selected from the group consisting of carbon and nitrogen and with at least one of Q¹ or Q⁵ being bulky (defined as having at least 2 atoms). Q″_{q} represents additional possible substituents on the ring, with q being 1, 2, 3, 4 or 5 and Q″ being selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, halide, nitro, and combinations thereof. T is a bridging group selected group consisting of —CR²R³— and —SiR²R³— with R² and R³ being independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, halide, nitro, and combinations thereof. J″ is generally selected from the group consisting of heteroaryl and substituted heteroaryl, with particular embodiments for particular reactions being described herein.

Also for example, in some embodiments, the ligands of the catalyst used in the practice of this invention may be combined with a metal catalyst compound that may be characterized by the general formula M(L)ₙ where M is Hf or Zr, preferably Hf, L is independently selected from the group consisting of halide (F, Cl, Br, I), alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations thereof. n is 1, 2, 3, 4, 5, or 6.

Preferred ligand-metal complexes useful herein may be generally characterized by the following formula (3):

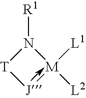

where M is zirconium or hafnium;

R¹ and T are as defined above;

J′″ being selected from the group of substituted heteroaryls with 2 atoms bonded to the metal M, at least one of those atoms being a heteroatom, and with one atom of J′″ is bonded to M via a dative bond, the other through a covalent bond; and

L¹ and L² are independently selected from the group consisting of halide, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations of these radicals.

For purposes of this invention, “nonmetallocene” means that the metal of the catalyst is not attached to a substituted or unsubstituted cyclopentadienyl ring. Representative nonmetallocene, metal-centered, heteroaryl ligand catalysts are described in U.S. Provisional Patent Application No. 60/246,781 filed Nov. 7, 2000 and No. 60/301,666 filed Jun. 28, 2001, which are incorporated by reference herein. Additionally, useful nonmetallocene, metal-centered, heteroaryl ligand catalysts (and activators useful therewith) are also described in WO 2003/040201, see particularly page 36, line 18 to page 64 line 30. Also, representative nonmetallocene, metal-centered, heteroaryl ligand catalysts described in U.S. patent application Ser. No. 7,087,690 filed Nov. 25, 2003, are incorporated by reference herein.

As here used, “nonmetallocene, metal-centered, heteroaryl ligand catalyst” means the catalyst derived from the ligand described in formula (1). As used in this phrase, “heteroaryl” includes substituted heteroaryl.

As used herein, the phrases “characterized by the formula” and “represented by the formula” are not intended to be limiting and is used in the same way that “comprising” is commonly used. The term “independently selected” is used herein to indicate that the R groups, e.g., R¹, R², R³, R⁴, and R⁵ can be identical or different (e.g. R¹, R², R³, R⁴, and R⁵ may all be substituted alkyls or R¹ and R² may be a substituted alkyl and R³ may be an aryl, etc.). Use of the singular includes use of the plural and vice versa (e.g., a hexane solvent, includes hexanes). A named R group will generally have the structure that is recognized in the art as corresponding to R groups having that name. The terms “compound” and “complex” are generally used interchangeably in this specification, but those of skill in the art may recognize certain compounds as complexes and vice versa. For the purposes of illustration, representative certain groups are defined herein. These definitions are intended to supplement and illustrate, not preclude, the definitions known to those of skill in the art.

“Hydrocarbyl” refers to univalent hydrocarbyl radicals containing 1 to about 30 carbon atoms, preferably 1 to about 24 carbon atoms, most preferably 1 to about 12 carbon atoms, including branched or unbranched, saturated or unsaturated species, such as alkyl groups, alkenyl groups, aryl groups, and the like. “Substituted hydrocarbyl” refers to hydrocarbyl substituted with one or more substituent groups, and the terms “heteroatom-containing hydrocarbyl” and “heterohydrocarbyl” refer to hydrocarbyl in which at least one carbon atom is replaced with a heteroatom.

The term “alkyl” is used herein to refer to a branched or unbranched, saturated or unsaturated acyclic hydrocarbon radical. Suitable alkyl radicals include, for example, methyl, ethyl, n-propyl, i-propyl, 2-propenyl (or allyl), vinyl, n-butyl, t-butyl, i-butyl (or 2-methylpropyl), etc. In particular embodiments, alkyls have between 1 and 200 carbon atoms, between 1 and 50 carbon atoms or between 1 and 20 carbon atoms.

“Substituted alkyl” refers to an alkyl as just described in which one or more hydrogen atom bound to any carbon of the alkyl is replaced by another group such as a halogen, aryl, substituted aryl, cycloalkyl, substituted cycloalkyl, heterocycloalkyl, substituted heterocycloalkyl, halogen, alkylhalos (e.g., CF₃), hydroxy, amino, phosphido, alkoxy, amino, thio, nitro, and combinations thereof. Suitable substituted alkyls include, for example, benzyl, trifluoromethyl and the like.

The term “heteroalkyl” refers to an alkyl as described above in which one or more hydrogen atoms to any carbon of the alkyl is replaced by a heteroatom selected from the group consisting of N, O, P, B, S, Si, Sb, Al, Sn, As, Se and Ge. This same list of heteroatoms is useful throughout this specification. The bond between the carbon atom and the heteroatom may be saturated or unsaturated. Thus, an alkyl substituted with a heterocycloalkyl, substituted heterocycloalkyl, heteroaryl, substituted heteroaryl, alkoxy, aryloxy, boryl, phosphino, amino, silyl, thio, or seleno is within the scope of the term heteroalkyl. Suitable heteroalkyls include cyano, benzoyl, 2-pyridyl, 2-furyl and the like.

The term “cycloalkyl” is used herein to refer to a saturated or unsaturated cyclic non-aromatic hydrocarbon radical having a single ring or multiple condensed rings. Suitable cycloalkyl radicals include, for example, cyclopentyl, cyclohexyl, cyclooctenyl, bicyclooctyl, etc. In particular embodiments, cycloalkyls have between 3 and 200 carbon atoms, between 3 and 50 carbon atoms or between 3 and 20 carbon atoms.

“Substituted cycloalkyl” refers to cycloalkyl as just described including in which one or more hydrogen atom to any carbon of the cycloalkyl is replaced by another group such as a halogen, alkyl, substituted alkyl, aryl, substituted aryl, cycloalkyl, substituted cycloalkyl, heterocycloalkyl, substituted heterocycloalkyl, heteroaryl, substituted heteroaryl, alkoxy, aryloxy, boryl, phosphino, amino, silyl, thio, seleno and combinations thereof. Suitable substituted cycloalkyl radicals include, for example, 4-dimethylaminocyclohexyl, 4,5-dibromocyclohept-4-enyl, and the like.

The term “heterocycloalkyl” is used herein to refer to a cycloalkyl radical as described, but in which one or more or all carbon atoms of the saturated or unsaturated cyclic radical are replaced by a heteroatom such as nitrogen, phosphorous, oxygen, sulfur, silicon, germanium, selenium, or boron. Suitable heterocycloalkyls include, for example, piperazinyl, morpholinyl, tetrahydropyranyl, tetrahydrofuranyl, piperidinyl, pyrrolidinyl, oxazolinyl and the like.

“Substituted heterocycloalkyl” refers to heterocycloalkyl as just described including in which one or more hydrogen atom to any atom of the heterocycloalkyl is replaced by another group such as a halogen, alkyl, substituted alkyl, aryl, substituted aryl, heteroaryl, substituted heteroaryl, alkoxy, aryloxy, boryl, phosphino, amino, silyl, thio, seleno and combinations thereof. Suitable substituted heterocycloalkyl radicals include, for example, N-methylpiperazinyl, 3-dimethylaminomorpholinyl and the like.

The term “aryl” is used herein to refer to an aromatic substituent which may be a single aromatic ring or multiple aromatic rings which are fused together, linked covalently, or linked to a common group such as a methylene or ethylene moiety. The aromatic ring(s) may include phenyl, naphthyl, anthracenyl, and biphenyl, among others. In particular embodiments, aryls have between 1 and 200 carbon atoms, between 1 and 50 carbon atoms or between 1 and 20 carbon atoms.

“Substituted aryl” refers to aryl as just described in which one or more hydrogen atom bound to any carbon is replaced by one or more functional groups such as alkyl, substituted alkyl, cycloalkyl, substituted cycloalkyl, heterocycloalkyl, substituted heterocycloalkyl, halogen, alkylhalos (e.g., CF₃), hydroxy, amino, phosphido, alkoxy, amino, thio, nitro, and both saturated and unsaturated cyclic hydrocarbons which are fused to the aromatic ring(s), linked covalently or linked to a common group such as a methylene or ethylene moiety. The common linking group may also be a carbonyl as in benzophenone or oxygen as in diphenylether or nitrogen in diphenylamine.

The term “heteroaryl” as used herein refers to aromatic or unsaturated rings in which one or more carbon atoms of the aromatic ring(s) are replaced by a heteroatom(s) such as nitrogen, oxygen, boron, selenium, phosphorus, silicon or sulfur. Heteroaryl refers to structures that may be a single aromatic ring, multiple aromatic ring(s), or one or more aromatic rings coupled to one or more non-aromatic ring(s). In structures having multiple rings, the rings can be fused together, linked covalently, or linked to a common group such as a methylene or ethylene moiety. The common linking group may also be a carbonyl as in phenyl pyridyl ketone. As used herein, rings such as thiophene, pyridine, isoxazole, pyrazole, pyrrole, furan, etc. or benzo-fused analogues of these rings are defined by the term “heteroaryl.”

“Substituted heteroaryl” refers to heteroaryl as just described including in which one or more hydrogen atoms bound to any atom of the heteroaryl moiety is replaced by another group such as a halogen, alkyl, substituted alkyl, aryl, substituted aryl, heteroaryl, substituted heteroaryl, alkoxy, aryloxy, boryl, phosphino, amino, silyl, thio, seleno and combinations thereof. Suitable substituted heteroaryl radicals include, for example, 4-N,N-dimethylaminopyridine.

The term “alkoxy” is used herein to refer to the —OZ¹ radical, where Z¹ is selected from the group consisting of alkyl, substituted alkyl, cycloalkyl, substituted cycloalkyl, heterocylcoalkyl, substituted heterocycloalkyl, silyl groups and combinations thereof as described herein. Suitable alkoxy radicals include, for example, methoxy, ethoxy, benzyloxy, t-butoxy, etc. A related term is “aryloxy” where Z¹ is selected from the group consisting of aryl, substituted aryl, heteroaryl, substituted heteroaryl, and combinations thereof. Examples of suitable aryloxy radicals include phenoxy, substituted phenoxy, 2-pyridinoxy, 8-quinalinoxy and the like.

As used herein the term “silyl” refers to the —SiZ¹Z²Z³ radical, where each of Z¹ and Z² and Z³ is independently selected from the group consisting of hydrogen, alkyl, substituted alkyl, cycloalkyl, heterocycloalkyl, heterocyclic, aryl, substituted aryl, heteroaryl, substituted heteroaryl, alkoxy, aryloxy, amino, silyl and combinations thereof.

As used herein the term “boryl” refers to the —BZ¹Z² group, where each of Z¹ and Z² is independently selected from the group consisting of hydrogen, alkyl, substituted alkyl, cycloalkyl, heterocycloalkyl, heterocyclic, aryl, substituted aryl, heteroaryl, substituted heteroaryl, alkoxy, aryloxy, amino, silyl and combinations thereof.

As used herein, the term “phosphino” refers to the group: —PZ¹Z², where each of Z¹ and Z² is independently selected from the group consisting of hydrogen, substituted or unsubstituted alkyl, cycloalkyl, heterocycloalkyl, heterocyclic, aryl, substituted aryl, heteroaryl, silyl, alkoxy, aryloxy, amino and combinations thereof.

As used herein, the term “phosphine” refers to the group: —PZ¹Z²Z³, where each of Z¹ and Z² and Z³ is independently selected from the group consisting of hydrogen, substituted or unsubstituted alkyl, cycloalkyl, heterocycloalkyl, heterocyclic, aryl, substituted aryl, heteroaryl, silyl, alkoxy, aryloxy, amino and combinations thereof.

The term “amino” is used herein to refer to the group —NZ¹Z², where each of Z¹ and Z² is independently selected from the group consisting of hydrogen, alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof.

The term “amine” is used herein to refer to the group: —NZ¹Z²Z³, where each of Z¹ and Z² and Z³ is independently selected from the group consisting of hydrogen, alkyl, substituted alkyl, cycloalkyl, substituted cycloalkyl, heterocycloalkyl, substituted heterocycloalkyl, aryl (including pyridines), substituted aryl, heteroaryl, substituted heteroaryl, alkoxy, aryloxy, silyl and combinations thereof.

The term “thio” is used herein to refer to the group —SZ¹, where Z¹ is selected from the group consisting of hydrogen, alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof.

The term “seleno” is used herein to refer to the group —SeZ¹, where Z¹ is selected from the group consisting of hydrogen, alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof.

The term “saturated” refers to lack of double and triple bonds between atoms of a radical group such as ethyl, cyclohexyl, pyrrolidinyl, and the like.

The term “unsaturated” refers to the presence one or more double and/or triple bonds between atoms of a radical group such as vinyl, acetylide, oxazolinyl, cyclohexenyl, acetyl and the like.

### Ligands

Suitable ligands useful in the catalysts used in the practice of this invention can be characterized broadly as monoanionic ligands having an amine and a heteroaryl or substituted heteroaryl group. The ligands of the catalysts used in the practice of this invention are referred to, for the purposes of this invention, as nonmetallocene ligands, and may be characterized by the following general formula(1):

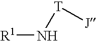

wherein R¹ is very generally selected from the group consisting of alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl and combinations thereof. In many embodiments, R¹ is a ring having from 4-8 atoms in the ring generally selected from the group consisting of substituted cycloalkyl, substituted heterocycloalkyl, substituted aryl and substituted heteroaryl, such that R¹ may be characterized by the general formula (2):

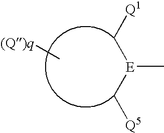

where Q¹ and Q⁵ are substituents on the ring ortho to atom E, with E being selected from the group consisting of carbon and nitrogen and with at least one of Q¹ or Q⁵ being bulky (defined as having at least 2 atoms). Q¹ and Q⁵ are independently selected from the group consisting of alkyl, substituted alkyl, cycloalkyl, substituted cycloalkyl, aryl, substituted aryl and silyl, but provided that Q¹ and Q⁵ are not both methyl. Q″q represents additional possible substituents on the ring, with q being 1, 2, 3, 4 or 5 and Q″ being selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, halide, nitro, and combinations thereof. T is a bridging group selected group consisting of —CR²R³— and —SiR²R³— with R² and R³ being independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, halide, nitro, and combinations thereof. J″ is generally selected from the group consisting of heteroaryl and substituted heteroaryl, with particular embodiments for particular reactions being described herein.

In a more specific embodiment, suitable nonmetallocene ligands useful in this invention may be characterized by the following general formula (4):

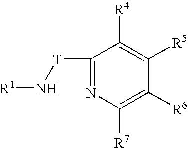

wherein R¹ and T are as defined above and each of R⁴, R⁵, R⁶ and R⁷ is independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, halide, nitro, and combinations thereof. Optionally, any combination of R⁴, R⁵, R⁶ and R⁷ may be joined together in a ring structure.

In certain more specific embodiments, the ligands in this invention may be characterized by the following general formula (5):

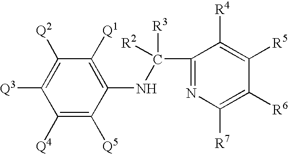

wherein Q¹, Q⁵, R⁴, R⁵, R⁶ and R⁷ are as defined above. Q², Q³, Q⁴, R², and R³ are independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, nitro, and combinations thereof.

In other more specific embodiments, the ligands of this invention and suitable herein may be characterized by the following general formula (6):

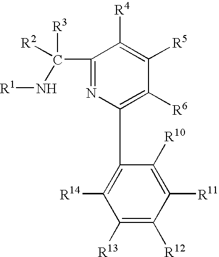

wherein R¹, R², R³, R⁴, R⁵, and R⁶ are as defined above. In this embodiment the R⁷ substituent has been replaced with an aryl or substituted aryl group, with R¹⁰, R¹¹, R¹² and R¹³ being independently selected from the group consisting of hydrogen, halo, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxy, aryloxy, silyl, boryl, phosphino, amino, thio, seleno, nitro, and combinations thereof, optionally, two or more R¹⁰, R¹¹, R¹² and R¹³ groups may be joined to form a fused ring system having from 3-50 non-hydrogen atoms. R¹⁴ is selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxy, aryloxy, silyl, boryl, phosphino, amino, thio, seleno, halide, nitro, and combinations thereof.

In still more specific embodiments, the ligands in this invention may be characterized by the general formula (7):

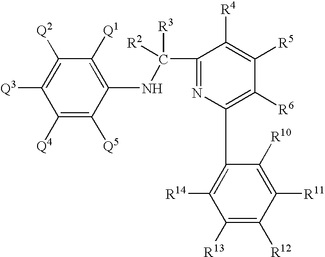

wherein R²—R⁶, R¹⁰—R¹⁴ and Q¹-Q⁵ are all as defined above.

In certain embodiments, R² is preferably hydrogen. Also preferably, each of R⁴ and R⁵ is hydrogen and R⁶ is either hydrogen or is joined to R⁷ to form a fused ring system. Also preferred is where R³ is selected from the group consisting of benzyl, phenyl, 2-biphenyl, t-butyl, 2-dimethylaminophenyl (2-(NMe₂)—C₆H₄—) (where Me is methyl), 2-methoxyphenyl (2-MeO—C₆H₄—), anthracenyl, mesityl, 2-pyridyl, 3,5-dimethylphenyl, o-tolyl, 9phenanthrenyl. Also preferred is where R¹ is selected from the group consisting of mesityl, 4 isopropylphenyl (4-Pr^{j}—C₆H₄—), napthyl, 3,5—(CF₃)₂ —C₆H₃, 2-Me-napthyl, 2,6-(Pr^{j})₂—C₆H₃—, 2-biphenyl, 2-Me-4-MeO—C₆H₃—; 2-Bu^{t}-C₆H₄—, 2,5-(Bu^{t})_{2.}—C₆H₃—, 2-Pr^{j}-6-Me-C₆H₃—; 2—Bu^{t}-6-Me-C₆H₃—, 2,6-Et₂-C₆H₃—, 2-sec-butyl-6-Et-C₆H₃—. Also preferred is where R⁷ is selected from the group consisting of hydrogen, phenyl, napthyl, methyl, anthracenyl, 9-phenanthrenyl, mesityl, 3,5-(CF₃)₂—C₆H₃—, 2-CF₃—C₆H₄—, 4-CF₃—C₆H₄—, 3,5-F₂—C₆H₃—, 4-F—C₆H₄—, 2,4-F—C₄H₃—, 4-(NMe₂)—C₆H₄—, 3-MeO—C₆H₄—, 4-MeO—C₆H₄—, 3,5-Me₂-C₆H₃—, o-tolyl, 2,6-F₂—C₆H₃— or where R⁷ is joined together with R⁶ to form a fused ring system, e.g., quinoline.

Also optionally, two or more R⁴, R⁵, R⁶, or R⁷ groups may be joined to form a fused ring system having from 3-50 non-hydrogen atoms in addition to the pyridine ring, e.g. generating a quinoline group. In these embodiments, R³ is selected from the group consisting of aryl, substituted aryl, heteroaryl, substituted heteroaryl, primary and secondary alkyl groups, and —PY₂ where Y is selected from the group consisting of aryl, substituted aryl, heteroaryl, and substituted heteroaryl.

Optionally within above formulas (6) and (7), R⁶ and R¹⁰ may be joined to form a ring system having from 5-50 non-hydrogen atoms. For example, if R⁶ and R¹⁰ together form a methylene, the ring will have 5 atoms in the backbone of the ring, which may or may not be substituted with other atoms. Also for example, if R⁶ and R¹⁰ together form an ethylene, the ring will have 6 atoms in the backbone of the ring, which may or may not be substituted with other atoms. Substituents from the ring can be selected from the group consisting of halo, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxy, aryloxy, silyl, boryl, phosphino, amino, thio, seleno, nitro, and combinations thereof.

In certain embodiments, the ligands are novel compounds and those of ordinary skill in the art will be able to identify such compounds from the above. One example of the novel ligand compounds, includes those compounds generally characterized by formula (5), above where R² is selected from the group consisting of hydrogen, alkyl, substituted alkyl, cycloalkyl, substituted cycloalkyl, aryl, and substituted aryl; and R³is a phosphino characterized by the formula —PZ¹Z², where each of Z¹ and Z² is independently selected from the group consisting of hydrogen, substituted or unsubstituted alkyl, cycloalkyl, heterocycloalkyl, heterocyclic, aryl, substituted aryl, heteroaryl, silyl, alkoxy, aryloxy, amino and combinations thereof. Particularly preferred embodiments of these compounds include those where Z¹ and Z² are each independently selected from the group consisting of alkyl, substituted alkyl, cycloalkyl, heterocycloalkyl, aryl, and substituted aryl; and more specifically phenyl; where Q¹, Q³, and Q⁵ are each selected from the group consisting of alkyl and substituted alkyl and each of Q² and Q⁴ is hydrogen; and where R⁴, R⁵, R⁶ and R⁷ are each hydrogen. For more information on useful ligands please see WO 2006/38628.

The ligands of the catalysts of this invention may be prepared using known procedures. See, for example, Advanced Organic Chemistry, March, Wiley, N.Y. 1992 (4.sup.th, Ed.). Specifically, the ligands of the invention may be prepared using the two step procedure outlined in Schemes 1 and as disclosed at pages 42 to 44 of WO 03/040201.

### Compositions

Once the desired ligand is formed, it may be combined with a metal atom, ion, compound or other metal catalyst compound. In some applications, the ligands of this invention will be combined with a metal compound or catalyst and the product of such combination is not determined, if a product forms. For example, the ligand may be added to a reaction vessel at the same time as the metal or metal catalyst compound along with the reactants, activators, scavengers, etc. Additionally, the ligand can be modified prior to addition to or after the addition of the metal catalyst, e.g. through a deprotonation reaction or some other modification.

For the above formulae, the metal catalyst compounds may be characterized by the general formula Hf(L)ₙ where L is independently selected from the group consisting of halide (F, Cl, Br, I), alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations thereof. n is 1, 2, 3, 4, 5, or 6. The hafnium catalysts may be monomeric, dimeric or higher orders thereof. It is well known that hafnium metal typically contains some amount of impurity of zirconium. Thus, this invention uses as pure hafnium as is commercially reasonable. Specific examples of suitable hafnium catalysts include, but are not limited to HfCl₄, Hf(CH₂Ph)₄, Hf(CH₂CMe₃)₄, Hf(CH₂SiMe₃)₄, Hf(CH₂Ph)₃Cl, Hf(CH₂CMe₃)₃Cl, Hf(CH₂SiMe₃)₃Cl, Hf(CH₂Ph)₂Cl₂, Hf(CH₂CMe₃)₂Cl₂, Hf(CH₂SiMe₃)₂Cl₂, Hf(NMe₂)₂, Hf(NEt₂)₄, and Hf(N(SiMe₃)₂)₂Cl₂. Lewis base adducts of these examples are also suitable as hafnium catalysts, for example, ethers, amines, thioethers, phosphines and the like are suitable as Lewis bases.

For formulae 5 and 6, the metal catalyst compounds may be characterized by the general formula M(L)ₙ where M is hafnium or zirconium and each L is independently selected from the group consisting of halide (F, Cl, Br, I), alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations thereof. n is 4, typically. It is well known that hafnium metal typically contains some amount of impurity of zirconium. Thus, this invention uses as pure hafnium or zirconium as is commercially reasonable. Specific examples of suitable hafnium and zirconium catalysts include, but are not limited to HfCl₄, Hf(CH₂Ph)₄, Hf(CH₂CMe₃)₄, Hf(CH₂SiMe₃)₄, Hf(CH₂Ph)₃Cl, Hf(CH₂CMe₃)₃Cl, Hf(CH₂SiMe₃)₃Cl, Hf(CH₂Ph)₂Cl₂, Hf(CH₂CMe₃)₂Cl₂, Hf(CH₂SiMe₃)₂Cl₂, Hf(NMe₂)₄, Hf(NEt₂)₄, and Hf(N(SiMe₃)₂)₂Cl₂, ZrCl₄, Zr(CH₂Ph)₄, Zr(CH₂CMe₃)₄, Zr(CH₂SiMe₃)₄, Zr(CH₂Ph)₃Cl, Zr(CH₂CMe₃)₃Cl, Zr(CH₂SiMe₃)₃Cl, Zr(CH₂Ph)₂Cl₂, Zr(CH₂CMe₃)₂Cl₂, Zr(CH₂SiMe₃)₂Cl₂, Zr(NMe₂)₄, Zr(NEt₂)₄, and Zr(N(SiMe₃)₂)₂Cl₂.

Lewis base adducts of these examples are also suitable as hafnium catalysts, for example, ethers, amines, thioethers, phosphines and the like are suitable as Lewis bases.

The ligand to metal catalyst compound molar ratio is typically in the range of about 0.01:1 to about 100:1, more preferably in the range of about 0.1:1 to about 10:1.

### Metal-Ligand Complexes

This invention, in part, relates to the use of nonmetallocene metal-ligand complexes. Generally, the ligand is mixed with a suitable metal catalyst compound prior to or simultaneously with allowing the mixture to be contacted with the reactants (e.g., monomers). When the ligand is mixed with the metal catalyst compound, a metal-ligand complex may be formed, which may be a catalyst or may need to be activated to be a catalyst. The metal-ligand complexes discussed herein are referred to as 2,1 complexes or 3,2 complexes, with the first number representing the number of coordinating atoms and second number representing the charge occupied on the metal. The 2,1-complexes therefore have two coordinating atoms and a single anionic charge. Other embodiments of this invention are those complexes that have a general 3,2 coordination scheme to a metal center, with 3,2 referring to a ligand that occupies three coordination sites on the metal and two of those sites being anionic and the remaining site being a neutral Lewis base type coordination.

Looking first at the 2,1-nonmetallocene metal-ligand complexes, the metal-ligand complexes may be characterized by the following general formula (8):

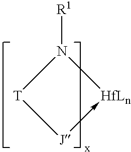

wherein T, J″, R¹, L and n are as defined previously; and x is 1 or 2. The J″ heteroaryl may or may not datively bond, but is drawn as bonding. More specifically, the nonmetallocene-ligand complexes may be characterized by the formula (9):

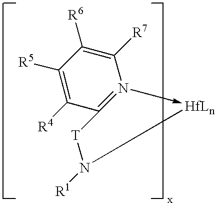

wherein R¹, T, R⁴, R⁵, R⁶, R⁷, L and n are as defined previously; and x is 1 or 2. In one preferred embodiment x=1 and n=3. Additionally, Lewis base adducts of these metal-ligand complexes are also within the scope of the invention, for example, ethers, amines, thioethers, phosphines and the like are suitable as Lewis bases.

More specifically, the nonmetallocene metal-ligand complexes of this invention may be characterized by the general formula (10):

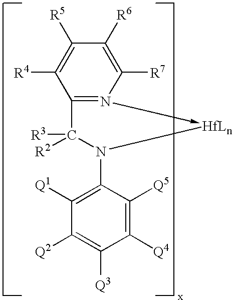

wherein the variables are generally defined above. Thus, e.g., Q², Q³, Q⁴, R², R³, R⁴, R⁵, R⁶ and R⁷ are independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, nitro, and combinations thereof, optionally, two or more R⁴, R⁵, R⁶ and R⁷ groups may be joined to form a fused ring system having from 3-50 non-hydrogen atoms in addition to the pyridine ring, e.g. generating a quinoline group; also, optionally, any combination of R², R³, and R⁴, may be joined together in a ring structure; Q¹ and Q⁵ are selected from the group consisting of alkyl, substituted alkyl, cycloalkyl, substituted cycloalkyl, aryl, substituted aryl, provided that Q¹ and Q⁵ are not both methyl; and each L is independently selected from the group consisting of halide, alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates and combinations thereof; n is 1,2,3,4,5, or 6; and x=1 or 2.

In other embodiments, the 2,1 metal-ligand complexes can be characterized by the general formula (11):

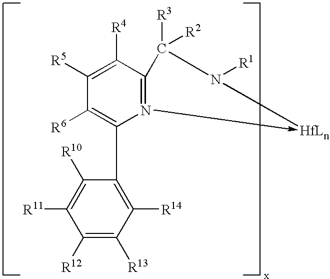

wherein the variables are generally defined above.

In still other embodiments, the 2,1 metal-ligand complexes of this invention can be characterized by the general formula (12):

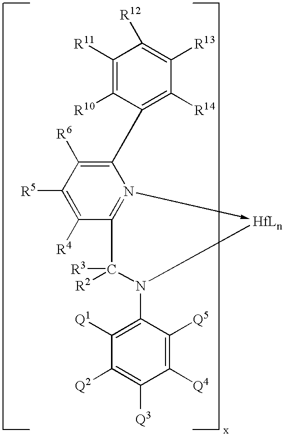

wherein the variables are generally defined above.

In a particularly preferred embodiment the nonmetallocene metal-ligand complexes are represented by the formulae at page 50-51 of WO 03/ 040201.

Turning to the 3,2 metal-ligand nonmetallocene complexes used in the practice of this invention, the metal-ligand complexes may be characterized by the general formula (13):

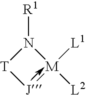

where M is zirconium or hafnium; R¹ and T are defined above; J′″ being selected from the group of substituted heteroaryls with 2 atoms bonded to the metal M, at least one of those 2 atoms being a heteroatom, and with one atom of J′″ is bonded to M via a dative bond, the other through a covalent bond; and L¹ and L² are independently selected from the group consisting of halide, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations thereof.

More specifically, the 3,2 metal-ligand nonmetallocene complexes of this invention may be characterized by the general formula (14):

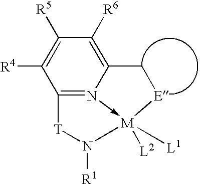

where M is zirconium or hafnium; T, R¹, R⁴, R⁵, R⁶, L¹ and L² are defined above; and E″ is either carbon or nitrogen and is part of an cyclic aryl, substituted aryl, heteroaryl, or substituted heteroaryl group.

Even more specifically, the 3,2 metal-ligand nonmetallocene complexes used in the practice of this invention may be characterized by the general formula (15):

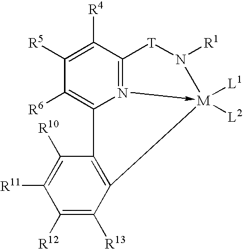

where M is zirconium or hafnium; and T, R¹, R⁴, R⁵, R⁶, R¹⁰, R¹¹, R¹², R¹³, L¹ and L² are defined above.

Still even more specifically, the 3,2 metal-ligand nonmetallocene complexes of this invention may be characterized by the general formula (16):

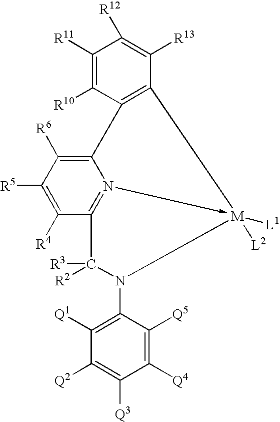

where M is zirconium or hafnium; and R², R³, R⁴, R⁵, R⁶, R¹⁰, R¹¹, R¹², R¹³, Q¹, Q², Q³, Q⁴, Q⁵, L¹ and L² are defined above.

In the above formulas, R¹⁰, R¹¹, R¹², and R¹³ are independently selected from the group consisting of hydrogen, halo, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxy, aryloxy, silyl, boryl, phosphino, amino, thio, seleno, nitro, and combinations thereof; optionally, two or more R¹⁰, R¹¹, R¹², and R¹³ groups may be joined to form a fused ring system having from 3-50 non-hydrogen atoms.

In addition, Lewis base adducts of the metal-ligand complexes in the above formulas are also suitable, for example, ethers, amines, thioethers, phosphines and the like are suitable as Lewis bases.

The metal-ligand complexes can be formed by techniques known to those of skill in the art. In some embodiments, R¹⁴ is hydrogen and the metal-ligand complexes are formed by a metallation reaction (in situ or not) as shown in the reaction scheme on page 54-55 of WO 03/040201.

Specific examples of 3,2 complexes of this invention include all those listed in WO 03/040201.

The ligands, complexes or catalysts may be supported on an organic or inorganic support. Suitable supports include silicas, aluminas, clays, zeolites, magnesium chloride, polyethyleneglycols, polystyrenes, polyesters, polyamides, peptides and the like. Polymeric supports may be cross-linked or not. Similarly, the ligands, complexes or catalysts may be supported on similar supports known to those of skill in the art. In addition, the catalysts of this invention may be combined with other catalysts in a single reactor and/or employed in a series of reactors (parallel or serial) in order to form blends of polymer products.

The metal complexes used in this invention are rendered catalytically active by combination with an activating cocatalyst or by use of an activating technique. Suitable activating cocatalysts for use herein include neutral Lewis acids such as alumoxane (modified and unmodified), C1-C30 hydrocarbyl substituted Group 13 compounds, especially tri(hydrocarbyl)aluminum- or tri(hydrocarbyl)boron compounds and halogenated (including perhalogenated) derivatives thereof, having from 1 to 10 carbons in each hydrocarbyl or halogenated hydrocarbyl group, more especially perfluorinated tri(aryl)boron compounds, and most especially tris(pentafluorophenyl)borane; nonpolymeric, compatible, noncoordinating, ion forming compounds (including the use of such compounds under oxidizing conditions), especially the use of ammonium-, phosphonium-, oxonium-, carbonium-, silylium- or sulfonium-salts of compatible, noncoordinating anions, or ferrocenium salts of compatible, noncoordinating anions; bulk electrolysis (explained in more detail hereinafter); and combinations of the foregoing activating cocatalysts and techniques. The foregoing activating cocatalysts and activating techniques have been previously taught with respect to different metal complexes in the following references: U.S. Pat. No. 5,153,157 and U.S. Pat. No. 5,064,802, EP-A-277,003, EP-A-468,651 (equivalent to U.S. Ser. No. 07/547,718), U.S. Pat. No. 5,721,185 and U.S. Pat. No. 5,350,723.

The alumoxane used as an activating cocatalyst in this invention is of the formula (R⁴ₓ(CH₃)_{y}AlOₙ, in which R⁴ is a linear, branched or cyclic C1 to C6 hydrocarbyl, x is from 0 to about 1, y is from about 1 to 0, and n is an integer from about 3 to about 25, inclusive. The preferred alumoxane components, referred to as modified methylalumoxanes, are those wherein R⁴ is a linear, branched or cyclic C3 to C9 hydrocarbyl, x is from about 0.15 to about 0.50, y is from about 0.85 to about 0.5 and n is an integer between 4 and 20, inclusive; still more preferably, R⁴ is isobutyl, tertiary butyl or n-octyl, x is from about 0.2 to about 0.4, y is from about 0.8 to about 0.6 and n is an integer between 4 and 15, inclusive. Mixtures of the above alumoxanes may also be employed in the practice of the invention.

Most preferably, the alumoxane is of the formula (R⁴ₓ(CH₃)_{.y}AlO)ₙ, wherein R⁴ is isobutyl or tertiary butyl, x is about 0.25, y is about 0.75 and n is from about 6 to about 8.

Particularly useful alumoxanes are so-called modified alumoxanes, preferably modified methylalumoxanes (MMAO), that are completely soluble in alkane solvents, for example heptane, and may include very little, if any, trialkylaluminum. A technique for preparing such modified alumoxanes is disclosed in U.S. Pat. No. 5,041,584 (which is incorporated by reference). Alumoxanes useful as an activating cocatalyst in this invention may also be made as disclosed in U.S. Pat. Nos. 4,542,199; 4,544,762; 4,960,878; 5,015,749; 5,041,583 and 5,041,585. Various alumoxanes can be obtained from commercial sources, for example, Akzo-Nobel Corporation, and include MMAO-3A, MMAO-12, and PMAO-IP.

Combinations of neutral Lewis acids, especially the combination of a trialkyl aluminum compound having from 1 to 4 carbons in each alkyl group and a halogenated tri(hydrocarbyl)boron compound having from 1 to 10 carbons in each hydrocarbyl group, especially tris(pentafluorophenyl)borane, and combinations of neutral Lewis acids, especially tris(pentafluorophenyl)borane, with nonpolymeric, compatible noncoordinating ion-forming compounds are also useful activating cocatalysts.

Suitable ion forming compounds useful as cocatalysts in one embodiment of the present invention comprise a cation which is a Bronsted acid capable of donating a proton, and a compatible, noncoordinating anion, A⁻. As used herein, the term “noncoordinating” means an anion or substance which either does not coordinate to the Group 4 metal containing catalyst complex and the catalytic derivative derived therefrom, or which is only weakly coordinated to such complexes thereby remaining sufficiently labile to be displaced by a neutral Lewis base. A noncoordinating anion specifically refers to an anion which when functioning as a charge balancing anion in a cationic metal complex does not transfer an anionic substituent or fragment thereof to said cation thereby forming neutral complexes. “Compatible anions” are anions which are not degraded to neutrality when the initially formed complex decomposes and are noninterfering with desired subsequent polymerization or other uses of the complex.

Preferred anions are those containing a single coordination complex comprising a charge-bearing metal or metalloid core which anion is capable of balancing the charge of the active catalyst species (the metal cation) which may be formed when the two components are combined. Also, said anion should be sufficiently labile to be displaced by olefinic, diolefinic and acetylenically unsaturated compounds or other neutral Lewis bases such as ethers or nitrites. Suitable metals include, but are not limited to, aluminum, gold and platinum. Suitable metalloids include, but are not limited to, boron, phosphorus, and silicon. Compounds containing anions which comprise coordination complexes containing a single metal or metalloid atom are, of course, well known and many, particularly such compounds containing a single boron atom in the anion portion, are available commercially.

In one embodiment of this invention, the activating cocatalysts may be represented by the following general formula: [L*−H]⁺_{d}[A^{d-}] wherein: L* is a neutral Lewis base; [L*−H]⁺ is a Bronsted acid; A^{d-} is a noncoordinating, compatible anion having a charge of d⁻; and d is an integer from 1 to 3. More preferably A^{d-} corresponds to the formula: [M′^{k+}Qₙ′]^{d-} wherein: k is an integer from 1 to 3; n′ is an integer from 2 to 6; n′−k=d; M′ is an element selected from Group 13 of the Periodic Table of the Elements; and each Q is independently selected from hydride, dialkylamido, halide, hydrocarbyl, hydrocarbyloxy, halosubstituted-hydrocarbyl, halosubstituted hydrocarbyloxy, and halo substituted silylhydrocarbyl radicals (including perhalogenated hydrocarbyl-perhalogenated hydrocarbyloxy- and perhalogenated silylhydrocarbyl radicals), said Q having up to 20 carbons with the proviso that in not more than one occurrence is Q halide. Examples of suitable hydrocarbyloxide Q groups are disclosed in U.S. Pat. No. 5,296,433.

In a more preferred embodiment, d is one, i.e., the counter ion has a single negative charge and is A⁻. Activating cocatalysts comprising boron which are particularly useful in the preparation of catalysts of this invention may be represented by the following general formula: [L*−H]⁺[BQ₄]⁻ wherein: [L*−H]⁺ is as previously defined; B is boron in an oxidation state of 3; and Q is a hydrocarbyl-, hydrocarbyloxy-, fluorinated hydrocarbyl-, fluorinated hydrocarbyloxy- or fluorinated silylhydrocarbyl-group of up to 20 nonhydrogen atoms, with the proviso that in not more than one occasion is Q hydrocarbyl. Most preferably, Q is each occurrence a fluorinated aryl group, especially, a pentafluorophenyl group.

Illustrative, but not limiting, examples of boron compounds which may be used as an activating cocatalyst in the preparation of the catalysts of this invention are tri-substituted ammonium salts such as:
triethylammonium tetraphenylborate,
N,N-dimethylanilinium tetraphenylborate,
tripropylammonium tetrakis(pentafluorophenyl)borate,
N,N-dimethylanilinium n-butyltris(pentafluorophenyl)borate,
triethylammonium tetrakis(2,3,4,6-tetrafluorophenyl)borate,
N,N-diethylanilinium tetrakis(2,3,4,6-tetrafluorophenyl)borate, and
N,N-dimethyl-2,4,6-trimethylanilinium tetrakis(2,3,4,6-tetrafluorophenyl)borate;
dialkyl ammonium salts such as:
di-(i-propyl)ammonium tetrakis(pentafluorophenyl)borate, and
dicyclohexylammonium tetrakis(pentafluorophenyl)borate;
tri-substituted phosphonium salts such as:
triphenylphosphonium tetrakis(pentafluorophenyl)borate,
tri(o-tolyl)phosphonium tetrakis(pentafluorophenyl)borate, and
tri(2,6-dimethylphenyl)phosphonium tetrakis(pentafluorophenyl)borate;
di-substituted oxonium salts such as:
diphenyloxonium tetrakis(pentafluorophenyl)borate,
di(o-tolyl)oxonium tetrakis(pentafluorophenyl)borate, and
di(2,6-dimethylphenyl)oxonium tetrakis(pentafluorophenyl)borate;
di-substituted sulfonium salts such as:
diphenylsulfonium tetrakis(pentafluorophenyl)borate,
di(o-tolyl)sulfonium tetrakis(pentafluorophenyl)borate, and
di(2,6-dimethylphenyl)sulfonium tetrakis(pentafluorophenyl)borate.

Preferred [L*−H]⁺ cations include N,N-dimethylanilinium and tributylammonium.

Another suitable ion forming, activating cocatalyst comprises a salt of a cationic oxidizing agent and a noncoordinating, compatible anion represented by the formula: (Ox.^{e+})_{d}(A^{d-})ₑ wherein: Ox.^{e+} is a cationic oxidizing agent having a charge of e⁺; e is an integer from 1 to 3; and A^{d-} and d are as previously defined. Examples of cationic oxidizing agents include: ferrocenium, hydrocarbyl-substituted ferrocenium, Ag⁺, or Pb⁺². Preferred embodiments of A^{d-} are those anions previously defined with respect to the Bronsted acid containing activating cocatalysts, especially tetrakis(pentafluorophenyl)borate.

Another suitable ion forming, activating cocatalyst comprises a compound which is a salt of a carbenium ion and a noncoordinating, compatible anion represented by the formula: [C]⁺A⁻wherein: [C]⁺ is a C1-C20 carbenium ion; and A⁻ is as previously defined.

A preferred carbenium ion is the trityl cation, i.e., triphenylmethylium.

A further suitable ion forming, activating cocatalyst comprises a compound which is a salt of a silylium ion and a noncoordinating, compatible anion represented by the formula: R₃Si(X′)_{q}⁺A⁻ wherein: R is C1-C10 hydrocarbyl, and X′, q and A⁻ are as previously defined.

Preferred silylium salt activating cocatalysts are trimethylsilylium tetrakis(pentafluorophenyl)borate, triethylsilylium(tetrakispentafluoro)phenylborate and ether substituted adducts thereof. Silylium salts have been previously generically disclosed in J. Chem Soc. Chem. Comm., 1993, 383-384, as well as Lambert, J. B., et al., Organometallics, 1994, 13, 2430-2443.

Certain complexes of alcohols, mercaptans, silanols, and oximes with tris(pentafluorophenyl)borane are also effective catalyst activators and may be used according to the present invention. Such cocatalysts are disclosed in U.S. Pat. No. 5,296,433.

The technique of bulk electrolysis involves the electrochemical oxidation of the metal complex under electrolysis conditions in the presence of a supporting electrolyte comprising a noncoordinating, inert anion. In the technique, solvents, supporting electrolytes and electrolytic potentials for the electrolysis are used such that electrolysis byproducts that would render the metal complex catalytically inactive are not substantially formed during the reaction. More particularly, suitable solvents are materials that are: liquids under the conditions of the electrolysis (generally temperatures from 0 to 100° C.), capable of dissolving the supporting electrolyte, and inert. “Inert solvents” are those that are not reduced or oxidized under the reaction conditions employed for the electrolysis. It is generally possible in view of the desired electrolysis reaction to choose a solvent and a supporting electrolyte that are unaffected by the electrical potential used for the desired electrolysis. Preferred solvents include difluorobenzene (all isomers), dimethoxyethane (DME), and mixtures thereof.

The electrolysis may be conducted in a standard electrolytic cell containing an anode and cathode (also referred to as the working electrode and counter electrode respectively). Suitable materials of construction for the cell are glass, plastic, ceramic and glass coated metal. The electrodes are prepared from inert conductive materials, by which are meant conductive materials that are unaffected by the reaction mixture or reaction conditions. Platinum or palladium are preferred inert conductive materials. Normally an ion permeable membrane such as a fine glass frit separates the cell into separate compartments, the working electrode compartment and counter electrode compartment. The working electrode is immersed in a reaction medium comprising the metal complex to be activated, solvent, supporting electrolyte, and any other materials desired for moderating the electrolysis or stabilizing the resulting complex. The counter electrode is immersed in a mixture of the solvent and supporting electrolyte. The desired voltage may be determined by theoretical calculations or experimentally by sweeping the cell using a reference electrode such as a silver electrode immersed in the cell electrolyte. The background cell current, the current draw in the absence of the desired electrolysis, is also determined. The electrolysis is completed when the current drops from the desired level to the background level. In this manner, complete conversion of the initial metal complex can be easily detected.

Suitable supporting electrolytes are salts comprising a cation and a compatible, noncoordinating anion, A⁻. Preferred supporting electrolytes are salts corresponding to the formula: G⁺A⁻ wherein: G⁺ is a cation which is nonreactive towards the starting and resulting complex, and A- is as previously defined.

Examples of cations, G⁺, include tetrahydrocarbyl substituted ammonium or phosphonium cations having up to 40 nonhydrogen atoms. Preferred cations are the tetra-n-butylammonium- and tetraethylammonium-cations.

During activation of the complexes of the present invention by bulk electrolysis the cation of the supporting electrolyte passes to the counter electrode and A⁻ migrates to the working electrode to become the anion of the resulting oxidized product. Either the solvent or the cation of the supporting electrolyte is reduced at the counter electrode in equal molar quantity with the amount of oxidized metal complex formed at the working electrode. Preferred supporting electrolytes are tetrahydrocarbylammonium salts of tetrakis(perfluoroaryl) borates having from 1 to 10 carbons in each hydrocarbyl or perfluoroaryl group, especially tetra-n-butylammonium tetrakis(pentafluorophenyl) borate.

A further electrochemical technique for generation of activating cocatalysts is the electrolysis of a disilane compound in the presence of a source of a noncoordinating compatible anion. This technique is more fully disclosed and claimed in U.S. Pat. No. 5,625,087.

The foregoing activating techniques and ion forming cocatalysts are also preferably used in combination with a tri(hydrocarbyl)aluminum or tri(hydrocarbyl)borane compound having from 1 to 4 carbons in each hydrocarbyl group.

In a preferred embodiment, the activator is selected from the group consisting of:
trimethylammonium tetraphenylborate, triethylammonium tetraphenylborate,
tripropylammonium tetraphenylborate, tri(n-butyl)ammonium tetraphenylborate,
tri(tert-butyl)ammonium tetraphenylborate, N,N-dimethylanilinium tetraphenylborate, N,N-diethylanilinium tetraphenylborate, N,N-dimethyl-(2,4,6-trimethylanilinium)tetraphenylborate, trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-diethylanilinium tetrakis(pentafluorophenyl)borate, N,N-dimethyl-(2,4,6-trimethylanilinium)tetrakis(pentafluorophenyl)borate, trimethylammonium tetrakis-(2,3,4,6-tetrafluorophenyl)borate, triethylammonium tetrakis-(2,3,4,6-tetrafluorophenyl)borate, tripropylammonium tetrakis-(2,3,4,6-tetrafluorophenyl)borate, tri(n-butyl)ammonium tetrakis-(2,3,4,6-tetrafluorophenyl)borate, dimethyl(tert-butyl)ammonium tetrakis-(2,3,4,6-tetrafluorophenyl)borate, N,N-dimethylanilinium tetrakis-(2,3,4,6-tetrafluorophenyl)borate, N,N-diethylanilinium tetrakis-(2,3,4,6-tetrafluorophenyl)borate, N,N-dimethyl-(2,4,6-trimethylanilinium) tetrakis-(2,3,4,6-tetrafluorophenyl)borate, trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(tert-butyl)ammonium tetrakis(perfluoronaphthyl)borate, N,N-dimethylanilinium tetrakis(perfluoronaphthyl)borate, N,N-diethylanilinium tetrakis(perfluoronaphthyl)borate, N,N-dimethyl-(2,4,6-trimethylanilinium)tetrakis(perfluoronaphthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(tert-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium)tetrakis(perfluorobiphenyl)borate, trimethylammonium tetrakis(3,5-bis(trifluoromethyl)phenyl)borate, triethylammonium tetrakis(3,5-bis(trifluoromethyl)phenyl)borate, tripropylammonium tetrakis(3,5-bis(trifluoromethyl)phenyl)borate, tri(n-butyl)ammonium tetrakis(3,5-bis(trifluoromethyl)phenyl)borate, tri(tert-butyl)ammonium tetrakis(3,5-bis(trifluoromethyl)phenyl)borate, N,N-dimethylanilinium tetrakis(3,5-bis(trifluoromethyl)phenyl)borate, N,N-diethylanilinium tetrakis(3,5-bis(trifluoromethyl)phenyl)borate, N,N-dimethyl-(2,4,6-trimethylanilinium)tetrakis(3,5-bis(trifluoromethyl)phenyl)borate, di-(iso-propyl)ammonium tetrakis(pentafluorophenyl)borate, dicyclohexylammonium tetrakis(pentafluorophenyl)borate; tri(o-tolyl)phosphonium tetrakis(pentafluorophenyl)borate, tri(2,6-dimethylphenyl)phosphonium tetrakis(pentafluorophenyl)borate, tropillium tetraphenylborate, triphenylcarbenium tetraphenylborate, triphenylphosphonium tetraphenylborate, triethylsilylium tetraphenylborate, benzene(diazonium)tetraphenylborate, tropillium tetrakis(pentafluorophenyl)borate, triphenylcarbenium tetrakis(pentafluorophenyl)borate, triphenylphosphonium tetrakis(pentafluorophenyl)borate, triethylsilylium tetrakis(pentafluorophenyl)borate, benzene(diazonium)tetrakis(pentafluorophenyl)borate, tropillium tetrakis-(2,3,4,6-tetrafluorophenyl)borate, triphenylcarbenium tetrakis-(2,3,4,6-tetrafluorophenyl)borate, triphenylphosphonium tetrakis-(2,3,4,6-tetrafluorophenyl)borate, triethylsilylium tetrakis-(2,3,4,6-tetrafluorophenyl)borate, benzene(diazonium) tetrakis-(2,3,4,6-tetrafluorophenyl)borate, tropillium tetrakis(perfluoronaphthyl)borate, triphenylcarbenium tetrakis(perfluoronaphthyl)borate, triphenylphosphonium tetrakis(perfluoronaphthyl)borate, triethylsilylium tetrakis(perfluoronaphthyl)borate, benzene(diazonium)tetrakis(perfluoronaphthyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium) tetrakis(perfluorobiphenyl)borate, tropillium tetrakis(3,5-bis(trifluoromethyl)phenyl)borate, triphenylcarbenium tetrakis(3,5-bis(trifluoromethyl)phenyl)borate, triphenylphosphonium tetrakis(3,5-bis(trifluoromethyl)phenyl)borate, triethylsilylium tetrakis(3,5-bis(trifluoromethyl)phenyl)borate, and benzene(diazonium) tetrakis(3,5-bis(trifluoromethyl)phenyl)borate.

The molar ratio of catalyst/cocatalyst employed preferably ranges from 1:10,000 to 100:1, more preferably from 1:5000 to 10:1, most preferably from 1:100 to 1:1. In one embodiment of the invention the cocatalyst can be used in combination with a tri(hydrocarbyl)aluminum compound having from 1 to 10 carbons in each hydrocarbyl group. Mixtures of activating cocatalysts may also be employed. It is possible to employ these aluminum compounds for their beneficial ability to scavenge impurities such as oxygen, water, and aldehydes from the polymerization mixture. Preferred aluminum compounds include trialkyl aluminum compounds having from 1 to 6 carbons in each alkyl group, especially those wherein the alkyl groups are methyl, ethyl, propyl, isopropyl, n-butyl, isobutyl, pentyl, neopentyl or isopentyl. The molar ratio of metal complex to aluminum compound is preferably from 1:10,000 to 100:1, more preferably from 1:1000 to 10:1, most preferably from 1:500 to 1:1. A most preferred borane activating cocatalyst comprises a strong Lewis acid, especially tris(pentafluorophenyl)borane.

In some embodiments disclosed herein, two or more different catalysts, including the use of mixed catalysts can be employed. In addition to a nonmetallocene, metal-centered, heteroaryl ligand catalyst, when a plurality of catalysts are used, any catalyst which is capable of copolymerizing one or more olefin monomers to make an interpolymer or homopolymer may be used in embodiments of the invention in conjunction with a nonmetallocene, metal-centered, heteroaryl ligand catalyst. For certain embodiments, additional selection criteria, such as molecular weight capability and/or comonomer incorporation capability, preferably should be satisfied. Two or more nonmetallocene, metal-centered, heteroaryl ligand catalysts having different substituents can be used in the practice of certain of the embodiments disclosed herein. Suitable catalysts which may be used in conjunction with the nonmetallocene, metal-centered, heteroaryl ligand catalysts disclosed herein include, but are not limited to, metallocene catalysts and constrained geometry catalysts, multi-site catalysts (Ziegler-Natta catalysts), and variations therefrom.

One suitable class of catalysts is the catalysts disclosed in U.S. Pat. No. 5,064,802, U.S. Pat. No. 5,132,380, U.S. Pat. No. 5,703,187, U.S. Pat. No. 6,034,021, EP 0 468 651, EP 0 514 828, WO 93/19104, and WO 95/00526. Another suitable class of catalysts is the metallocene catalysts disclosed in U.S. Pat. No. 5,044,438; U.S. Pat. No. 5,057,475; U.S. Pat. No. 5,096,867; and U.S. Pat. No. 5,324,800. It is noted that these catalysts may be considered as metallocene catalysts, and both are sometimes referred to in the art as single-site catalysts.

Another suitable class of catalysts is substituted indenyl containing metal complexes as disclosed in U.S. Pat. No. 5,965,756 and U.S. Pat. No. 6,015,868. Other catalysts are disclosed in copending applications: U.S. application Ser. No. 09/230,185; and Ser. No. 09/715,380, and U.S. Provisional Application Ser. No. 60/215,456; No. 60/170,175, and No. 60/393,862. The disclosures of all of the preceding patent applications are incorporated by reference herein in their entirety. These catalysts tend to have a higher molecular weight capability.

Other catalysts, cocatalysts, catalyst systems, and activating techniques which may be used in the practice of the invention disclosed herein may include WO 96/23010, published on Aug. 1, 1996; WO 99/14250, published Mar. 25, 1999; WO 98/41529, published Sep. 24, 1998; WO 97/42241, published Nov. 13, 1997; Scollard, et al., in J. Am. Chem. Soc 1996, 118, 10008-10009; EP 0 468 537 B1, published Nov. 13, 1996; WO 97/22635, published Jun. 26, 1997; EP 0 949 278 A2, published Oct. 13, 1999; EP 0 949 279 A2, published Oct. 13, 1999; EP 1 063 244 A2, published Dec. 27, 2000; U.S. Pat. No. 5,408,017; U.S. Pat. No. 5,767,208; U.S. Pat. No. 5,907,021; WO 88/05792, published Aug. 11, 1988; W088/05793, published Aug. 11, 1988; WO 93/25590, published Dec. 23, 1993; U.S. Pat. No. 5,599,761; U.S. Pat. No. 5,218,071; WO 90/07526, published Jul. 12, 1990; U.S. Pat. No. 5,972,822; U.S. Pat. No. 6,074,977; U.S. Pat. No. 6,013,819; U.S. Pat. No. 5,296,433; U.S. Pat. No. 4,874,880; U.S. Pat. No. 5,198,401; U.S. Pat. No. 5,621,127; U.S. Pat. No. 5,703,257; U.S. Pat. No. 5,728,855; U.S. Pat. No. 5,731,253; U.S. Pat. No. 5,710,224; U.S. Pat. No. 5,883,204; U.S. Pat. No. 5,504,049; U.S. Pat. No. 5,962,714; U.S. Pat. No. 5,965,677; U.S. Pat. No. 5,427,991; WO 93/21238, published Oct. 28, 1993; WO 94/03506, published Feb. 17, 1994; WO 93/21242, published Oct. 28, 1993; WO 94/00500, published Jan. 6, 1994; WO 96/00244, published Jan. 4, 1996; WO 98/50392, published Nov. 12, 1998; WO 02/38628, published May 16, 2002; Wang, et al., Organometallics 1998, 17, 3149-3151; Younkin, et al., Science 2000, 287, 460-462; those disclosed by Chen and Marks, Chem. Rev. 2000, 100, 1391-1434; those disclosed by Alt and Koppl, Chem. Rev. 2000, 100, 1205-1221; those disclosed by Resconi, et al., Chem. Rev. 2000, 100, 1253-1345; those disclosed by Ittel, et al., Chem Rev. 2000, 100, 1169-1203; those disclosed by Coates, Chem. Rev., 2000, 100, 1223-1251; those disclosed by Brady, III, et al., U.S. Pat. No. 5,093,415, those disclosed by Murray, et al., U.S. Pat. No. 6,303,719, those disclosed by Saito, et al., U.S. Pat. No. 5,874,505; and WO 96/13530, published May 9, 1996. Also useful are those catalysts, cocatalysts, and catalyst systems disclosed in U.S. Ser. No. 09/230,185, filed Jan. 15, 1999; U.S. Pat. No. 5,965,756; U.S. Pat. No. 6,150,297; U.S. Ser. No. 09/715,380, filed Nov. 17, 2000. The disclosures of all of the preceding patents and or patent applications are incorporated by reference herein in their entirety to the extent they are not inconsistent with this specification.

In a preferred embodiment the polymerization system comprises less than 5 weight % polar species, preferably less than 4 weight %, more preferably less than 3 weight %, more preferably less than 2 weight %, more preferably less than 1 weight %, more preferably less than 1000 ppm, more preferably less than 750 ppm, more preferably less than 500 ppm, more preferably less than 250 ppm, more preferably less than 100 ppm, more preferably less than 50 ppm, more preferably less than 10 ppm. Polar species include oxygen containing compounds (except for alumoxanes) such as alcohols, oxygen, ketones, aldehydes, acids, esters and ethers.

In another embodiment the polymerization system comprises less than 5 weight % trimethylaluminum and/or triethylaluminum, preferably less than 4 weight %, more preferably less than 3 weight %, more preferably less than 2 weight %, more preferably less than 1 weight %, more preferably less than 1000 ppm, more preferably less than 750 ppm, more preferably less than 500 ppm, more preferably less than 250 ppm, more preferably less than 100 ppm, more preferably less than 50 ppm, more preferably less than 10 ppm.

In another preferred embodiment the polymerization system comprises methylalumoxane and less than 5 weight % trimethylaluminum and or triethylaluminum, preferably less than 4 weight %, more preferably less than 3 weight %, more preferably less than 2 weight %, more preferably less than 1 weight %, more preferably less than 1000 ppm, more preferably less than 750 ppm, more preferably less than 500 ppm, more preferably less than 250 ppm, more preferably less than 100 ppm, more preferably less than 50 ppm, more preferably less than 10 ppm.

### Polymerization Process

This invention relates to processes to polymerize olefins comprising contacting one or more olefins having at least three carbon atoms with a catalyst compound and an activator in a catalyst system comprising one or two fluid phases in a reactor. In the preferred embodiment, the fluid reaction medium is in its supercritical state and forms a single fluid phase. One or more reactors in series or in parallel may be used in the present invention. Catalyst compounds and activators may be delivered as a solution or slurry, either separately to the reactor, activated in-line just prior to the reactor, or preactivated and pumped as an activated solution or slurry to the reactor. A preferred operation is two solutions activated in-line. Polymerizations are carried out in either single reactor operation, in which monomer, comonomers, catalyst/activator, scavenger, and optional modifiers are added continuously to a single reactor or in more than one reactors connected in series or in parallel. If the reactors are connected in a series cascade, the catalyst components can be added to the first reactor in the series. The catalyst component may also be added to more than one reactor in a reactor cascade (such as a series reactor cascade), with one component being added to first reaction and other components to other reactors.

A series reactor cascade has two or more reactors connected in series, in which the effluent of an upstream reactor is fed to the next reactor downstream in the reactor cascade. Besides the effluent of the upstream reactor(s), the feed of any reactor can be augmented with any combination of additional monomer, catalyst, scavenger, or solvent fresh or recycled feed streams. In a parallel reactor configuration, the reactor or reactors in series cascade that form a branch of the parallel reactor configuration is referred to as a reactor train.

Invention methods also cover polymerization in high-pressure reactors where, preferably, the reactor is substantially unreactive with the polymerization reaction components and is able to withstand the high pressures and temperatures that occur during the polymerization reaction. Such reactors are known as high-pressure reactors for purposes of this disclosure. Withstanding these high pressures and temperatures will allow the reactor to maintain the fluid reaction medium in its supercritical condition. Suitable reaction vessels include those known in the art to maintain supercritical or other high-pressure polymerization reactions (such as high pressure ethylene polymerization reactions). Suitable reactors are selected from autoclave, loop, pump-around loop, pump-around autoclave, tubular, and autoclave/tubular reactors, among others.

The polymerization processes described herein operate well in tubular reactors and in autoclaves (also called stirred tank reactors). Autoclave reactors can be operated in batch or in continuous mode. To provide better productivity, and thus to lower production cost, continuous operation is preferred in commercial operations. Tubular reactors preferably operate in continuous mode. Typically, autoclave reactors have length-to-diameter ratios of 1:1 to 20:1(preferably 4:1 to 20:1) and are typically fitted with a high-speed (up to 2000 RPM) multiblade stirrer. When the autoclave has a low length-to-diameter ratio (such as less than four) the feed streams are typically injected at only one position along the length of the reactor. Reactors with large diameters may have multiple injection ports at nearly the same position along the length of the reactor but radially distributed to allow for faster intermixing of the feed components with the reactor content. In the case of stirred tank reactors, the separate introduction of the catalyst is possible and often preferred. Such introduction prevents the possible formation of hot spots in the unstirred feed zone between the mixing point and the stirred zone of the reactor. Injections at two or more positions along the length of the reactor is also possible and sometimes preferred. For instance, in reactors where the length-to-diameter ratio is around 4:1 to 20:1, the reactor preferably can contain up to six different injection positions. Additionally, in the larger autoclaves, one or more lateral fixing devices support the high-speed stirrer. These fixing devices can also divide the autoclave into two or more zones. Mixing blades on the stirrer can differ from zone to zone to allow for a different degree of plug flow and back mixing, largely independently, in the separate zones. Two or more autoclaves with one or more zones can connect in series cascade to increase residence time or to tailor polymer structure. As mentioned above, a series reactor cascade typically has two or more reactors connected in series, in which the effluent of at least one upstream reactor is fed to the next reactor downstream in the cascade. Besides the effluent of the upstream reactor(s), the feed of any reactor in the series cascade can be augmented with any combination of additional monomer, catalyst, or solvent fresh or recycled feed streams. Two or more reactors can also be arranged in a parallel configuration. The individual arms of such parallel arrangements are referred to as reactor trains. These reactor trains in turn may themselves comprise one reactor or a reactor series cascade creating a combination of series and parallel reactors.

Tubular reactors may also be used in the process disclosed herein and more particularly tubular reactors capable of operating up to about 350 MPa. Tubular reactors are fitted with external cooling and one or more injection points along the (tubular) reaction zone. As in autoclaves, these injection points serve as entry points for monomers (such as propylene), one or more comonomer, catalyst, or mixtures of these. In tubular reactors, external cooling often allows for increased monomer conversion relative to an autoclave, where the low surface-to-volume ratio hinders any significant heat removal. Tubular reactors have a special outlet valve that can send a pressure shockwave backward along the tube. The shockwave helps dislodge any polymer residue that has formed on reactor walls during operation. Alternately, tubular reactors may be fabricated with smooth, unpolished internal surfaces to address wall deposits. Tubular reactors generally may operate at pressures of up to 360 MPa, may have lengths of 100-2000 meters or 100-4000 meters, and may have internal diameters of less than 12.5 cm (alternately less than 10 cm). Typically, tubular reactors have length-to-diameter ratios of 10:1 to 50,000:1 and may include up to 10 different injection positions along its length.

Reactor trains that pair autoclaves with tubular reactors can also serve in invention processes. In such instances, the autoclave typically precedes the tubular reactor or the two types of reactors form separate trains of a parallel reactor configuration. Such systems may have injection of additional catalyst and/or feed components at several points in the autoclave and more particularly along the tube length.

In both autoclaves and tubular reactors, at injection, feeds are preferably cooled to near ambient temperature or below to provide maximum cooling and thus maximum polymer production within the limits of maximum operating temperature. In autoclave operation, a preheater operates at startup, but not necessarily after the reaction reaches steady state if the first mixing zone has some back-mixing characteristics. In tubular reactors, the first section of double-jacketed tubing is heated rather than cooled and is operated continuously. A useful tubular reactor is characterized by plug flow. By plug flow, is meant a flow pattern with minimal radial flow rate differences. In both multizone autoclaves and tubular reactors, catalyst can be injected not only at the inlet, but also optionally at one or more points along the reactor. The catalyst feeds injected at the inlet and other injection points can be the same or different in terms of content, density, concentration, etc. Choosing different catalyst feeds allows polymer design tailoring. At the reactor outlet valve, the pressure drops to levels below that which critical phase separation occurs. Therefore, a downstream separation vessel may contain a polymer-rich phase and a polymer-lean phase. Typically, conditions in this vessel remain supercritical and temperature remains above the polymer product's crystallization temperature. The autoclave or tubular reactor effluent is depressurized on entering the high pressure separator (HPS).

In any of the multi-reactor systems described herein only one need be operated in the supercritical state or above the solid-fluid phase transition pressure and temperature (preferably above the fluid-fluid phase transition pressure and temperature); however all may be operated in the supercritical state or above the solid-fluid phase transition pressure and temperature(preferably above the fluid-fluid phase transition pressure and temperature). Likewise in any of the multi-reactor systems described herein only one reactor need contain the non-metallocene metal centered, heteroaryl ligand catalyst compound described herein. Any of the other reactors may contain any other polymerization catalyst such as Ziegler-Natta polymerization catalysts, metallocene catalysts, Phillips type catalysts or the like. Useful other catalysts are described at WO 2004/026921 at page 21 paragraph [0081] to page 72, paragraph [00118]. A preferred catalyst for use in any of the reactors is a chiral metallocene catalyst compound used in combination with an activator. In a preferred embodiment both the non-metallocene metal centered, heteroaryl ligand catalyst compound and a chiral metallocene compound are used. In another embodiment the non-metallocene metal centered, heteroaryl ligand catalyst compound and a chiral metallocene compound are used in series reactors or parallel reactors. Particularly useful metallocene compounds include Me₂Si-bis(2-R,4-Phl-indenyl)MX₂, where R is an alkyl group (such as methyl), Phl is phenyl or substituted phenyl, M is Hf, Zr or Ti, and X is a halogen or alkyl group (such as Cl or methyl). Particularly useful metallocene compounds include: 2-dimethylsilyl-bis(2-methyl, 4-phenyl-indenyl)zirconium dimethyl, and 2-dimethylsilyl-bis(2-methyl, 4-phenyl-indenyl)zirconium dichloride.

At the reactor outlet valve, the pressure drops to begin the separation of polymer and unreacted monomer, co-monomers, inerts, like ethane, propane, solvents, like hexanes, toluene, etc. The temperature in this vessel will be maintained above the polymer product's crystallization point but the pressure may be below the critical point. The pressure need only be high enough that the monomer, for example propylene, can be condensed against standard cooling water. The liquid recycle stream can then be recycled to the reactor with a liquid pumping system instead of the hyper-compressors required for polyethylene units. The relatively low pressure in this separator will reduce the monomer concentration in the liquid polymer phase which will result in a much lower polymerization rate. This polymerization rate in some embodiments may be low enough to operate this system without adding a catalyst poison or “killer”. If a catalyst killer is required (e.g., to prevent reactions in the high pressure recycle) then provision must be made to remove any potential catalyst poisons from the recycled propylene rich monomer stream e.g. by the use of fixed bed adsorbents or by scavenging with an aluminum alkyl.

Alternately, the HPS may be operated over the critical pressure of the monomer or monomer blend but within the monomer/polymer two-phase region. This is the economically preferred method if the polymer is to be produced with a revamped high-pressure polyethylene (HPPE) plant. The recycled HPS overhead is cooled and dewaxed before being returned to the suction of the secondary compressor.

The polymer from this intermediate or high pressure vessel will then go through another pressure reduction step to a low pressure separator. The temperature of this vessel will be maintained above the polymer melting point so that the polymer from this vessel can be fed as a liquid directly to an extruder or static mixer. The pressure in this vessel will be kept low by using a compressor to recover the unreacted monomers, etc to the condenser and pumping system referenced above.

In addition to autoclave reactors, tubular reactors, or a combination of these reactors, loop-type reactors may be utilized in the process disclosed herein. In this reactor type, monomer enters and polymer exits continuously at different points along the loop, while an in-line pump continuously circulates the contents (reaction liquid). The feed/product takeoff rates control the total average residence time. A cooling jacket removes reaction heat from the loop. Typically feed inlet temperatures are near to or below ambient temperatures to provide cooling to the exothermic reaction in the reactor operating above the crystallization temperature of the polymer product. The loop reactor may have a diameter of 41 to 61 cm and a length of 100 to 200 meters and may operate at pressures of 25 to 30 MPa. In addition, an in-line pump may continuously circulate the polymerization system through the loop reactor.

U.S. Pat. No. 6,355,741 discusses a reactor with at least two loops that is useful in the practice of this invention provided that one or both loops operate at the supercritical conditions. U.S. Pat. No. 5,326,835 describes a process said to produce polymer in a bimodal fashion. This process's first reactor stage is a loop reactor in which polymerization occurs in an inert, low-boiling hydrocarbon. After the loop reactor, the reaction medium transits into a gas-phase reactor where gas-phase polymerization occurs. Since two very different environments create the polymer, it shows a bimodal molecular weight distribution. This two stage procedure can be modified to work with the procedure of the instant invention. For instance, a first stage loop reactor can use propylene as the monomer and a propylene-based reaction medium instead of the inert low-boiling hydrocarbon.

PCT publication WO 19/14766 describes a process comprising the steps of (a) continuously feeding olefinic monomer and a catalyst system, with a metallocene component and a cocatalyst component, to the reactor; (b) continuously polymerizing that monomer in a polymerization zone reactor under elevated pressure; (c) continuously removing the polymer/monomer mixture from the reactor; (d) continuously separating monomer from molten polymer; (e) reducing pressure to form a monomer-rich and a polymer-rich phase; and (f) separating monomer from the reactor. The polymerization zoning technique described in the above process can be practiced using the instant invention's process conditions. That is, the above process is suitable for use with this invention provided at least one polymerization zone makes the propylene or the reaction media containing propylene supercritical.

The polymerization processes disclosed herein may have residence times in the reactors as short as 0.5 seconds and as long as several hours, alternately from 1 sec to 120 min, alternately from 1 second to 60 minutes, alternately from 5 seconds to 30 minutes, alternately from 30 seconds to 30 minutes, alternately from 1 minute to 60 minutes, and alternately from 1 minute to 30 minutes. More particularly, the residence time may be selected from 10, or 30, or 45, or 50, seconds, or 1, or 5, or 10, or 15, or 20, or 25, or 30 or 60 or 120 minutes. Maximum residence times may be selected from 1, or 5, or 10, or 15, or 30, or 45, or 60, or 120 minutes.

Dividing the total quantity of polymer that is collected during the reaction time by the amount of monomer added to the reaction yields the conversion rate. The monomer-to-polymer conversion rate for the described processes can be as high as 90%. For practical reasons, for example for limiting viscosity, lower conversions could be preferred. Also, for practical reasons, for example for limiting the cost of monomer recycle, maximum conversions could be preferred. Thus, invention processes can be run at practical conversion rates of 80% or less, alternately 60 percent or less, alternately between 3-80%, alternately between 5-80%, alternately between 10-80%, alternately between 15-80%, alternately between 20-80%, alternately between 25-60%, alternately between 3-60%, alternately between 5-60%, alternately between 10-60%, alternately between 15-60%, alternately between 20-60%, alternately between 10-50%, alternately between 5-40%, alternately between 10-40%, alternately between 20-50%, alternately between 15-40%, alternately between 20-40%, or alternately between 30-40% conversion, preferably greater than 5%, or greater than 10 percent conversion%, preferably greater than 30% conversion, more preferably greater than 40% conversion, more preferably greater than 50% conversion, more preferably greater than 75% conversion, more preferably greater than 85% conversion.

Catalyst productivities range from 1,000 to 50,000,000 kg PP/(kg catalyst hr). These high levels of catalyst productivity may result in low residual ash solids in the polymer product. Residual total ash solid amount of less than 0.3 wt %, particularly less than 0.1 wt %, more particularly less than 0.01 wt % are preferred.

### Comonomers, Dual Catalysts and Polymer Structure

In reactors with multiple injection points for catalyst and feed there exists the possibility to tailor the polymer design. Use of more than one catalyst having different molecular weight and structural capabilities allows a wide variety of product compositions (e.g. bimodal, linear mixed with long chain branched).

When multiple reactors are used, the production of polymer blends is possible. In one embodiment, homopolymer and copolymer blends are made by using at least two reactors in parallel or series. The homopolymers could be polyethylene, polypropylene, polybutene, polyhexene, polyoctane, etc. In a preferred embodiment, the homopolymer comprises polyethylene, polypropylene, polybutylene, polyhexene, and polystyrene. In a more preferred embodiment, the homopolymer is polyethylene or polypropylene. The copolymers could be any two- or three-component combinations of ethylene, propylene, butene-1, hexene-1, octene-1, styrene, norbornene, 1,5-hexadiene, and 1,7-octadiene. In a more preferred embodiment, the copolymers are made from a two-component combination of ethylene, propylene, butene-1, hexene-1, styrene, norbornene, 1,5-hexadiene, and 1,7-octadiene. In another preferred embodiment, the copolymer is an ethylene-propylene, propylene-butene-1, propylene-hexene-1, propylene-butene-1, ethylene-butene-1, ethylene-hexene-1, ethylene-octene-1 copolymer. When the polymer blends are made in a series reactor cascade, one or more upstream reactors are fed with a single monomer-containing feed, while the feed of one or more downstream reactors is augmented with a comonomer feed stream. Since controlling the ratio of the homo- and copolymer is difficult in a series cascade reactor configuration, parallel reactor configuration are very useful in the production of polymer blends.

### Catalyst Killing

Once the polymerization is complete, the reactor effluent is depressurized to an intermediate pressure significantly below the cloud point pressure. This allows separation of a polymer rich phase for further purification and a propylene rich phase for recycle compression back to the reactor. Sometimes, heating the reactor effluent before pressure let down is necessary to avoid the separation of a solid polymer phase causing fouling.

This separation is typically carried out in a vessel known as a high pressure separator (HPS). Since this vessel also has a significant residence time, the catalyst activity is killed by addition of a polar species such as water, alcohol or sodium/calcium stearate. The choice and quantity of killing agent will depend on the requirements for clean up of the recycle propylene and comonomers as well as the product properties, if the killing agent has low volatility.

Alternately the intermediate separation can be done at pressures well below the critical point so that the monomer concentration and therefore reactivity in the high pressure separator is relatively low. The relatively small amount of continued polymerization in this vessel may not be a problem so addition of catalyst deactivating compounds as is done in PE processes may be avoided presuming that no undesired reactions occur in the high or intermediate pressure recycle system. If no killing compounds are added then the killer removal step can be eliminated.

### Choice of Propylene Feed Purity.

Propylene is generally available commercially at two levels of purity—polymer grade at 99.5% and chemical grade at about 93 to 95%. The choice of feed will set the level of purge required from the recycle to avoid over dilution of the feed by inert propane. The presence of propane in the reactor and HPS will raise the pressure of the cloud point curve for a given temperature but will decrease the polymerization efficiency due to a decrease in propylene (and other olefin) concentrations in the reactor. The elevation of cloud point pressure due to propane will widen the operating window of the HPS. In copolymerizations of propylene with limited amounts of ethylene, a similar effect in raising the cloud point pressure will be noted due to the presence of low levels of ethylene in the HPS.

### Low Pressure Separator Operation

A low pressure separator (LPS) can be used in the methods described herein. An LPS running at just above atmospheric pressure is just a simple sub-critical flash of light components, reactants and oligomers thereof, for the purpose of producing a low volatile-containing polymer melt entering the finishing extruder or static mixer.

In another embodiment, the processes of this invention are used to make ethylene homo- or co-polymers. Specifically ethylene-hexene and ethylene-butene copolymers are particular preferred. A process to produce ethylene polymers would preferably use a temperature of 150 to 190° C. and a pressure of 10,000 to 20,000 psi (69 to 138 MPa).

### Polymer Products

The polymers produced by invention processes may be in any structures including block, linear, radial, star, branched, and combinations of these. Some invention embodiments produce polypropylene and copolymers of polypropylene with a unique microstructure. The process of the invention can be practiced such that novel isotactic and syndiotactic compositions are made. In other embodiments, the invention processes make crystalline polymers.

The polymers produced herein typically have a melting point (also called melting temperature) of 70 to 165° C. The polymers produced herein typically have a weight-average molecular weight of 2,000 to 1,000,000, alternately 10,000 to 1,000,000, alternately 15,000 to 600,000, alternately 25,000 to 500,000, or alternately 35,000 to 350,000. Alternately, the polymers produced herein may have an Mw of 30,000 or more, preferably 50,000 or more, preferably 100,000 or more. In a preferred embodiment the polymers produced herein may have a melting point of 80° C. or more, preferably 100° C. or more, preferably 125° C. or more.

The propylene polymers produced herein typically have a melting point of 70 to 165° C. The propylene polymers produced herein typically have a weight-average molecular weight of 2,000 to 1,000,000, alternately 10,000 to 1,000,000, alternately 15,000 to 600,000, alternately 25,000 to 500,000, or alternately 35,000 to 350,000.

Invention processes preferably produce polymer with a heat of fusion, ΔH_{f}, of 1-60 J/g, 2-50 J/g, or 3-40 J/g. In another embodiment the processes of this invention produce polymers having ΔH_{f} of up to 100 J/g, preferably 60 to 100 J/g, more preferably 60 to 90 J/g.

The processes described herein can produce polymers having little or no ash or residue from catalyst or supports. In a preferred embodiment the polymers produced herein comprise less than 1 weight % silica, preferably less than 0.1 weight % silica, preferably less than 100 wt ppm silica, preferably less than 10 wt ppm silica. In a preferred embodiment the polymers produced herein comprise less than 1 weight % metal, preferably less than 0.1 weight % metal, preferably less than 100 wt ppm metal, preferably less than 10 wt ppm metal.

Dienes can be used as a comonomer to increase the molecular weight of the resulting polymer and to create long chain branching. Vinyl chloride can be used as a comonomer to increase the degree of vinyl termination in the polymer.

Invention processes can produce long-chain-branched polypropylene. Long-chain branching is achievable using invention process regardless of whether additional α,ω-diene or other diene such as vinylnorbornene are used. In a preferred embodiment, less than 0.5 wt % diene is used. Alternately, embodiments with less than 0.4 wt %, 0.3 wt %, 0.2 wt %, 1000 wt ppm, 500 wt ppm, 200 wt ppm, or 100 wt ppm α,ω-diene are used.

In some embodiments, the present invention involves using as a comonomer an α,ω-diene and the olefin/α,ω-diene copolymers resulting from that use. Additionally, the present invention involves a copolymerization reaction of olefin monomers, wherein the reaction includes propylene and ethylene copolymerization with an α,ω-diene and the copolymers that are made. These copolymers may be employed in a variety of articles including, for example, films, fibers, such as spunbonded and melt blown fibers, fabrics, such as nonwoven fabrics, and molded articles. More particularly, these articles include, for example, cast films, oriented films, injection molded articles, blow molded articles, foamed articles, foam laminates and thermoformed articles.

It should be noted that while linear α,ω-dienes are preferred, other dienes can also be employed to make polymers of this invention. These would include branched, substituted α,ω-dienes, such as 2-methyl-1,9-decadiene; cyclic dienes, such as vinylnorbornene; or aromatic types, such as divinyl benzene.

Embodiments of the present invention include copolymers having from 98 to 99.999 weight percent olefin units, and from 0.001 to 2.000 weight percent α,ω-diene units. Copolymer embodiments may have a weight-average molecular weight from 30,000 to 2,000,000, crystallization temperatures from 30° C. to 140° C. and an MFR (melt flow rate as measured by ASTM 1238, 230° C., 2.16 kg) from 0.1 dg/min to 5000 dg/min or more (dg/min is decigrams per minute).

In other embodiments, the copolymer includes from 90 to 99.999 weight percent of propylene units, from 0.000 to 8 weight percent of olefin units other than propylene units and from 0.001 to 2 weight percent α,ω-diene units. Copolymer embodiments may have weight-average molecular weights from 20,000 to 2,000,000, crystallization temperatures (without the addition of external nucleating agents) from 30° C. to 120° C. and MFRs from 0.1 dg/min to 5,000 dg/min or more. The accompanying olefin may be any of C₂-C₂₀ α-olefins, diolefins (with one internal olefin) and their mixtures thereof. More specifically, olefins include ethylene, butene-1, pentene-1, hexene-1, heptene-1, 4-methyl-1-pentene, 3-methyl-1-pentene, 4-methyl-1-hexene, 5-methyl-1-hexene, 1-octene, 1-decene, 1-undecene, and 1-dodecene.

Copolymers of isotactic polypropylene made under supercritical conditions include ethylene and C₄-C₁₂ comonomers such as but-1-ene, 3-methylpent-1-ene, hex-1-ene, 4-methylpent-1-ene, and oct-1-ene. Invention process can prepare these copolymers without the use of solvent or in an environment with low solvent concentration.

In a preferred embodiment the polymers have a residual solid ash amount of less than 0.5 wt %, particularly less than 0.3 wt %, or more particularly less than 0.1 wt % total solids residue are preferred.

Preferred propylene polymers produced typically comprise 0 to 40 weight % of a comonomer, preferably I to 30 weight %, preferably 2 to 20 weight %, preferably 4 to 10 weight %, and have one or more of:
1. a heat of fusion (H_{f}) of 10 J/g or more, preferably 20 J/g or more, preferably 30 or more, preferably 40 or more, preferably 50 or more, preferably 60 or more, preferably 70 or more OR an H_{f} of 30 J/g or less, more preferably 20 J/g or less preferably 0 J/g; and/or
2. a Branching index (g′_{avg}) of 1.0 or less, preferably 0.98 or less, preferably 0.97 or less, preferably 0.96 or less, preferably 0.95 or less, preferably 0.94 or less, preferably 0.93 or less, more preferably 0.92 or less, more preferably 0.91 or less, more preferably 0.90 or less; and/or
3. a weight average molecular weight (as measured by GPC DRI) of 20,000 or more, preferably 40,000 to 1,000,000, preferably 60,000 to 800,000, preferably 80,000 to 700,000, preferably6o,000 to 500,000; and/or
4. a melt flow rate of 0.1 dg/min or more, preferably 0.7 dg/min or more, preferably 1.0 dg/min or more, preferably between 0.1 and 5000 dg/min; and/or
5. a percent crystallinity (% X) of 20 % or more, preferably between 30 and 50%; and/or
6. a melting temperature (Tm) of 120° C. or more, preferably 130° C. or more, preferably 140° C. or more, preferably between 140 and 155° C.; and/or
7. a crystallization temperature of 20° C. or more, preferably 40° C. or more, preferably 60° C. or more, preferably 80° C. or more; and/or
8. an Mw/Mn (as measured by GPC DRI) of about 1 to 20, preferably about 1.5 to 8, preferably 2 to 4.

In another embodiment, polymers produced herein have a melt viscosity of less than 10,000 centipoises at 180° C. as measured on a Brookfield viscometer (ASTM 3236 at 180° C.), preferably between 1000 to 3000 cps for some embodiments (such as packaging and adhesives) and preferably between 5000 and 10,000 for other applications.

Heat of fusion, Mw, Mn, melting temperature, crystallization temperature, percent crystallinity, are determined according to the procedure in the Examples section. Melt flow rate is determined according to ASTM 1238(230° C., 2.16kg). Branching index (g′ₐᵥₑ) is determined using SEC with an on-line viscometer (SEC-VIS) and are reported as g′ at each molecular weight in the SEC trace. The branching index g′ is defined as:

$${g}^{′} = \frac{{η}_{b}}{{η}_{I}}$$

where η_{b} is the intrinsic viscosity of the branched polymer and η₁ is the intrinsic viscosity of a linear polymer of the same viscosity-averaged molecular weight (Mᵥ) as the branched polymer. η₁=KMᵥ^{α}, K and α are measured values for linear polymers and should be obtained on the same SEC-DRI-LS-VIS instrument as the one used for branching index measurement. For polypropylene samples presented in this invention, K=0.0002288 and α=0.705 are used. The SEC-DRI-LS-VIS method obviates the need to correct for polydispersities, since the intrinsic viscosity and the molecular weight are measured at individual elution volumes, which arguably contain narrowly dispersed polymer. Linear polymers selected as standards for comparison should be of the same viscosity average molecular weight and comonomer content. Linear character for polymer containing C2 to C10 monomers is confirmed by Carbon-13 NMR the method of Randall (Rev. Macromol. Chem. Phys., C29 (2&3), p. 285-297).

### Formulations

In some embodiments the polymer produced by this invention may be blended with one or more other polymers, including but not limited to, thermoplastic polymer(s) and/or elastomer(s).

A “thermoplastic polymer(s)” is a polymer that can be melted by heat and then cooled without appreciable change in properties. Thermoplastic polymers typically include, but are not limited to, polyolefins, polyamides, polyesters, polycarbonates, polysulfones, polyacetals, polylactones, acrylonitrile-butadiene-styrene resins, polyphenylene oxide, polyphenylene sulfide, styrene-acrylonitrile resins, styrene maleic anhydride, polyimides, aromatic polyketones, or mixtures of two or more of the above. Preferred polyolefins include, but are not limited to, polymers comprising one or more linear, branched or cyclic C₂ to C₄₀ olefins, preferably polymers comprising propylene copolymerized with one or more C₂ or C₄ to C₄₀ olefins, preferably a C₃ to C₂₀ alpha olefin, more preferably C₃ to C₁₀ α-olefins. More preferred polyolefins include, but are not limited to, polymers comprising ethylene including but not limited to ethylene copolymerized with a C₃ to C₄₀ olefin, preferably a C₃ to C₂₀ alpha olefin, more preferably propylene and or butene.

“Elastomers” encompass all natural and synthetic rubbers, including those defined in ASTM D1566). Examples of preferred elastomers include, but are not limited to, ethylene propylene rubber, ethylene propylene diene monomer rubber, styrenic block copolymer rubbers (including SI, SIS, SB, SBS, SEBS and the like, where S=styrene, I=isobutylene, and B=butadiene), butyl rubber, halobutyl rubber, copolymers of isobutylene and para-alkylstyrene, halogenated copolymers of isobutylene and para-alkylstyrene, natural rubber, polyisoprene, copolymers of butadiene with acrylonitrile, polychloroprene, alkyl acrylate rubber, chlorinated isoprene rubber, acrylonitrile chlorinated isoprene rubber, polybutadiene rubber (both cis and trans).

In another embodiment, the polymer produced by this invention is combined with one or more of isotactic polypropylene, highly isotactic polypropylene, syndiotactic polypropylene, random copolymer of propylene and ethylene and/or butene and/or hexene, polybutene, ethylene vinyl acetate, low density polyethylene (density 0.915 to less than 0.935 g/cm³) linear low density polyethylene, ultra low density polyethylene (density 0.86 to less than 0.90 g/cm³), very low density polyethylene (density 0.90 to less than 0.915 g/cm³), medium density polyethylene (density 0.935 to less than 0.945 g/cm³), high density polyethylene (density 0.945 to 0.98 g/cm³), ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, crosslinked polyethylene, polymers that are a hydrolysis product of EVA that equate to an ethylene vinyl alcohol copolymer, polymers of aromatic monomers such as polystyrene, poly-1 esters, polyacetal, polyvinylidine fluoride, polyethylene glycols and/or polyisobutylene.

In another embodiment elastomers are blended with the polymer produced by this invention to form rubber toughened compositions. In some particularly preferred embodiments, the rubber toughened composition is a two (or more) phase system where the elastomer is a discontinuous phase and the polymer produced by this invention is a continuous phase. This blend may be combined with tackifiers and/or other additives as described herein.

In another embodiment the polymer produced by this invention may be blended with elastomers or other soft polymers to form impact copolymers. In some embodiments the blend is a two (or more) phase system where the elastomer or soft polymer is a discontinuous phase and the polymer produced by this invention is a continuous phase. This blend may be combined with tackifiers and/or other additives as described herein.

In some embodiments the polymers of the invention described above are combined with metallocene polyethylenes (mPEs) or metallocene polypropylenes (mPPs). The mPE and mPP homopolymers or copolymers are typically produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings by may substituted or unsubstituted. Several commercial products produced with such catalyst/activator combinations are commercially available from ExxonMobil Chemical Company in Baytown, Tex. under the tradenames EXCEED™, ACHIEVE™ and EXAC™. For more information on the methods and catalysts/activators to produce such homopolymers and copolymers see WO 94/26816; WO 94/03506; EPA 277,003; EPA 277,004; U.S. Pat. No. 5,153,157; U.S. Pat. No. 5,198,401; U.S. Pat. No. 5,240,894; U.S. Pat. No. 5,017,714; CA 1,268,753; U.S. Pat. No. 5,324,800; EPA 129,368; U.S. Pat. No. 5,264,405; EPA 520,732; WO 92 00333; U.S. Pat. No. 5,096,867; U.S. Pat. No. 5,507,475; EPA 426 637; EPA 573 403; EPA 520 732; EPA 495 375; EPA 500 944; EPA 570 982; W091/09882; W094/03506 and U.S. Pat. No. 5,055,438.

In some embodiments the polymer of this invention is present in the above blends, at from 10 to 99 weight %, based upon the weight of the polymers in the blend, preferably 20 to 95 weight %, even more preferably at least 30 to 90 weight %, even more preferably at least 40 to 90 weight %, even more preferably at least 50 to 90 weight %, even more preferably at least 60 to 90 weight %, even more preferably at least 70 to 90 weight %.

The blends described above may be produced by (a) mixing the polymers of the invention with one or more polymers (as described above), by (b) connecting reactors together in series to make in situ reactor blends or by (c) using more than one catalyst in the same reactor to produce multiple species of polymers. The polymers can be mixed together prior to being put into the extruder or may be mixed in an extruder.

Any of the above polymers may be functionalized. Functionalized means that the polymer has been contacted with an unsaturated acid or anhydride. Preferred unsaturated acids or anhydrides include any unsaturated organic compound containing at least one double bond and at least one carbonyl group. Representative acids include carboxylic acids, anhydrides, esters and their salts, both metallic and non-metallic. Preferably the organic compound contains an ethylenic unsaturation conjugated with a carbonyl group (—C═O). Examples include maleic, fumaric, acrylic, methacrylic, itaconic, crotonic, alpha-methyl crotonic, and cinnamic acids as well as their anhydrides, esters and salt derivatives. Maleic anhydride is particularly preferred. The unsaturated acid or anhydride is preferably present at about 0.1 weight % to about 5 weight %, preferably at about 0.5 weight % to about 4 weight %, even more preferably at about 1 to about 3 weight %, based upon the weight of the hydrocarbon resin and the unsaturated acid or anhydride.

Tackifiers may be blended with the polymers of this invention and/or with blends of the polymer produced by this inventions (as described above). Examples of useful tackifiers include, but are not limited to, aliphatic hydrocarbon resins, aromatic modified aliphatic hydrocarbon resins, hydrogenated polycyclopentadiene resins, polycyclopentadiene resins, gum rosins, gum rosin esters, wood rosins, wood rosin esters, tall oil rosins, tall oil rosin esters, polyterpenes, aromatic modified polyterpenes, terpene phenolics, aromatic modified hydrogenated polycyclopentadiene resins, hydrogenated aliphatic resin, hydrogenated aliphatic aromatic resins, hydrogenated terpenes and modified terpenes, and hydrogenated rosin esters. In some embodiments the tackifier is hydrogenated. In other embodiments the tackifier is non-polar. (Non-polar tackifiers are substantially free of monomers having polar groups. Preferably the polar groups are not present; however, if present, they are preferably not present at more that 5 weight %, preferably not more that 2 weight %, even more preferably no more than 0.5 weight %.) In some embodiments the tackifier has a softening point (Ring and Ball, as measured by ASTM E-28) of 80° C. to 140° C., preferably 100° C. to 130° C. In some embodiments the tackifier is functionalized. By functionalized is meant that the hydrocarbon resin has been contacted with an unsaturated acid or anhydride. Preferred unsaturated acids or anhydrides include any unsaturated organic compound containing at least one double bond and at least one carbonyl group. Representative acids include carboxylic acids, anhydrides, esters and their salts, both metallic and non-metallic. Preferably the organic compound contains an ethylenic unsaturation conjugated with a carbonyl group (—C═O). Examples include maleic, fumaric, acrylic, methacrylic, itaconic, crotonic, alpha-methyl crotonic, and cinnamic acids as well as their anhydrides, esters and salt derivatives. Maleic anhydride is particularly preferred. The unsaturated acid or anhydride is preferably present at about 0.1 weight % to about 10 weight %, preferably at about 0.5 weight % to about 7 weight %, even more preferably at about 1 to about 4 weight %, based upon the weight of the hydrocarbon resin and the unsaturated acid or anhydride.

The tackifier, if present, is typically present at about 1 weight % to about 50 weight %, based upon the weight of the blend, more preferably 10 weight % to 40 weight %, even more preferably 20 weight % to 40 weight %. Preferably however, tackifier is not present, or if present, is present at less than 10 weight %, preferably less than 5 weight %, more preferably at less than I weight %.

In another embodiment the polymers of this invention, and/or blends thereof, further comprise a crosslinking agent. Preferred crosslinking agents include those having functional groups that can react with the acid or anhydride group. Preferred crosslinking agents include alcohols, multiols, amines, diamines and/or triamines. Examples of crosslinking agents useful in this invention include polyamines such as ethylenediamine, diethylenetriamine, hexamethylenediamine, diethylaniinopropylamine, and/or menthanediamine.

In another embodiment the polymers of this invention, and/or blends thereof, further comprise typical additives known in the art such as fillers, cavitating agents, antioxidants, surfactants, adjuvants, plasticizers, block, antiblock, color masterbatches, pigments, dyes, processing aids, UV stabilizers, neutralizers, lubricants, waxes, and/or nucleating agents. The additives may be present in the typically effective amounts well known in the art, such as 0.001 weight % to 10 weight %.

Preferred fillers, cavitating agents and/or nucleating agents include titanium dioxide, calcium carbonate, barium sulfate, silica, silicon dioxide, carbon black, sand, glass beads, mineral aggregates, talc, clay and the like.

Preferred antioxidants include phenolic antioxidants, such as Irganox 1010, Irganox, 1076 both available from Ciba-Geigy. Preferred oils include paraffinic or naphthenic oils such as Primol 352, or Primol 876 available from ExxonMobil Chemical France, S.A. in Paris, France.

More preferred oils include aliphatic naphthenic oils, white oils or the like. Preferred plasticizers and/or adjuvants include mineral oils, polybutenes, phthalates and the like. Particularly preferred plasticizers include phthalates such as diisoundecyl phthalate (DIUP), diisononylphthalate (DINP), dioctylphthalates (DOP) and polybutenes, such as Parapol 950 and Parapol 1300 available from ExxonMobil Chemical Company in Houston Texas. Additional Preferred plasticizers include WO0118109A1 and U.S. Ser. No. 10/640,435, which are incorporated by reference herein.

Preferred processing aids, lubricants, waxes, and/or oils include low molecular weight products such as wax, oil or low Mn polymer, (low meaning below Mn of 5000, preferably below 4000, more preferably below 3000, even more preferably below 2500). Preferred waxes include polar or non-polar waxes, functionalized waxes, polypropylene waxes, polyethylene waxes, and wax modifiers. Preferred waxes include ESCOMER™101.

Preferred functionalized waxes include those modified with an alcohol, an acid, or a ketone. Functionalized means that the polymer has been contacted with an unsaturated acid or anhydride. Preferred unsaturated acids or anhydrides include any unsaturated organic compound containing at least one double bond and at least one carbonyl group. Representative acids include carboxylic acids, anhydrides, esters and their salts, both metallic and non-metallic. Preferably the organic compound contains an ethylenic unsaturation conjugated with a carbonyl group (—C═O). Examples include maleic, fumaric, acrylic, methacrylic, itaconic, crotonic, alpha-methyl crotonic, and cinnamic acids as well as their anhydrides, esters and salt derivatives. Maleic anhydride is particularly preferred. The unsaturated acid or anhydride is preferably present at about 0.1 weight % to about 10 weight %, preferably at about 0.5 weight % to about 7 weight %, even more preferably at about 1 to about 4 weight %, based upon the weight of the hydrocarbon resin and the unsaturated acid or anhydride. Preferred examples include waxes modified by methyl ketone, maleic anhydride or maleic acid. Preferred low Mn polymers include polymers of lower alpha olefins such as propylene, butene, pentene, hexene and the like. A particularly preferred polymer includes polybutene having an Mn of less than 1000. An example of such a polymer is available under the trade name PARAPOL™950 from ExxonMobil Chemical Company. PARAPOL™950 is an liquid polybutene polymer having an Mn of 950 and a kinematic viscosity of 220 cSt at 100° C., as measured by ASTM D 445.

Preferred UV stabilizers and or antioxidants include Irganox 1010 and the like.

### Applications

The polymers of this invention (and blends thereof as described above) whether formed in situ or by physical blending are preferably used in any known thermoplastic or elastomer application. Examples include uses in molded parts, films, tapes, sheets, tubing, hose, sheeting, wire and cable coating, adhesives, shoe soles, bumpers, gaskets, bellows, films, fibers, elastic fibers, nonwovens, spunbonds, sealants, surgical gowns and medical devices.

### Adhesives

The polymers of this invention or blends thereof can be used as adhesives, either alone or combined with tackifiers. The tackifier is typically present at about 1 weight % to about 50 weight %, based upon the weight of the blend, more preferably 10 weight % to 40 weight %, even more preferably 20 weight % to 40 weight %. Other additives, as described above, may be added also.

The adhesives of this invention can be used in any adhesive application, including but not limited to, disposables, packaging, laminates, pressure sensitive adhesives, tapes labels, wood binding, paper binding, non-wovens, road marking, reflective coatings, and the like. In some embodiments the adhesives of this invention can be used for disposable diaper and napkin chassis construction, elastic attachment in disposable goods converting, packaging, labeling, bookbinding, woodworking, and other assembly applications. Particularly preferred applications include: baby diaper leg elastic, diaper frontal tape, diaper standing leg cuff, diaper chassis construction, diaper core stabilization, diaper liquid transfer layer, diaper outer cover lamination, diaper elastic cuff lamination, feminine napkin core stabilization, feminine napkin adhesive strip, industrial filtration bonding, industrial filter material lamination, filter mask lamination, surgical gown lamination, surgical drape lamination, and perishable products packaging.

The adhesives described above may be applied to any substrate. Preferred substrates include wood, paper, cardboard, plastic, thermoplastic, rubber, metal, metal foil (such as aluminum foil and tin foil), metallized surfaces, cloth, non-wovens (particularly polypropylene spun bonded fibers or non-wovens), spunbonded fibers, cardboard, stone, plaster, glass (including silicon oxide (SiOₓ) coatings applied by evaporating silicon oxide onto a film surface), foam, rock, ceramics, films, polymer foams (such as polyurethane foam), substrates coated with inks, dyes, pigments, PVDC and the like or combinations thereof. Additional preferred substrates include polyethylene, polypropylene, polyacrylates, acrylics, polyethylene terephthalate, or any of the polymers listed above as suitable for blends. Corona treatment, electron beam irradiation, gamma irradiation, microwave or silanization may modify any of the above substrates.

### Films

The polymer produced by this invention described above and the blends thereof may be formed into monolayer or multilayer films. These films may be formed by any of the conventional techniques known in the art including extrusion, co-extrusion, extrusion coating, lamination, blowing, tenter frame, and casting. The film may be obtained by the flat film or tubular process, which may be followed by orientation in a uniaxial direction, or in two mutually perpendicular directions in the plane of the film. One or more of the layers of the film may be oriented in the transverse and/or longitudinal directions to the same or different extents. This orientation may occur before or after the individual layers are brought together. For example a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically the films are oriented in the Machine Direction (MD) at a ratio of up to 15, preferably between 5 and 7, and in the Transverse Direction (TD) at a ratio of up to 15 preferably 7 to 9. However in another embodiment the film is oriented to the same extent in both the MD and TD directions. In another embodiment the layer comprising the polymer composition of this invention (and/or blends thereof) may be combined with one or more other layers. The other layer(s) may be any layer typically included in multilayer film structures. For example the other layer or layers may be:
1. Polyolefins. Preferred polyolefins include homopolymers or copolymers of C₂ to C₄₀ olefins, preferably C₂ to C₂₀ olefins, preferably a copolymer of an α-olefin and another olefin or .α-olefin (ethylene is defined to be an α-olefin for purposes of this invention). Preferably homopolyethylene, homopolypropylene, propylene copolymerized with ethylene and or butene, ethylene copolymerized with one or more of propylene, butene or hexene, and optional dienes. Preferred examples include thermoplastic polymers such as ultra low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and blends of thermoplastic polymers and elastomers, such as for example, thermoplastic elastomers and rubber toughened plastics.
2. Polar polymers. Preferred polar polymers include homopolymers and copolymers of esters, amides, acrylates, anhydrides, copolymers of a C₂ to C₂₀ olefin, such as ethylene and/or propylene and/or butene with one or more polar monomers such as acetates, anhydrides, esters, alcohol, and or acrylics. Preferred examples include polyesters, polyamides, ethylene vinyl acetate copolymers, and polyvinyl chloride.
3. Cationic polymers. Preferred cationic polymers include polymers or copolymers of geminally disubstituted olefins, alpha-heteroatom olefins and/or styrenic monomers. Preferred geminally disubstituted olefins include isobutylene, isopentene, isoheptene, isohexane, isooctene, isodecene, and isododecene. Preferred a-heteroatom olefins include vinyl ether and vinyl carbazole, preferred styrenic monomers include styrene, alkyl styrene, para-alkyl styrene, alpha-methyl styrene, chloro-styrene, and bromo-para-methyl styrene. Preferred examples of cationic polymers include butyl rubber, isobutylene copolymerized with para methyl styrene, polystyrene, and poly-α-methyl styrene.
4. Miscellaneous. Other preferred layers can be paper, wood, cardboard, metal, metal foils (such as aluminum foil and tin foil), metallized surfaces, glass (including silicon oxide (SiO.x)coatings applied by evaporating silicon oxide onto a film surface), fabric, spunbonded fibers, and non-wovens (particularly polypropylene spun bonded fibers or non-wovens), and substrates coated with inks, dyes, pigments, PVDC and the like. The films may vary in thickness depending on the intended application, however films of a thickness from 1 to 250 μm are usually suitable. Films intended for packaging are usually from 10 to 60 μm thick. The thickness of the sealing layer is typically 0.2 to 50 μm. There may be a sealing layer on both the inner and outer surfaces of the film or the sealing layer may be present on only the inner or the outer surface. Additives such as block, antiblock, antioxidants, pigments, fillers, processing aids, UV stabilizers, neutralizers, lubricants, surfactants and/or nucleating agents may also be present in one or more than one layer in the films. Preferred additives include silicon dioxide, titanium dioxide, polydimethylsiloxane, talc, dyes, wax, calcium stearate, carbon black, low molecular weight resins and glass beads. In another embodiment, one or more layers may be modified by corona treatment, electron beam irradiation, gamma irradiation, or microwave. In some embodiments, one or both of the surface layers is modified by corona treatment. The films described herein may also comprise from 5 to 60 weight %, based upon the weight of the polymer and the resin, of a hydrocarbon resin. The resin may be combined with the polymer of the seal layer(s) or may be combined with the polymer in the core layer(s). The resin preferably has a softening point above 100° C., even more preferably from 130 to 180° C. Preferred hydrocarbon resins include those described above. The films comprising a hydrocarbon resin may be oriented in uniaxial or biaxial directions to the same or different degrees.

The films described above may be used as packaging and or stretch and/or cling films. Stretch/cling films are used in various bundling, packaging and palletizing operations. To impart cling properties to, or improve the cling properties of, a particular film, a number of well-known tackifying additives have been utilized. Common tackifying additives include polybutenes, terpene resins, alkali metal stearates and hydrogenated rosins and rosin esters. The well-known physical process referred to as corona discharge can also modify the cling properties of a film. Some polymers (such as ethylene methyl acrylate copolymers) do not need cling additives and can be used as cling layers without tackifiers. Stretch/cling films may comprise a slip layer comprising any suitable polyolefin or combination of polyolefins such as polyethylene, polypropylene, copolymers of ethylene and propylene, and polymers obtained from ethylene and/or propylene copolymerized with minor amounts of other olefins, particularly C₄-C₁₂ olefins. Particularly, preferred are polypropylene and linear low density polyethylene (LLDPE). Suitable polypropylene is normally solid and isotactic, i.e., greater than 90% hot heptane insolubles, having wide ranging melt flow rates of from about 0.1 to about 300 g/10 min. Additionally, the slip layer may include one or more anti-cling (slip and/or antiblock) additives, which may be added during the production of the polyolefin or subsequently blended in to improve the slip properties of this layer. Such additives are well-known in the art and include, for example, silicas, silicates, diatomaceous earths, talcs and various lubricants. These additives are preferably utilized in amounts ranging from about 100 ppm to about 20,000 ppm, more preferably between about 500 ppm to about 10,000 ppm, by weight based upon the weight of the slip layer. The slip layer may, if desired, also include one or more other additives as described above

Polymers produced herein can be used for nonwovens, sealing layers, oriented polypropylene, and high-clarity thermoforming.

### Melt-Blown and Spun-Bond Fabrics

Polymer made under supercritical conditions herein are useful for melt blown and spun bond fabrics. Invention processes can be used for making PP for spun bonded (SB) and melt blown (MB) fibers. Typical invention polymers have ash levels below 1000, 900, 700, 500, 400, 300, 200, 100, 50, 10, 1, 0.5, or 0.1 ppm. Some embodiments have ash levels of 1-500 ppb. All these characteristics combine to reduce polymer build-up on the die exits. These products can have high MFRs from 300-5000 useful for fiber applications.

### Waxes

Invention process can prepare long chain branched isotactic-polypropylene at high monomer conversion (35+% and especially 45+%) conditions. Some embodiments use higher amounts of diluent to promote long chain branching. Long chain branching is also favored by operating the polymerization under supercritical conditions, but with a polymer rich phase and a polymer lean phase. Doing this allows the polymer-rich phase to have a lower monomer concentration and a higher local concentration of vinyl terminated polymer.

An appropriate choice of operating conditions and monomer and comonomer feeds, 180-200° C. and 20-150 MPa, yields polypropylene waxes from invention polymers and processes. Some invention embodiments are isotactic polypropylene waxes. As such these materials are well suited for viscosity modification in polymers, adhesives, films, and other applications.

### End Use Articles

Laminates comprising invention polymers can be used as a thermoformable sheet where the substrate is either sprayed or injection molded to couple it with the ionomer/tie-layer laminate sheet. The composite is formed into the desired shape to make the article, or composite article. Various types of substrate materials form highly desirable articles. The laminate can be used with plastic substrates such as homopolymers, copolymers, foams, impact copolymers, random copolymers, and other applications. Specifically, some articles in which the present invention can be incorporated are the following: vehicle parts, especially exterior parts such as bumpers and grills, rocker panels, fenders, doors, hoods, trim, and other parts can be made from the laminates, composites and methods of the invention.

Other articles can also be named, for example: counter tops, laminated surface counter tops, pool liners/covers/boat covers, boat sails, cable jacketing, motorcycles/snowmobiles/outdoor vehicles, marine boat hulls/canoe interior and exterior, luggage, clothing/fabric (combined with non-wovens), tent material, GORETEX™, Gamma-radiation resistant applications, electronics housing (TV's, VCR's and computers), a wood replacement for decks and other outdoor building materials, prefab buildings, synthetic marble panels for construction, wall covering, hopper cars, floor coating, polymer/wood composites, vinyl tile, bath/shower/toilet applications and translucent glass replacement, sidings, lawn/outdoor furniture, appliances such as refrigerators, washing machines, etc., children's toys, reflective signage and other reflective articles on roads and clothing, sporting equipment such as snowboards, surfboards, skis, scooters, wheels on in-line skates, CD's for scratch resistance, stadium seats, aerospace reentry shields, plastic paper goods, sports helmets, plastic microwaveable cookware, and other applications for coating plastics and metal where a highly glossy and scratch resistant surface is desirable, while not being subject to algae/discoloration.

The polypropylene copolymers described herein are suitable for applications such as molded articles, including injection and blow molded bottles and molded items used in automotive articles, such as automotive interior and exterior trims. Examples of other methods and applications for making polypropylene polymers and for which polypropylene polymers may be useful are described in the Encyclopedia of Chemical Technology, by Kirk-Othmer, Fourth Edition, vol. 17, at pages 748-819, which are incorporated by reference herein. In those instances where the application is for molded articles, the molded articles may include a variety of molded parts, particularly molded parts related to and used in the automotive industry such as, for example, bumpers, side panels, floor mats, dashboards and instrument panels. Foamed articles are another application and examples where foamed plastics, such as foamed polypropylene, are useful may be found in Encyclopedia of Chemical Technology, by Kirk-Othmer, Fourth Edition, vol. 11, at pages 730-783, which are incorporated by reference herein. Foamed articles are particularly useful for construction and automotive applications. Examples of construction applications include heat and sound insulation, industrial and home appliances, and packaging. Examples of automotive applications include interior and exterior automotive parts, such as bumper guards, dashboards and interior liners.

The polyolefinic compositions of the present invention are suitable for such articles as automotive components, wire and cable jacketing, pipes, agricultural films, geomembranes, toys, sporting equipment, medical devices, casting and blowing of packaging films, extrusion of tubing, pipes and profiles, sporting equipment, outdoor furniture (e.g., garden furniture) and playground equipment, boat and water craft components, and other such articles. In particular, the compositions are suitable for automotive components such as bumpers, grills, trim parts, dashboards and instrument panels, exterior door and hood components, spoiler, wind screen, hub caps, mirror housing, body panel, protective side molding, and other interior and external components associated with automobiles, trucks, boats, and other vehicles.

Other useful articles and goods may be formed economically by the practice of our invention including: crates, containers, packaging, labware, such as roller bottles for culture growth and media bottles, office floor mats, instrumentation sample holders and sample windows; liquid storage containers such as bags, pouches, and bottles for storage and IV infusion of blood or solutions; packaging material including those for any medical device or drugs including unit-dose or other blister or bubble pack as well as for wrapping or containing food preserved by irradiation. Other useful items include medical tubing and valves for any medical device including infusion kits, catheters, and respiratory therapy, as well as packaging materials for medical devices or food which is irradiated including trays, as well as stored liquid, particularly water, milk, or juice, containers including unit servings and bulk storage containers as well as transfer means such as tubing, pipes, and such.

### Molded Products

The polymers described above may also be used to prepare the molded products of this invention in any molding process, including but not limited to, injection molding, gas-assisted injection molding, extrusion blow molding, injection blow molding, injection stretch blow molding, compression molding, rotational molding, foam molding, thermoforming, sheet extrusion, and profile extrusion. The molding processes are well known to those of ordinary skill in the art.

The compositions described herein may be shaped into desirable end use articles by any suitable means known in the art. Thermoforming, vacuum forming, blow molding, rotational molding, slush molding, transfer molding, wet lay-up or contact molding, cast molding, cold forming matched-die molding, injection molding, spray techniques, profile co-extrusion, or combinations thereof are typically used methods.

Thermoforming is a process of forming at least one pliable plastic sheet into a desired shape. An embodiment of a thermoforming sequence is described, however this should not be construed as limiting the thermoforming methods useful with the compositions of this invention. First, an extrudate film of the composition of this invention (and any other layers or materials) is placed on a shuttle rack to hold it during heating. The shuttle rack indexes into the oven which pre-heats the film before forming. Once the film is heated, the shuttle rack indexes back to the forming tool. The film is then vacuumed onto the forming tool to hold it in place and the forming tool is closed. The forming tool can be either “male” or “female” type tools. The tool stays closed to cool the film and the tool is then opened. The shaped laminate is then removed from the tool.

Thermoforming is accomplished by vacuum, positive air pressure, plug-assisted vacuum forming, or combinations and variations of these, once the sheet of material reaches thermoforming temperatures, typically of from 140° C. to 185° C. or higher. A pre-stretched bubble step is used, especially on large parts, to improve material distribution. In one embodiment, an articulating rack lifts the heated laminate towards a male forming tool, assisted by the application of a vacuum from orifices in the male forming tool. Once the laminate is firmly formed about the male forming tool, the thermoformed shaped laminate is then cooled, typically by blowers. Plug-assisted forming is generally used for small, deep drawn parts. Plug material, design, and timing can be critical to optimization of the process. Plugs made from insulating foam avoid premature quenching of the plastic. The plug shape is usually similar to the mold cavity, but smaller and without part detail. A round plug bottom will usually promote even material distribution and uniform side-wall thickness. For a semicrystalline polymer such as polypropylene, fast plug speeds generally provide the best material distribution in the part.

The shaped laminate is then cooled in the mold. Sufficient cooling to maintain a mold temperature of 30° C. to 65° C. is desirable. The part is below 90° C. to 100° C. before ejection in one embodiment. For the good behavior in thermoforming, the lowest melt flow rate polymers are desirable. The shaped laminate is then trimmed of excess laminate material.

Blow molding is another suitable forming means, which includes injection blow molding, multi-layer blow molding, extrusion blow molding, and stretch blow molding, and is especially suitable for substantially closed or hollow objects, such as, for example, gas tanks and other fluid containers. Blow molding is described in more detail in, for example, CONCISE ENCYCLOPEDIA OF POLYMER SCIENCE AND ENGINEERING 90-92 (Jacqueline I. Kroschwitz, ed., John Wiley & Sons 1990).

In yet another embodiment of the formation and shaping process, profile co-extrusion can be used. The profile co-extrusion process parameters are as above for the blow molding process, except the die temperatures (dual zone top and bottom) range from 150° C.-235° C., the feed blocks are from 90° C.-250° C., and the water cooling tank temperatures are from 10° C.-40° C.

One embodiment of an injection molding process is described as follows. The shaped laminate is placed into the injection molding tool. The mold is closed and the substrate material is injected into the mold. The substrate material has a melt temperature between 200° C. and 300° C. in one embodiment, and from 215° C. and 250° C. and is injected into the mold at an injection speed of between 2 and 10 seconds. After injection, the material is packed or held at a predetermined time and pressure to make the part dimensionally and aesthetically correct. Typical time periods are from 5 to 25 seconds and pressures from 1,380 kPa to 10,400 kPa. The mold is cooled between 10° C. and 70° C. to cool the substrate. The temperature will depend on the desired gloss and appearance desired. Typical cooling time is from 10 to 30 seconds, depending on part on the thickness. Finally, the mold is opened and the shaped composite article ejected.

Likewise, molded articles may be fabricated by injecting molten polymer into a mold that shapes and solidifies the molten polymer into desirable geometry and thickness of molded articles. Sheet may be made either by extruding a substantially flat profile from a die, onto a chill roll, or alternately by calendaring. Sheet will generally be considered to have a thickness of from 10 mils to 100 mils (254 μm to 2540 μm), although sheet may be substantially thicker. Tubing or pipe may be obtained by profile extrusion for uses in medical, potable water, land drainage applications or the like. The profile extrusion process involves the extrusion of molten polymer through a die. The extruded tubing or pipe is then solidified by chill water or cooling air into a continuous extruded articles. The tubing will generally be in the range of from 0.31 cm to 2.54 cm in outside diameter, and have a wall thickness of in the range of from 254 μm to 0.5 cm. The pipe will generally be in the range of from 2.54 cm to 254 cm in outside diameter, and have a wall thickness of in the range of from 0.5 cm to 15 cm. Sheet made from the products of an embodiment of a version of the present invention may be used to form containers. Such containers may be formed by thermoforming, solid phase pressure forming, stamping and other shaping techniques. Sheets may also be formed to cover floors or walls or other surfaces.

In an embodiment of the thermoforming process, the oven temperature is between 160° C. and 195° C., the time in the oven between 10 and 20 seconds, and the die temperature, typically a male die, between 10° C. and 71° C. The final thickness of the cooled (room temperature), shaped laminate is from 10 μm to 6000 μm in one embodiment, from 200 μm to 6000 μm in another embodiment, and from 250 μm to 3000 μm in yet another embodiment, and from 500 μm to 1550 μm in yet another embodiment, a desirable range being any combination of any upper thickness limit with any lower thickness limit.

In an embodiment of the injection molding process, wherein a substrate material in injection molded into a tool including the shaped laminate, the melt temperature of the substrate material is between 230° C. and 255° C. in one embodiment, and between 235° C. and 250° C. in another embodiment, the fill time from 2 to 10 seconds in one embodiment, from 2 to 8 seconds in another embodiment, and a tool temperature of from 25° C. to 65° C. in one embodiment, and from 27° C. and 60° C. in another embodiment. In a desirable embodiment, the substrate material is at a temperature that is hot enough to melt any tie-layer material or backing layer to achieve adhesion between the layers.

In yet another embodiment of the invention, the compositions of this invention may be secured to a substrate material using a blow molding operation. Blow molding is particularly useful in such applications as for making closed articles such as fuel tanks and other fluid containers, playground equipment, outdoor furniture and small enclosed structures. In one embodiment of this process, compositions of this invention are extruded through a multi-layer head, followed by placement of the uncooled laminate into a parison in the mold. The mold, with either male or female patterns inside, is then closed and air is blown into the mold to form the part.

It will be understood by those skilled in the art that the steps outlined above may be varied, depending upon the desired result. For example, an extruded sheet of the compositions of this invention may be directly thermoformed or blow molded without cooling, thus skipping a cooling step. Other parameters may be varied as well in order to achieve a finished composite article having desirable features.

### Non-Wovens and Fibers

The polymers described above may also be used to prepare the nonwoven fabrics and fibers of this invention in any nonwoven fabric and fiber making process, including but not limited to, melt blowing, spunbonding, film aperturing, and staple fiber carding. A continuous filament process may also be used. Preferably a spunbonding process is used. The spunbonding process is well known in the art. Generally it involves the extrusion of fibers through a spinneret. These fibers are then drawn using high velocity air and laid on an endless belt. A calender roll is generally then used to heat the web and bond the fibers to one another although other techniques may be used such as sonic bonding and adhesive bonding. The fabric may be prepared with mixed metallocene polypropylene alone, physically blended with other mixed metallocene polypropylene or physically blended with single metallocene polypropylene. Likewise the fabrics of this invention may be prepared with mixed metallocene polypropylene physically blended with conventional Ziegler-Natta produced polymer. If blended, the fabric of this invention is preferably comprised of at least 50% mixed metallocene polypropylene. With these nonwoven fabrics, manufacturers can maintain the desirable properties of fabrics prepared with metallocene produced polypropylene while increasing fabric strength and potentially increased line speed compared to fabrics made using conventional polymers.

This Invention Also Relates to:
1. A process to polymerize olefins comprising contacting, at a temperature of 60° C. or more and a pressure between 15 MPa and 1500 MPa, one or more olefin monomers having three or more carbon atoms, with:
1) a catalyst system comprising one or more activators and one or more nonmetallocene metal-centered, heteroaryl ligand catalyst compounds, where the metal is chosen from the Group 4, 5, 6, the lanthanide series, or the actinide series of the Periodic Table of the Elements,
2) optionally one or more comonomers,
3) optionally diluent or solvent, and
4) optionally scavenger,
   wherein:

a) the olefin monomers and any comonomers are present in the polymerization system at 40 weight % or more,

b) the monomer having three or more carbon atoms is present at 80 wt % or more based upon the weight of all monomers and comonomers present in the feed, and,

c) the polymerization occurs at a temperature above the solid-fluid phase transition temperature of the polymerization system and a pressure no lower than 2 MPa below the cloud point pressure of the polymerization system, in the event the solid-fluid phase transition temperature of the polymerization system cannot be determined then the polymerization occurs at a temperature above the fluid fluid phase transition temperature.
2. The process of paragraph 1 wherein the polymerization occurs at a temperature above the fluid-fluid phase transition temperature of the polymerization system.
3. The process of paragraph 1 or 2 further comprising obtaining a polymer having an Mw of 30,000 or more, preferably 50,000 or more, preferably 100,000 or more.
4. The process of paragraph 1, 2 or 3 further comprising obtaining a polymer having a melting point of 80° C. or more, preferably 100° C. or more, preferably 125° C. or more.
5. The process of any of paragraphs 1 to 4 wherein the olefin monomers having three or more carbon atoms are present in the polymerization system at 40 weight % or more, preferably 55 wt % or more, preferably 75 wt % or more.
6. The process of any of paragraphs 1 to 5 where the temperature is between 80 to 200° C., preferably between 90 to 180° C.
7. The process of any of paragraphs 1 to 6 wherein the pressure is between 15 and 250 MPa, preferably between 20 and 140 MPa.
8. The process of any of paragraphs 1 to 7 wherein solvent and or diluent is hexane.
9. The process of any of paragraphs 1 to 8 wherein the olefin monomers having three or more carbon atoms are present in the feed at 75 wt % or more, preferably 85 wt % or more.
10. The process of any of paragraphs 1 to 9 wherein the olefin monomer having three or more carbon atoms comprises propylene, preferably the olefin monomer having three or more carbon atoms consists essentially of propylene.
11. The process of paragraph 1 wherein the temperature is above the cloud point temperature of the polymerization system and the pressure is less than 250 MPa.
12. The process of any of paragraphs 1 to 11 wherein the metal is selected from Hf, Ti and Zr.
13. The process of any of paragraphs 1 to 12 wherein solvent and or diluent is present in the polymerization system at 0.5 to 40 wt %, preferably 1 to 20 wt %.
14. The process of any of paragraphs 1 to 13 wherein comonomer is present in the feed at 0.1 to 20 wt %.
15. The process of any of paragraphs 1 to 14 wherein the feed of the monomer, comonomers, solvents and diluents comprises from 55-100 wt % propylene monomer, and from 0 to 45 wt % of one or more comonomers selected from the group consisting of ethylene, butene, hexene, 4-methylpentene, dicyclopentadiene, norbornene, C₄-C₂₀₀₀ α-olefins, C₄-C₂₀₀₀ α,internal-diolefins, and C₄-C₂₀₀₀ α,ω-diolefins.
16. The process of any of paragraphs 1 to 15 wherein the comonomer comprises one or more of ethylene, butene, hexene-1, octene-1, or decene-1.
17. The process of any of paragraphs 1 to 16 wherein the nonmetallocene, metal-centered, heteroaryl ligand catalyst compound comprises a ligand represented by the formula (1):

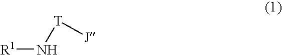

wherein R¹ is represented by the formula (2):

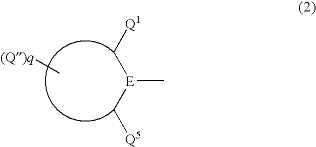

where
Q¹ and Q⁵ are substituents on the ring other than to atom E, where at least one of Q¹ or Q⁵ has at least 2 atoms;
E is selected from the group consisting of carbon and nitrogen;
q is 1, 2, 3, 4 or 5;
Q″ is selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, halide, nitro, and combinations thereof;
T is a bridging group selected group consisting of —CR²R³— and —SiR²R³—;
R² and R³ are each, independently, selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, halide, nitro, and combinations thereof; and
J″ is selected from the group consisting of heteroaryl and substituted heteroaryl.
18. The process of any of paragraphs 1 to 17 wherein the nonmetallocene, metal-centered, heteroaryl ligand catalyst compound comprises a ligand represented by the formula (3):

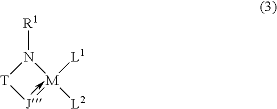

where
M is zirconium or hafnium;
R¹, T, R² and R³ are as defined in paragraph 3,
J′″ is selected from the group of substituted heteroaryls with 2 atoms bonded to the metal M, at least one of those atoms being a heteroatom, and with one atom of J′″ is bonded to M via a dative bond, the other through a covalent bond; and
L¹ and L² are independently selected from the group consisting of halide, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations of these radicals.
19. The process of any of paragraphs 1 to 18 where the nonmetallocene, metal-centered, heteroaryl ligand catalyst is represented by the formula (4):

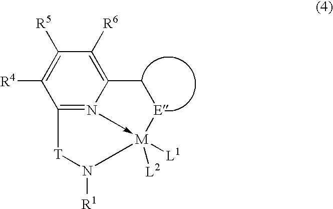

where
M, L¹ and L² are as defined in paragraph 4;
R⁴, R⁵, and R⁶ are independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, nitro, and combinations thereof, optionally, two or more R⁴, R⁵, and R⁶ groups may be joined to form a fused ring system having from 3-50 non-hydrogen atoms in addition to the pyridine ring, or, optionally, any combination of R², R³, and R⁴, may be joined together in a ring structure;
R¹, T, R² and R³ are as defined in paragraph 3; and
E″ is either carbon or nitrogen and is part of an cyclic aryl, substituted aryl, heteroaryl, or substituted heteroaryl group.
20. The process of any of paragraphs 1 to 19 wherein the catalyst compound is represented by the one or both of the following formulae:

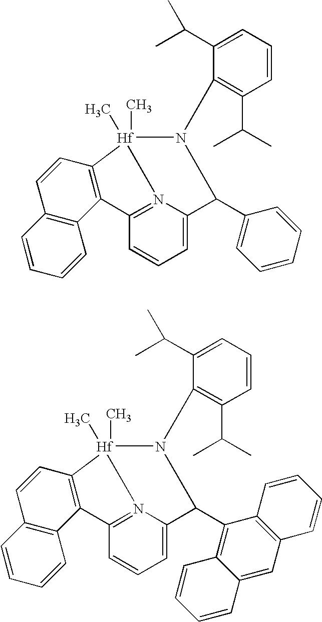

21. The process of any of paragraphs 1 to 20 where the activator comprises an alumoxane, preferably a methylalumoxane.
22. The process of any of paragraphs 1 to 21 where the activator comprises one or more of triethylammonium tetraphenylborate,
N,N-dimethylanilinium tetraphenylborate,
tripropylammonium tetrakis(pentafluorophenyl)borate,
N,N-dimethylanilinium n-butyltris(pentafluorophenyl)borate,
triethylammonium tetrakis(2,3,4,6-tetrafluorophenyl)borate,
N,N-diethylanilinium tetrakis(2,3,4,6-tetrafluorophenyl)borate, and
N,N-dimethyl-2,4,6-trimethylanilinium tetrakis(2,3,4,6-tetrafluorophenyl)borate;
di-(i-propyl)ammonium tetrakis(pentafluorophenyl)borate,
dicyclohexylammonium tetrakis(pentafluorophenyl)borate;
triphenylphosphonium tetrakis(pentafluorophenyl)borate,
tri(o-tolyl)phosphonium tetrakis(pentafluorophenyl)borate,
tri(2,6-dimethylphenyl)phosphonium tetrakis(pentafluorophenyl)borate;
diphenyloxonium tetrakis(pentafluorophenyl)borate,
di(o-tolyl)oxonium tetrakis(pentafluorophenyl)borate,
di(2,6-dimethylphenyl)oxonium tetrakis(pentafluorophenyl)borate;
diphenylsulfonium tetrakis(pentafluorophenyl)borate,
di(o-tolyl)sulfonium tetrakis(pentafluorophenyl)borate,
di(2,6-dimethylphenyl)sulfonium tetrakis(pentafluorophenyl)borate,
trimethylsilylium tetrakis(pentafluorophenyl)borate, and
triethylsilylium(tetrakispentafluoro)phenylborate.
23. The process of any of paragraphs 1 to 22 where the activator comprises one or more of trimethylammonium tetraphenylborate, triethylammonium tetraphenylborate, tripropylammonium tetraphenylborate, tri(n-butyl)ammonium tetraphenylborate, tri(tert-butyl)ammonium tetraphenylborate, N,N-dimethylanilinium tetraphenylborate, N,N-diethylanilinium tetraphenylborate, N,N-dimethyl-(2,4,6-trimethylanilinium)tetraphenylborate, trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-diethylanilinium tetrakis(pentafluorophenyl)borate, N,N-dimethyl-(2,4,6-trimethylanilinium)tetrakis(pentafluorophenyl)borate, trimethylammonium tetrakis-(2,3,4,6-tetrafluorophenyl)borate, triethylammonium tetrakis-(2,3,4,6-tetrafluorophenyl)borate, tripropylammonium tetrakis-(2,3,4,6-tetrafluorophenyl)borate, tri(n-butyl)ammonium tetrakis-(2,3,4,6-tetrafluorophenyl)borate, dimethyl(tert-butyl)ammonium tetrakis-(2,3,4,6-tetrafluorophenyl)borate, N,N-dimethylanilinium tetrakis-(2,3,4,6-tetrafluorophenyl)borate, N,N-diethylanilinium tetrakis-(2,3,4,6-tetrafluorophenyl)borate, N,N-dimethyl-(2,4,6-trimethylanilinium)tetrakis-(2,3,4,6-tetrafluorophenyl)borate, trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(tert-butyl)ammonium tetrakis(perfluoronaphthyl)borate, N,N-dimethylanilinium tetrakis(perfluoronaphthyl)borate, N,N-diethylanilinium tetrakis(perfluoronaphthyl)borate, N,N-dimethyl-(2,4,6-trimethylanilinium)tetrakis(perfluoronaphthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(tert-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium)tetrakis(perfluorobiphenyl)borate, trimethylammonium tetrakis(3,5-bis(trifluoromethyl)phenyl)borate, triethylammonium tetrakis(3,5-bis(trifluoromethyl)phenyl)borate, tripropylammonium tetrakis(3,5-bis(trifluoromethyl)phenyl)borate, tri(n-butyl)ammonium tetrakis(3,5-bis(trifluoromethyl)phenyl)borate, tri(tert-butyl)ammonium tetrakis(3,5-bis(trifluoromethyl)phenyl)borate, N,N-dimethylanilinium tetrakis(3,5-bis(trifluoromethyl)phenyl)borate, N,N-diethylanilinium tetrakis(3,5-bis(trifluoromethyl)phenyl)borate, N,N-dimethyl-(2,4,6-trimethylanilinium)tetrakis(3,5-bis(trifluoromethyl)phenyl)borate, di-(iso-propyl)ammonium tetrakis(pentafluorophenyl)borate, and dicyclohexylammonium tetrakis(pentafluorophenyl)borate; tri(o-tolyl)phosphonium tetrakis(pentafluorophenyl)borate, tri(2,6-dimethylphenyl)phosphonium tetrakis(pentafluorophenyl)borate, tropillium tetraphenylborate, triphenylcarbenium tetraphenylborate, triphenylphosphonium tetraphenylborate, triethylsilylium tetraphenylborate, benzene(diazonium)tetraphenylborate, tropillium tetrakis(pentafluorophenyl)borate, triphenylcarbenium tetrakis(pentafluorophenyl)borate, triphenylphosphonium tetrakis(pentafluorophenyl)borate, triethylsilylium tetrakis(pentafluorophenyl)borate, benzene(diazonium)tetrakis(pentafluorophenyl)borate, tropillium tetrakis-(2,3,4,6-tetrafluorophenyl)borate, triphenylcarbenium tetrakis-(2,3,4,6-tetrafluorophenyl)borate, triphenylphosphonium tetrakis-(2,3,4,6-tetrafluorophenyl)borate, triethylsilylium tetrakis-(2,3,4,6-tetrafluorophenyl)borate, benzene(diazonium)tetrakis-(2,3,4,6-tetrafluorophenyl)borate, tropillium tetrakis(perfluoronaphthyl)borate, triphenylcarbenium tetrakis(perfluoronaphthyl)borate, triphenylphosphonium tetrakis(perfluoronaphthyl)borate, triethylsilylium tetrakis(perfluoronaphthyl)borate, benzene(diazonium)tetrakis(perfluoronaphthyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium)tetrakis(perfluorobiphenyl)borate, tropillium tetrakis(3,5-bis(trifluoromethyl)phenyl)borate, triphenylcarbenium tetrakis(3,5-bis(trifluoromethyl)phenyl)borate, triphenylphosphonium tetrakis(3,5-bis(trifluoromethyl)phenyl)borate, triethylsilylium tetrakis(3,5-bis(trifluoromethyl)phenyl)borate, or benzene(diazonium) tetrakis(3,5-bis(trifluoromethyl)phenyl)borate.
24. The process of any of paragraphs 1 to 20 wherein the activator comprises N,N-dimethylanilinium tetra(perfluorophenyl)borate and/or triphenylcarbenium tetra(perfluorophenyl)borate.
25. The process of any of paragraphs 1 to 24 where diluent or solvent is present and the diluent or solvent comprises a fluorinated hydrocarbon.
26. The process of any of paragraphs 1 to 25 wherein the polymerization takes place in a tubular reactor.
27. The process of paragraph 26 wherein the tubular reactor has a length-to-internal diameter ratio of 10:1 to 50000:1.
28. The process of paragraph 26 or 27 wherein the reactor contains from one to ten different injection positions, alternately from one to six different injection positions.
29. The process of paragraph 26, 27 or 28 wherein the tubular reactor has a length of 100-4000 meters, preferably 100-2000 meters and/or an internal diameter of less than 12.5 cm, preferably less than 10 cm.
30. The process of paragraph 26, 27, 28 or 29 wherein the tubular reactor is operated in multiple zones.
31. The process of any of paragraphs 1 to 25 wherein the polymerization takes place in an autoclave reactor.
32. The process of paragraph 31 wherein the autoclave reactor has a length-to-diameter ratios of 1:1 to 20: 1, preferably 4:1 to 20:1.
33. The process of paragraph 31 wherein the autoclave reactor has a length-to-diameter ratio of 4:1 to 20:1 and the reactor contains up to six different injection positions.
34. The process of paragraph 31, 32 or 33 wherein the autoclave reactor is operated in multiple zones.
35. The process of paragraph 31, 32, 33 or 34 wherein the process comprises (a) continuously feeding olefin monomers, catalyst compound, and activator to the autoclave reactor; (b) continuously polymerizing the monomers at a pressure of 15 MPa or more; (c) continuously removing the polymer/monomer mixture from the reactor; (d) reducing pressure to form a monomer-rich phase and a polymer-rich phase; (e) continuously separating monomer from the polymer; and (f) optionally recycling separated monomer to the polymerization process.
36. The process of any of paragraphs 1 to 25 wherein the polymerization takes place in a loop reactor.
37. The process of paragraph 36 wherein the loop reactor has a diameter of 41 to 61 cm and a length of 100 to 200 meters.
38. The process of paragraph 36 or 37 wherein the loop reactor is operated at pressures of 25 to 30 MPa.
39. The process of paragraph 36, 37 or 38 where an in-line pump continuously circulates the polymerization system through the loop reactor.
40. The process of paragraph 36, 37, 38 or 39 wherein the process comprises (a) continuously feeding olefin monomers, catalyst compound, and activator to the loop reactor; (b) continuously polymerizing the monomers at pressure of 15 MPa or more; (c) continuously removing the polymer/monomer mixture from the reactor; (d) reducing pressure to form a monomer-rich phase and a polymer-rich phase; (e) continuously separating monomer from the polymer; and (f) optionally recycling separated monomer to the polymerization process.
41. The process of any of paragraphs 1 to 39 wherein the polymerization takes place in multiple reactors.
42. The process of any of paragraphs 1 to 41 wherein the polymerization process comprises two or more reactors configured in parallel.
43. The process of paragraph 42 one or more of the reactors configured in parallel comprises a stirred autoclave reactor.
44. The process of paragraph 42 or 43 wherein one or more of the reactors configured in parallel comprises a loop reactor.
45. The process paragraph 42, 43 or 44 wherein one or more of the reactors configured in parallel comprises a tubular reactor.
46. The process of any of paragraphs 1 to 45 wherein the polymerization process comprises two or more reactors configured in series.
47. The process of paragraph 41, 42, or 46 wherein the polymerization takes places in a tubular reactor and then in one or more autoclave reactors.
48. The process of paragraph 41, 42, or 46 wherein the polymerization takes places in a tubular reactor and then one or more loop reactors.
49. The process of any of paragraphs 1 to 48 wherein the residence time in any one reactor (alternately in all reactors total) is less than 30 minutes, preferably less than 20 minutes, preferably less than 10 minutes, preferably less than 5 minutes.
50. The process of any of paragraphs 1 to 49 wherein the polymerization system is in a supercritical state.
51. The process of any of paragraphs 1 to 50 where the solvent or diluent are present at less than 1 volume % in the polymerization system.
52. The process of any of paragraphs 1 to 50 wherein the solvent or diluent are present at less than 40 wt % in the feed to the polymerization reactor, preferably less than 30 wt %, preferably less than 20 wt %, preferably less than 10 wt %, preferably less than 5 wt %, preferably less than 1 wt %.
53. The process of any of paragraphs 1 to 52 where the catalyst system is dissolved in the polymerization system.
54. The process of any of paragraphs 1 to 53 wherein the catalyst system further comprises one or more metallocene catalyst compounds.
55. The process of any of paragraphs 1 to 54 wherein the product of the polymerization process has a weight average molecular weight (Mw) of up to 2,000,000 g/mol as measured by Gel Permeation Chromatograph.
56. The process of any of paragraphs 1 to 55 wherein the product of the polymerization process has a melting peak temperature of up to 145° C. as measured by Differential Scanning Calorimetry.
57. The process of any of paragraphs 1 to 56 wherein the metal is selected from Group 5 of the Periodic Table of the Elements.
58. The process of any of paragraphs 1 to 56 wherein the metal is selected from Group 6 of the Periodic Table of the Elements.
59. The process of any of paragraphs 1 to 56 wherein the nonmetallocene, metal-centered, heteroaryl ligand catalyst compound comprises any metal from the Actinide or Lanthanide series of the Periodic Table of the Elements.

### EXAMPLES

All manipulations were conducted in a drybox with less than 10 ppm of oxygen and water. All solvents were degassed with nitrogen and dried over Na/K alloy prior to use. Catalyst Compound A (depicted below) was prepared according to the procedure generally described in WO 03/040201 A1, Page 90 line, 21 to page 93, line 9.

### Catalyst Precursor Compound A

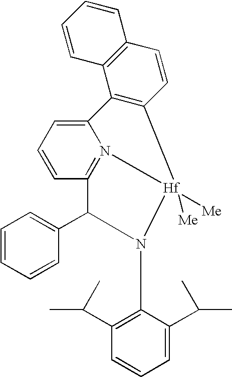

### Catalyst Precursor Compound A

### Examples 1-4

A 35-mL stainless steel autoclave reactor equipped with a magnetic stir bar was heated to 120° C. for one hour under a stream of dry nitrogen in order to dry the reactor. The reactor was cooled and subsequently charged with tri-n-octyl aluminum (1.50 mL, 0.029 mmol) as a scavenger. The total amount of tri-n-octyl aluminum utilized was adjusted to maintain an Al:Hf molar ratio between 20-30:1, respectively. To the reactor was added liquid propylene (33.5 mL; approx. 1000 psi (6.9 MPa); >99 purity; Airgas Corp.) and the reactor heated to 120° C. After heating to this temperature, the pressure of the reactor increased to approximately 7000 psi (48.3 MPa), and the contents were stirred. Separately, in a nitrogen Glove Box, Catalyst Precursor Compound A (0.163 g, 0.24 mmol) was dissolved in 20 mL of dried, degassed toluene to afford a catalyst stock solution of 0.012 M. Using a pipette, 0.833 mL of this stock solution was added to 9.167 mL of a toluene solution containing [N,N-dimethylanilinium][tetrakis(heptafluoronapthyl)borate] (Activator C) (0.014 g, 0.012 mmol) such that the activator : catalyst compound molar ratio was approximately 1.2:1. This mixture was stirred at room temperature for approximately 15 minutes. Next, in the dry box, 5.5 mL of this stock solution was charged to a previously dried syringe pump, sealed and attached to the 30-mL reactor. The activated catalyst solution (1 mL; 0.0011 mmol Catalyst Precursor Compound A) was added via syringe pump by over-pressurizing the feed line (10,000 psi (69 MPa)) above the reactor pressure (7000 psi (48.3 MPa)). After the catalyst was added, propylene was added to attain a pressure of 10,000 psi (69 MPa). The reactor was maintained at the desired temperature and pressure for 30 minutes. The reaction was terminated by venting the reactor contents into a vessel attached to the reactor vent line. After cooling, product was recovered from the vent collector and the reactor. The product was dried in a vacuum oven for 12 hours and the product was characterized by gel permeation chromatography (GPC) and differential scanning calorimetry (DSC). The data are reported in Table 1. The Tm was measured as DSC second melt. Mw and Mn were measured using GPC. See analytical section for more details. All GPC data were obtained utilizing a GPC-DRI method.

### Example 5

The procedure described for Examples 1-4 was utilized with the exception that [N,N-dimethylanilinium][tetrakis(perfluorophenyl)borate] (Activator B) was utilized. The data are reported in Table 1.

### Examples 6-8

The procedure described for Examples 1-4 was utilized with the exception that the reaction temperature was 105° C. The data are reported in Table 1.

TABLE 1

| | Example | | | | | | | |
|---|---|---|---|---|---|---|---|---|
| | 1 | 2 | 3 | 4 | 5 | 6 | 7 | 8 |
| Cat. A (μmol) | 1.0 | 1.0 | 1.0 | 1.0 | 1.2 | 1.0 | 0.8 | 0.8 |
| Reaction | 120 | 120 | 120 | 120 | 120 | 105 | 105 | 105 |
| Temp. (° C.) | | | | | | | | |
| Activator B | NA | NA | NA | NA | 1.44 | NA | NA | NA |
| (mmol) | | | | | | | | |
| Activator C | 1.2 | 1.2 | 1.2 | 1.2 | NA | 1.2 | 0.96 | 0.96 |
| (mmol) | | | | | | | | |
| TNOAl | 0.143 | 0.029 | 0.029 | 0.029 | 0.029 | 0.029 | 0.029 | 0.029 |
| (mmol) | | | | | | | | |
| Al:Hf molar | 143 | 29 | 29 | 29 | 24 | 29 | 36 | 36 |
| ratio | | | | | | | | |
| Rxn Time | 30 | 30 | 30 | 30 | 30 | 30 | 30 | 30 |
| (Min) | | | | | | | | |
| Yield (g) | 0.997 | 0.637 | 1.614 | 0.445 | 1.089 | 1.554 | 1.118 | 1.699 |
| Mw (g/mol) | 96,364 | 332,299 | 320,733 | 330,643 | 314,143 | 905,066 | 1,182,976 | 1,160,236 |
| Mw/Mn | 4.24 | 3.69 | 6.41 | 6.24 | 4.03 | 3.27 | 3.15 | 3.2 |
| Tm (° C.) | 132.7 | 131.6 | 132.1 | 133.3 | 131.3 | 133.8 | 134.5 | 133.9 |
| Hf (J/g) | 76.6 | 74.8 | 74.0 | 73.2 | 74.4 | 54.4 | 72.6 | 75.9 |

Activator B = [N,N-dimethylanilinium] [tetrakis(perfluorophenyl)borate]
Activator C = [N,N-dimethylanilinium] [tetrakis(heptafluoronapthyl)borate]
TNOAl = tri-n-octyl aluminum
Cat. A = Catalyst Precursor Compound A.

### Analytical Methods

### Differential Scanning Calorimetry (DSC)

Phase transitions were measured on heating and cooling the sample from the solid state and melt respectively using Differential Scanning Calorimetry (DSC). For crystallization temperature (Tc) and melting temperature (Tₘ), the measurements were conducted using a TA Instrument MDSC 2920 or Q1000 Tzero-DSC and data analyzed using the standard analysis software by the vendor. 3 to 10 mg of polymer was encapsulated in an aluminum pan and loaded into the instrument at room temperature. The sample was cooled to −70° C. and heated to 210° C. at a heating rate of 10° C./min. Each sample was held at 210° C. for 5 minutes to establish a common thermal history. Crystallization behavior was evaluated by cooling the sample from the melt to sub-ambient temperature at a cooling rate of 10° C./min. The sample was held at the low temperature for 10 minutes to fully equilibrate in the solid state and achieve a steady state. Second heating data was measured by heating this in-situ melt-crystallized sample at 10° C./min. The second heating data thus provide phase behavior for samples crystallized under controlled thermal history conditions. The melting temperatures reported in Table 1 are the peak melting temperatures from the second melt unless otherwise indicated. For polymers displaying multiple peaks, the higher melting peak temperature was reported.

Areas under the curve are used to determine the heat of fusion (H_{f}) which can be used to calculate the degree of crystallinity (also referred to as percent crystallinity). For determining polypropylene crystallinity, a value of 8.7 kJ/mol is used as the equilibrium heat of fusion for 100% crystalline polypropylene (single crystal measurement) reported in B. Wunderlich, “Thermal Analysis”, Academic Press, Page 418, 1990). The percent crystallinity for the propylene polymers is calculated using the formula, [area under the curve (J/g)×42 g/mol/8700 (J/mol)]*100%. For other polymers the percent crystallinity is calculated using the formula, [area under the curve (Joules/gram)/B (Joules/gram)]*100, where B is the heat of fusion for the homopolymer of the major monomer component. These values for B are to be obtained from the Polymer Handbook, Fourth Edition, published by John Wiley and Sons, New York 1999.

### Gel Permeation Chromatography (GPC-DRI)

The analysis was performed using a Waters GPCV 2000 (Gel Permeation Chromatograph) with triple detection. The three detectors were in series with Wyatt DAWN “EOS” MALLS 18 angle laser light scattering detector first, followed by the DRI (Differential Refractive Index) then Differential Viscometer detector. The detector output signals are collected on Wyatt's ASTRA software and analyzed using a GPC analysis program. The detailed GPC conditions are listed in Table 2.

Standards and samples were prepared in inhibited TCB (1,2,4-trichlorobenzene) solvent. Four NBS polyethylene standards were used for calibrating the GPC. Standard identifications are listed in Table 2. The samples were accurately weighed and diluted to a ˜1.5 mg/mL concentration and recorded. The standards and samples were placed on a PL Labs 260 Heater/Shaker at 160° C. for two hours. These were filtered through a 0.45 micron steel filter cup then analyzed.

TABLE 2
Gel Permeation Chromatography (GPC) measurement conditions

| | | |
|---|---|---|
| INSTRUMENT | | WATERS 2000 V + Wyatt Dawn EOS |
| COLUMN | Type: | 3 × MIXED BED TYPE “B” |
| | | 10 MICRON PD (high porosity col.'s) |
| | Length: | 300 mm |
| | ID: | 7.8 mm |
| | Supplier | POLYMER LABS |
| SOLVENT PROGRAM | | |
| | A | 0.54 ml/min TCB inhibited |
| | | GPC console setting was 0.5 mL/min to which 8% expansion |
| | | factor (from Waters) makes actual flow 0.54 mL/min |
| DETECTOR | A: | Wyatt MALLS 17 angle's of laser light scattering detector |
| | B: | DIFFERENTIAL REFRACTIVE INDEX (DRI) in series |
| | C: | Viscometer |
| | | IDvol. = +232.2 ul LS to DRI |
| | | IDvol. = −91.8 ul Dp to DRI |
| TEMPERATURE | Injector: | 135° C. |
| | Detector: | 135° C. |
| | Column: | 135° C. |
| DISOLUTION CONDITIONS | | Shaken for 2 h on a PL SP260 heater |
| | | Shaker @160° C. |
| SAMPLE FILTRATION | | Through a 0.45μ SS Filter @ 135° C. |
| INJECTION VOLUME | | 329.5 μL |
| SAMPLE CONCENTRATION | | 0.15 w/v % (1.5 mg/ml) Target wt |
| SOLVENT DILUENT | | TCB inhibited |
| CALIBRATION NARROW PE | | NIST 1482a; NIST1483a; NIST1484a |
| STANDARDS | | |
| BROAD PE STANDARD | | NIST 1475a |

All documents described herein are incorporated by reference herein, including any priority documents and/or testing procedures, except to the extent they are inconsistent with this specification. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law.

1. A process to polymerize olefins comprising contacting, at a temperature of 60° C. or more and a pressure between 15 MPa and 1500 MPa, one or more olefin monomers having three or more carbon atoms, with:
1) a catalyst system comprising one or more activators and one or more nonmetallocene metal-centered, heteroaryl ligand catalyst compounds, where the metal is chosen from the Group 4, 5, 6, the lanthanide series, or the actinide series of the Periodic Table of the Elements,
2) optionally one or more comonomers,
3) optionally diluent or solvent, and
4) optionally scavenger,
wherein:
a) the olefin monomers and any comonomers are present in the polymerization system at 40 weight % or more,
b) the monomer having three or more carbon atoms is present at 80 wt % or more based upon the weight of all monomers and comonomers present in the feed, and
c) the polymerization occurs at a temperature above the solid-fluid phase transition temperature of the polymerization system and a pressure no lower than 2 MPa below the cloud point pressure of the polymerization system and less than 1500 MPa, in the event the solid-fluid phase transition temperature of the polymerization system cannot be determined then the polymerization occurs at a temperature above the fluid fluid phase transition temperature.

2. The process of claim 1 wherein the polymerization occurs at a temperature above the fluid-fluid phase transition temperature of the polymerization system.

3. The process of claim 1 further comprising obtaining a polymer having an Mw of 30,000 or more.

4. The process of claim 1 further comprising obtaining a polymer having an melting point of 80° C. or more.

5. The process of claim 1 wherein the olefin monomers having three or more carbon atoms are present in the polymerization system at 40 weight % or more.

6. The process of claim 1 where the temperature is between 80 to 200° C.

7. The process of any of claim 1 wherein the pressure is between 15 and 250 MPa.

8. The process of claim 1 wherein solvent and or diluent is present in the feed at 0.5 to 40 wt %.

9. The process of claim 1 wherein the olefin monomers having three or more carbon atoms are present in the feed at 75 wt % or more.

10. The process of claim 1 wherein the olefin monomer having three or more carbon atoms comprises propylene.

11. The process of claim 1 wherein the temperature is above the cloud point temperature of the polymerization system and the pressure is less than 250 MPa.

12. The process of claim 1 wherein the metal is selected from Hf, Ti and Zr.

13. The process of claim 1 wherein solvent and or diluent is present in the polymerization system at 0.5 to 40 wt %.

14. The process of claim 1 wherein comonomer is present in the feed at 0.1 to 20wt %.

15. The process of claim 1 wherein the feed of the monomer, comonomers, solvents and diluents comprises from 55-100 wt % propylene monomer, and from 0 to 45 wt % of one or more comonomers selected from the group consisting of ethylene, butene, hexene, 4-methylpentene, dicyclopentadiene, norbornene, C₄-C₂₀₀₀ α-olefins, C₄-C₂₀₀₀ α,linternal-diolefins, and C₄-C₂₀₀₀ α,ω-diolefins.

16. The process of claim 1 wherein the comonomer comprises one or more of ethylene, butene, hexene-1, octene-1, or decene-1.

17. The process of claim 1 wherein the nonmetallocene, metal-centered, heteroaryl ligand catalyst compound comprises a ligand represented by the formula (1): 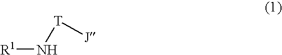
wherein R¹ is represented by the formula (2): 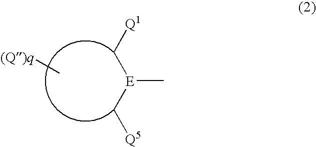
where
Q¹ and Q⁵ are substituents on the ring other than to atom E, where at least one of Q¹ or Q5 has at least 2 atoms;
E is selected from the group consisting of carbon and nitrogen;
q is 1, 2, 3, 4 or 5;
Q″ is selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, halide, nitro, and combinations thereof;
T is a bridging group selected group consisting of —CR²R³— and —SiR²R³—;
R² and R³ are each, independently, selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, halide, nitro, and combinations thereof; and
J″ is selected from the group consisting of heteroaryl and substituted heteroaryl.

18. The process of claim 1 wherein the nonmetallocene, metal-centered, heteroaryl ligand catalyst compound comprises a ligand represented by the formula (3): 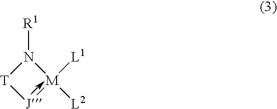
where
M is zirconium or hafnium;
R¹, T, R² and R³ are as defined in claim 3,
J′″ is selected from the group of substituted heteroaryls with 2 atoms bonded to the metal M, at least one of those atoms being a heteroatom, and with one atom of J′″ is bonded to M via a dative bond, the other through a covalent bond; and
L¹ and L² are independently selected from the group consisting of halide, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations of these radicals.

19. The process of claim 1 where the nonmetallocene, metal-centered, heteroaryl ligand catalyst is represented by the formula (4): 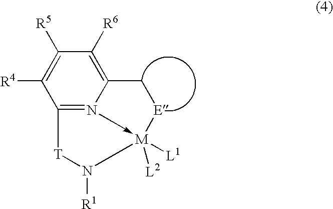
where
M, L¹ and L² are as defined in claim 4;
R⁴, R⁵, and R⁶ are independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, nitro, and combinations thereof, optionally, two or more R⁴, R⁵, and R⁶ groups may be joined to form a fused ring system having from 3-50 non-hydrogen atoms in addition to the pyridine ring, or, optionally, any combination of R², R³, and R⁴, may be joined together in a ring structure;
R¹ , T, R² and R³ are as defined in claim 3; and
E″ is either carbon or nitrogen and is part of an cyclic aryl, substituted aryl, heteroaryl, or substituted heteroaryl group.

20. The process of claim 1 wherein the catalyst compound is represented by the one or both of the following formulae:

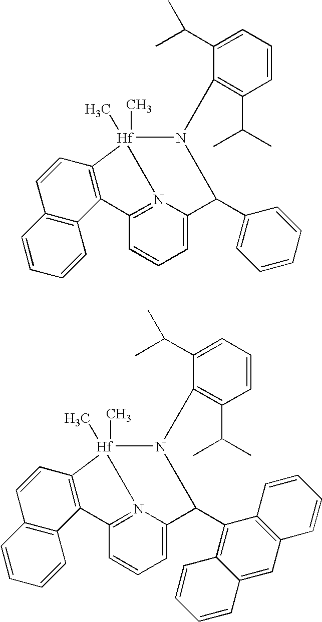

21. The process of claim 1 where the activator comprises an alumoxane.

22. The process of claim 1 where the activator comprises one or more of triethylammonium tetraphenylborate,
N,N-dimethylanilinium tetraphenylborate,
tripropylammonium tetrakis(pentafluorophenyl)borate,
N,N-dimethylanilinium n-butyltris(pentafluorophenyl)borate,
triethylammonium tetrakis(2,3,4,6-tetrafluorophenyl)borate,
N,N-diethylanilinium tetrakis(2,3,4,6-tetrafluorophenyl)borate, and
N,N-dimethyl-2,4,6-trimethylanilinium tetrakis(2,3,4,6-tetrafluorophenyl)borate;
di-(i-propyl)ammonium tetrakis(pentafluorophenyl)borate,
dicyclohexylammonium tetrakis(pentafluorophenyl)borate;
triphenylphosphonium tetrakis(pentafluorophenyl)borate,
tri(o-tolyl)phosphonium tetrakis(pentafluorophenyl)borate,
tri(2,6-dimethylphenyl)phosphonium tetrakis(pentafluorophenyl)borate;
diphenyloxonium tetrakis(pentafluorophenyl)borate,
di(o-tolyl)oxonium tetrakis(pentafluorophenyl)borate,
di(2,6-dimethylphenyl)oxonium tetrakis(pentafluorophenyl)borate;
diphenylsulfonium tetrakis(pentafluorophenyl)borate,
di(o-tolyl)sulfonium tetrakis(pentafluorophenyl)borate,
di(2,6-dimethylphenyl)sulfonium tetrakis(pentafluorophenyl)borate,
trimethylsilylium tetrakis(pentafluorophenyl)borate, and
triethylsilylium(tetrakispentafluoro)phenylborate.

23. The process of any of claim 1 where the activator comprises one or more of trimethylammonium tetraphenylborate, triethylammonium tetraphenylborate, tripropylammonium tetraphenylborate, tri(n-butyl)ammonium tetraphenylborate, tri(tert-butyl)ammonium tetraphenylborate, N,N-dimethylanilinium tetraphenylborate, N,N-diethylanilinium tetraphenylborate, N,N-dimethyl-(2,4,6-trimethylanilinium)tetraphenylborate, trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-diethylanilinium tetrakis(pentafluorophenyl)borate, N,N-dimethyl-(2,4,6-trimethylanilinium)tetrakis(pentafluorophenyl)borate, trimethylammonium tetrakis-(2,3,4,6-tetrafluorophenyl)borate, triethylammonium tetrakis-(2,3,4,6-tetrafluorophenyl)borate, tripropylammonium tetrakis-(2,3,4,6-tetrafluorophenyl)borate, tri(n-butyl)ammonium tetrakis-(2,3,4,6-tetrafluorophenyl)borate, dimethyl(tert-butyl)ammonium tetrakis-(2,3,4,6-tetrafluorophenyl)borate, N,N-dimethylanilinium tetrakis-(2,3,4,6-tetrafluorophenyl)borate, N,N-diethylanilinium tetrakis-(2,3,4,6-tetrafluorophenyl)borate, N,N-dimethyl-(2,4,6-trimethylanilinium) tetrakis-(2,3,4,6-tetrafluorophenyl)borate, trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(tert-butyl)ammonium tetrakis(perfluoronaphthyl)borate, N,N-dimethylanilinium tetrakis(perfluoronaphthyl)borate, N,N-diethylanilinium tetrakis(perfluoronaphthyl)borate, N,N-dimethyl-(2,4,6-trimethylanilinium)tetrakis(perfluoronaphthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(tert-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium)tetrakis(perfluorobiphenyl)borate, trimethylammonium tetrakis(3,5-bis(trifluoromethyl)phenyl)borate, triethylammonium tetrakis(3,5-bis(trifluoromethyl)phenyl)borate, tripropylammonium tetrakis(3,5-bis(trifluoromethyl)phenyl)borate, tri(n-butyl)ammonium tetrakis(3,5-bis(trifluoromethyl)phenyl)borate, tri(tert-butyl)ammonium tetrakis(3,5-bis(trifluoromethyl)phenyl)borate, N,N-dimethylanilinium tetrakis(3,5-bis(trifluoromethyl)phenyl)borate, N,N-diethylanilinium tetrakis(3,5-bis(trifluoromethyl)phenyl)borate, N,N-dimethyl-(2,4,6-trimethylanilinium)tetrakis(3,5-bis(trifluoromethyl)phenyl)borate, di-(iso-propyl)ammonium tetrakis(pentafluorophenyl)borate, and dicyclohexylammonium tetrakis(pentafluorophenyl)borate; tri(o-tolyl)phosphonium tetrakis(pentafluorophenyl)borate, tri(2,6-dimethylphenyl)phosphonium tetrakis(pentafluorophenyl)borate, tropillium tetraphenylborate, triphenylcarbenium tetraphenylborate, triphenylphosphonium tetraphenylborate, triethylsilylium tetraphenylborate, benzene(diazonium)tetraphenylborate, tropillium tetrakis(pentafluorophenyl)borate, triphenylcarbenium tetrakis(pentafluorophenyl)borate, triphenylphosphonium tetrakis(pentafluorophenyl)borate, triethylsilylium tetrakis(pentafluorophenyl)borate, benzene(diazonium)tetrakis(pentafluorophenyl)borate, tropillium tetrakis-(2,3,4,6-tetrafluorophenyl)borate, triphenylcarbenium tetrakis-(2,3,4,6-tetrafluorophenyl)borate, triphenylphosphonium tetrakis-(2,3,4,6-tetrafluorophenyl)borate, triethylsilylium tetrakis-(2,3,4,6-tetrafluorophenyl)borate, benzene(diazonium)tetrakis-(2,3,4,6-tetrafluorophenyl)borate, tropillium tetrakis(perfluoronaphthyl)borate, triphenylcarbenium tetrakis(perfluoronaphthyl)borate, triphenylphosphonium tetrakis(perfluoronaphthyl)borate, triethylsilylium tetrakis(perfluoronaphthyl)borate, benzene(diazonium)tetrakis(perfluoronaphthyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium)tetrakis(perfluorobiphenyl)borate, tropillium tetrakis(3,5-bis(trifluoromethyl)phenyl)borate, triphenylcarbenium tetrakis(3,5-bis(trifluoromethyl)phenyl)borate, triphenylphosphonium tetrakis(3,5-bis(trifluoromethyl)phenyl)borate, triethylsilylium tetrakis(3,5-bis(trifluoromethyl)phenyl)borate, or benzene(diazonium) tetrakis(3,5-bis(trifluoromethyl)phenyl)borate.

24. The process of claim 1 wherein the activator comprises N,N-dimethylanilinium tetra(perfluorophenyl)borate and/or triphenylcarbenium tetra(perfluorophenyl)borate.

25. The process of claim 1 where diluent or solvent is present and the diluent or solvent comprises a fluorinated hydrocarbon.

26. The process of claim 1 wherein the polymerization takes place in a tubular reactor.

27. The process of claim 26 wherein the tubular reactor has a length-to-internal diameter ratio of 10:1 to 50000:1.

28. The process of claim 26 wherein the reactor contains from 1 to 10 different injection positions.

29. The process of claim 26 wherein the tubular reactor has a length of 100-4000 meters and/or an internal diameter of less than 12.5 cm.

30. The process of claim 26 wherein the tubular reactor is operated in multiple zones.

31. The process of claim 1 wherein the polymerization takes place in an autoclave reactor.

32. The process of claim 31 wherein the autoclave reactor has a length-to-diameter ratio of 1:1 to 20:1.

33. The process of claim 31 wherein the autoclave reactor has a length-to-diameter ratio of 4:1 to 20:1 and the reactor contains up to six different injection positions.

34. The process of claim 31 wherein the autoclave reactor is operated in multiple zones.

35. The process of claim 31 wherein the process comprises (a) continuously feeding olefin monomers, catalyst compound, and activator to the autoclave reactor; (b) continuously polymerizing the monomers at a pressure of 15 MPa or more; (c) continuously removing the polymer/monomer mixture from the reactor; (d) reducing pressure to form a monomer-rich phase and a polymer-rich phase; (e) continuously separating monomer from the polymer; and (f) optionally recycling separated monomer to the polymerization process.

36. The process of claim 1 wherein the polymerization takes place in a loop reactor.

37. The process of claim 36 wherein the loop reactor has a diameter of 41 to 61 cm and a length of 100 to 200 meters.

38. The process of claim 36 wherein the loop reactor is operated at pressures of 25 to 30 MPa.

39. The process of claim 36 where an in-line pump continuously circulates the polymerization system through the loop reactor.

40. The process of claim 36 wherein the process comprises (a) continuously feeding olefin monomers, catalyst compound, and activator to the loop reactor; (b) continuously polymerizing the monomers at pressure of 15 MPa or more; (c) continuously removing the polymer/monomer mixture from the reactor; (d) reducing pressure to form a monomer-rich phase and a polymer-rich phase; (e) continuously separating monomer from the polymer; and (f) optionally recycling separated monomer to the polymerization process.

41. The process of claim 1 wherein the polymerization takes place in multiple reactors.

42. The process of claim 1 wherein the polymerization process comprises two or more reactors configured in parallel.

43. The process of claim 42 one or more of the reactors configured in parallel comprises a stirred autoclave reactor.

44. The process of claim 42 wherein one or more of the reactors configured in parallel comprises a loop reactor.

45. The process claim 42 wherein one or more of the reactors configured in parallel comprises a tubular reactor.

46. The process of claim 1 wherein the polymerization process comprises two or more reactors configured in series.

47. The process of claim 41 wherein the polymerization takes places in a tubular reactor and then an autoclave reactor.

48. The process of claim 41 wherein the polymerization takes places in a tubular reactor and then a loop reactor.

49. The process of claim 1 wherein the residence time is less than 30 minutes in any one reactor.

50. The process of claim 1 wherein the polymerization system is in a supercritical state.

51. The process of claim 1 where the solvent or diluent are present at less than 1 volume % in the polymerization system.

52. The process of claim 1 wherein the solvent or diluent are present at less than 10 wt % in the feed to the polymerization reactor.

53. The process of claim 1 where the catalyst system is dissolved in the polymerization system.

54. The process of claim 1 wherein the catalyst system further comprises one or more metallocene catalyst compounds.

55. The process of claim 1 wherein the product of the polymerization process has a weight average molecular weight (Mw) of up to 2,000,000 g/mol as measured by Gel Permeation Chromatograph.

56. The process of claim 1 wherein the product of the polymerization process has a melting peak temperature of up to 145° C. as measured by Differential Scanning Calorimetry.

57. The process of claim 1 wherein the metal is selected from Group 5 of the Periodic Table of the Elements.

58. The process of claim 1 wherein the metal is selected from Group 6 of the Periodic Table of the Elements.

59. The process of claim 1 wherein the nonmetallocene, metal-centered, heteroaryl ligand catalyst compound comprises any metal from the Actinide or Lanthanide series of the Periodic Table of the Elements.
